(19) United States
(12) Patent Application Publication
(10) Pub. No.: US 2025/0055731 A1
(43) Pub. Date: Feb. 13, 2025

(54) Communication Method, Apparatus, and System

(71) Applicant: Huawei Technologies Co., Ltd., Shenzhen (CN)

(72) Inventors: Zhengchun Zhou, Chengdu (CN); Rui Du, Singapore (SG); Yajing Zhou, Chengdu (CN); Xiaohu Tang, Chengdu (CN); Chenchen Liu, Shenzhen (CN); Xiao Han, Shenzhen (CN)

(21) Appl. No.: 18/920,006

(22) Filed: Oct. 18, 2024

Related U.S. Application Data
(63) Continuation of application No. PCT/CN2023/087637, filed on Apr. 11, 2023.

(30) Foreign Application Priority Data
Apr. 19, 2022 (CN) 202210408695.1

(51) Int. Cl. H04L 25/02; H04W 84/12

(52) U.S. Cl. CPC H04L 25/024; H04W 84/12

(57) ABSTRACT

A communication method includes generating a first sequence, where the first sequence is based on a complete complementary code set, the complete complementary code set is based on a Golay pair and a Hadamard matrix through a Kronecker product operation, and the first sequence is used for channel estimation; and sending the first sequence. In the method, use of a P-matrix is avoided in a process of constructing a plurality of streams of zero correlation sequences.

### CROSS-REFERENCE TO RELATED APPLICATIONS

This is a continuation of International Patent Application No. PCT/CN2023/087637 filed on Apr. 11, 2023, which claims priority to Chinese Patent Application No. 202210408695.1 filed on Apr. 19, 2022. The disclosures of the aforementioned applications are hereby incorporated by reference in their entireties.

### TECHNICAL FIELD

Embodiments of this application relate to the communication field, and in particular, to a communication method, apparatus, and system.

### BACKGROUND

A communication environment is complex and changeable, and a signal is subject to various types of interference during transmission. When the signal arrives at a receiver, an amplitude, a phase, and a frequency of the signal change. Therefore, good channel estimation is critical to communication quality. According to the wireless local area network (WLAN) sensing (802.11bf) technology based on channel estimation, target sensing can be performed by using a WLAN wireless signal, for example, information about an ambient environment of each communication path between two communication devices is extracted based on a radio measurement or environment sampling capability. WLAN devices are widely deployed in today's society. WLAN sensing based on existing WLAN standards will have a very wide application prospect. However, currently, channel estimation time and efficiency need to be improved. Therefore, how to shorten channel estimation time and improve channel estimation efficiency is an urgent problem to be resolved.

### SUMMARY

This application provides a communication method, apparatus, and system, to reduce a channel estimation delay and improve channel estimation efficiency.

According to a first aspect, a communication method is provided. The method includes generating a first sequence, where the first sequence is determined based on a complete complementary code set, the complete complementary code set is determined based on a Golay pair and a Hadamard matrix through a Kronecker product operation, and the first sequence is used for at least one of channel estimation, target sensing, or time synchronization; and sending a physical layer protocol data unit, where the physical layer protocol data unit includes the first sequence.

In the method, use of a P-matrix is avoided in a process of constructing a plurality of streams of zero correlation sequences. This reduces complexity of constructing a channel estimation sequence, shortens a length of the channel estimation sequence, reduces resource occupation, and also reduces a delay of channel estimation, target sensing, and/or time synchronization and improves efficiency of channel estimation, target sensing, or time synchronization.

It should be understood that channel estimation, target sensing, and/or time synchronization are merely examples of scenarios to which this method is applicable, and this application is not limited thereto.

With reference to the first aspect, in some implementations of the first aspect, the first sequence is one sequence in a zero correlation zone sequence set, and any sequence in the zero correlation zone sequence set is determined based on the complete complementary code set.

With reference to the first aspect, in some implementations of the first aspect, a length of the Golay pair is L, the Hadamard matrix is an n-order matrix, L and n are positive integers, a size of the complete complementary code set is 2n, a size of the zero correlation zone sequence set is 2n, and a length of any sequence in the zero correlation zone sequence set is 4nL.

With reference to the first aspect, in some implementations of the first aspect, each sequence in the zero correlation zone sequence set is obtained based on the complete complementary code set through a concatenation operation.

With reference to the first aspect, in some implementations of the first aspect, a sequence in the zero correlation zone sequence set and the complete complementary code set satisfy the following relationship:

$${CE}_{1} = ( {A}_{i , 1} ‖ {A}_{i , 2} ‖ … ‖ {A}_{1 , 2 n - 1} ‖ {A}_{i , 2 n} ‖ - {A}_{i , 1} ‖ {A}_{i , 2} ‖ … ‖ - {A}_{1 , 2 n - 1} ‖ {A}_{i , 2} )$$

Herein, CEᵢ is the sequence in the zero correlation zone sequence set, i is an integer greater than or equal to 1, and A_{i,j} is an element in the complete complementary code set.

With reference to the first aspect, in some implementations of the first aspect, when n is 4, and Lis 128, sequences in the zero correlation zone sequence set and complete complementary code sets satisfy the following relationships:

$${CE}_{1} = ( {A}_{1 , 1} ‖ {A}_{1 , 2} ‖ {A}_{1 , 3} ‖ {A}_{1 , 4} ‖ {A}_{1 , 5} ‖ {A}_{1 , 6} ‖ {A}_{1 , 7} ‖ {A}_{1 , 8} ‖ - {A}_{1 , 1} ‖ {A}_{1 , 2} ‖ - {A}_{1 , 3} ‖ {A}_{1 , 4} ‖ - {A}_{1 , 5} ‖ {A}_{1 , 6} ‖ - {A}_{1 , 7} ‖ {A}_{1 , 8} ) ,$$

$${CE}_{2} = ( {A}_{2 , 1} ‖ {A}_{2 , 2} ‖ {A}_{2 , 3} ‖ {A}_{2 , 4} ‖ {A}_{2 , 5} ‖ {A}_{2 , 6} ‖ {A}_{2 , 7} ‖ {A}_{2 , 8} ‖ - {A}_{2 , 1} ‖ {A}_{2 , 2} ‖ - {A}_{2 , 3} ‖ {A}_{2 , 4} ‖ - {A}_{2 , 5} ‖ {A}_{2 , 6} ‖ - {A}_{2 , 7} ‖ {A}_{2 , 8} ) ,$$

$${CE}_{3} = ( {A}_{3 , 1} ‖ {A}_{3 , 2} ‖ {A}_{3 , 3} ‖ {A}_{3 , 4} ‖ {A}_{3 , 5} ‖ {A}_{3 , 6} ‖ {A}_{3 , 7} ‖ {A}_{3 , 8} ‖ - {A}_{3 , 1} ‖ {A}_{3 , 2} ‖ - {A}_{3 , 3} ‖ {A}_{3 , 4} ‖ - {A}_{3 , 5} ‖ {A}_{3 , 6} ‖ - {A}_{3 , 7} ‖ {A}_{3 , 8} ) ,$$

$${CE}_{4} = ( {A}_{4 , 1} ‖ {A}_{4 , 2} ‖ {A}_{4 , 3} ‖ {A}_{4 , 4} ‖ {A}_{4 , 5} ‖ {A}_{4 , 6} ‖ {A}_{4 , 7} ‖ {A}_{4 , 8} ‖ - {A}_{4 , 1} ‖ {A}_{4 , 2} ‖ - {A}_{4 , 3} ‖ {A}_{4 , 4} ‖ - {A}_{4 , 5} ‖ {A}_{4 , 6} ‖ - {A}_{4 , 7} ‖ {A}_{4 , 8} ) ,$$

$${CE}_{5} = ( {A}_{5 , 1} ‖ {A}_{5 , 2} ‖ {A}_{5 , 3} ‖ {A}_{5 , 4} ‖ {A}_{5 , 5} ‖ {A}_{5 , 6} ‖ {A}_{5 , 7} ‖ {A}_{5 , 8} ‖ - {A}_{5 , 1} ‖ {A}_{5 , 2} ‖ - {A}_{5 , 3} ‖ {A}_{5 , 4} ‖ - {A}_{5 , 5} ‖ {A}_{5 , 6} ‖ - {A}_{5 , 7} ‖ {A}_{5 , 8} ) ,$$

$${CE}_{6} = ( {A}_{6 , 1} ‖ {A}_{6 , 2} ‖ {A}_{6 , 3} ‖ {A}_{6 , 4} ‖ {A}_{6 , 5} ‖ {A}_{6 , 6} ‖ {A}_{6 , 7} ‖ {A}_{6 , 8} ‖ - {A}_{6 , 1} ‖ {A}_{6 , 2} ‖ - {A}_{6 , 3} ‖ {A}_{6 , 4} ‖ - {A}_{6 , 5} ‖ {A}_{6 , 6} ‖ - {A}_{6 , 7} ‖ {A}_{6 , 8} ) ,$$

$${CE}_{7} = ( {A}_{7 , 1} ‖ {A}_{7 , 2} ‖ {A}_{7 , 3} ‖ {A}_{7 , 4} ‖ {A}_{7 , 5} ‖ {A}_{7 , 6} ‖ {A}_{7 , 7} ‖ {A}_{7 , 8} ‖ - {A}_{7 , 1} ‖ {A}_{7 , 2} ‖ - {A}_{7 , 3} ‖ {A}_{7 , 4} ‖ - {A}_{7 , 5} ‖ {A}_{7 , 6} ‖ - {A}_{7 , 7} ‖ {A}_{7 , 8} ) ,$$

$$and$$

$${CE}_{8} = ( {A}_{8 , 1} ‖ {A}_{8 , 2} ‖ {A}_{8 , 3} ‖ {A}_{8 , 4} ‖ {A}_{8 , 5} ‖ {A}_{8 , 6} ‖ {A}_{8 , 7} ‖ {A}_{8 , 8} ‖ - {A}_{8 , 1} ‖ {A}_{8 , 2} ‖ - {A}_{8 , 3} ‖ {A}_{8 , 4} ‖ - {A}_{8 , 5} ‖ {A}_{8 , 6} ‖ - {A}_{8 , 7} ‖ {A}_{8 , 8} ) .$$

With reference to the first aspect, in some implementations of the first aspect, the first sequence is sent through a first antenna, where the first antenna is one of at least one antenna, the at least one antenna is configured to send a sequence in the zero correlation zone sequence set, and the at least one antenna corresponds to the sequence in the zero correlation zone sequence set.

According to a second aspect, a communication method is provided. The method includes receiving a physical layer protocol data unit, where the physical layer protocol data unit includes a first sequence, the first sequence is determined based on a complete complementary code set, and the complete complementary code set is determined based on a Golay pair and a Hadamard matrix through a Kronecker product operation; and performing at least one of channel estimation, target sensing, or time synchronization based on the first sequence.

With reference to the second aspect, in some implementations of the second aspect, the first sequence is one sequence in a zero correlation zone sequence set, and any sequence in the zero correlation zone sequence set is determined based on the complete complementary code set.

With reference to the second aspect, in some implementations of the second aspect, a length of the Golay pair is L, the Hadamard matrix is an n-order matrix, L and n are positive integers, a size of the complete complementary code set is 2n, a size of the zero correlation zone sequence set is 2n, and a length of any sequence in the zero correlation zone sequence set is 4nL.

With reference to the second aspect, in some implementations of the second aspect, each sequence in the zero correlation zone sequence set is obtained based on the complete complementary code set through a concatenation operation.

With reference to the second aspect, in some implementations of the second aspect, a sequence in the zero correlation zone sequence set and the complete complementary code set satisfy the following relationship:

$${CE}_{1} = ( {A}_{i , 1} ‖ {A}_{i , 2} ‖ … ‖ {A}_{1 , 2 n - 1} ‖ {A}_{i , 2 n} ‖ - {A}_{i , 1} ‖ {A}_{i , 2} ‖ … ‖ - {A}_{1 , 2 n - 1} ‖ {A}_{i , 2} )$$

Herein, CEᵢ is the sequence in the zero correlation zone sequence set, i is an integer greater than or equal to 1, and A_{i,j} is an element in the complete complementary code set.

With reference to the second aspect, in some implementations of the second aspect, when n is 4, and L is 128, sequences in the zero correlation zone sequence set and complete complementary code sets satisfy the following relationships:

$${CE}_{1} = ( {A}_{1 , 1} ‖ {A}_{1 , 2} ‖ {A}_{1 , 3} ‖ {A}_{1 , 4} ‖ {A}_{1 , 5} ‖ {A}_{1 , 6} ‖ {A}_{1 , 7} ‖ {A}_{1 , 8} ‖ - {A}_{1 , 1} ‖ {A}_{1 , 2} ‖ - {A}_{1 , 3} ‖ {A}_{1 , 4} ‖ - {A}_{1 , 5} ‖ {A}_{1 , 6} ‖ - {A}_{1 , 7} ‖ {A}_{1 , 8} ) ,$$

$${CE}_{2} = ( {A}_{2 , 1} ‖ {A}_{2 , 2} ‖ {A}_{2 , 3} ‖ {A}_{2 , 4} ‖ {A}_{2 , 5} ‖ {A}_{2 , 6} ‖ {A}_{2 , 7} ‖ {A}_{2 , 8} ‖ - {A}_{2 , 1} ‖ {A}_{2 , 2} ‖ - {A}_{2 , 3} ‖ {A}_{2 , 4} ‖ - {A}_{2 , 5} ‖ {A}_{2 , 6} ‖ - {A}_{2 , 7} ‖ {A}_{2 , 8} ) ,$$

$${CE}_{3} = ( {A}_{3 , 1} ‖ {A}_{3 , 2} ‖ {A}_{3 , 3} ‖ {A}_{3 , 4} ‖ {A}_{3 , 5} ‖ {A}_{3 , 6} ‖ {A}_{3 , 7} ‖ {A}_{3 , 8} ‖ - {A}_{3 , 1} ‖ {A}_{3 , 2} ‖ - {A}_{3 , 3} ‖ {A}_{3 , 4} ‖ - {A}_{3 , 5} ‖ {A}_{3 , 6} ‖ - {A}_{3 , 7} ‖ {A}_{3 , 8} ) ,$$

$${CE}_{4} = ( {A}_{4 , 1} ‖ {A}_{4 , 2} ‖ {A}_{4 , 3} ‖ {A}_{4 , 4} ‖ {A}_{4 , 5} ‖ {A}_{4 , 6} ‖ {A}_{4 , 7} ‖ {A}_{4 , 8} ‖ - {A}_{4 , 1} ‖ {A}_{4 , 2} ‖ - {A}_{4 , 3} ‖ {A}_{4 , 4} ‖ - {A}_{4 , 5} ‖ {A}_{4 , 6} ‖ - {A}_{4 , 7} ‖ {A}_{4 , 8} ) ,$$

$${CE}_{5} = ( {A}_{5 , 1} ‖ {A}_{5 , 2} ‖ {A}_{5 , 3} ‖ {A}_{5 , 4} ‖ {A}_{5 , 5} ‖ {A}_{5 , 6} ‖ {A}_{5 , 7} ‖ {A}_{5 , 8} ‖ - {A}_{5 , 1} ‖ {A}_{5 , 2} ‖ - {A}_{5 , 3} ‖ {A}_{5 , 4} ‖ - {A}_{5 , 5} ‖ {A}_{5 , 6} ‖ - {A}_{5 , 7} ‖ {A}_{5 , 8} ) ,$$

$${CE}_{6} = ( {A}_{6 , 1} ‖ {A}_{6 , 2} ‖ {A}_{6 , 3} ‖ {A}_{6 , 4} ‖ {A}_{6 , 5} ‖ {A}_{6 , 6} ‖ {A}_{6 , 7} ‖ {A}_{6 , 8} ‖ - {A}_{6 , 1} ‖ {A}_{6 , 2} ‖ - {A}_{6 , 3} ‖ {A}_{6 , 4} ‖ - {A}_{6 , 5} ‖ {A}_{6 , 6} ‖ - {A}_{6 , 7} ‖ {A}_{6 , 8} ) ,$$

$${CE}_{7} = ( {A}_{7 , 1} ‖ {A}_{7 , 2} ‖ {A}_{7 , 3} ‖ {A}_{7 , 4} ‖ {A}_{7 , 5} ‖ {A}_{7 , 6} ‖ {A}_{7 , 7} ‖ {A}_{7 , 8} ‖ - {A}_{7 , 1} ‖ {A}_{7 , 2} ‖ - {A}_{7 , 3} ‖ {A}_{7 , 4} ‖ - {A}_{7 , 5} ‖ {A}_{7 , 6} ‖ - {A}_{7 , 7} ‖ {A}_{7 , 8} ) ,$$

$$and$$

$${CE}_{8} = ( {A}_{8 , 1} ‖ {A}_{8 , 2} ‖ {A}_{8 , 3} ‖ {A}_{8 , 4} ‖ {A}_{8 , 5} ‖ {A}_{8 , 6} ‖ {A}_{8 , 7} ‖ {A}_{8 , 8} ‖ - {A}_{8 , 1} ‖ {A}_{8 , 2} ‖ - {A}_{8 , 3} ‖ {A}_{8 , 4} ‖ - {A}_{8 , 5} ‖ {A}_{8 , 6} ‖ - {A}_{8 , 7} ‖ {A}_{8 , 8} ) .$$

With reference to the second aspect, in some implementations of the second aspect, the first sequence is received through a second antenna, where the second antenna is one of at least one antenna, the at least one antenna is configured to receive a sequence in the zero correlation zone sequence set, and the at least one antenna corresponds to the sequence in the zero correlation zone sequence set.

It should be understood that the method in the second aspect is a receive-end method corresponding to the first aspect, and explanations, supplements, and beneficial effects of the first aspect are also applicable to the second aspect. Details are not described herein again.

According to a third aspect, a communication method is provided. The method includes: generating a second sequence, where the second sequence is determined based on a loosely synchronized code set, the loosely synchronized code set is determined through iterations based on a first Golay complementary pair and a second Golay complementary pair, the second Golay complementary pair includes a third sequence and a fourth sequence, the first Golay complementary pair includes a fifth sequence and a sixth sequence, the third sequence is a sequence obtained by inverting the sixth sequence, the fourth sequence is a product of −1 and a sequence obtained by inverting the fifth sequence, and the second sequence is used for at least one of channel estimation, target sensing, or time synchronization; and sending a physical layer protocol data unit, where the physical layer protocol data unit includes the second sequence.

The method provides another manner of constructing a channel estimation sequence, so that a plurality of streams of aperiodic zero correlation sequences can be generated, and use of a P-matrix is avoided. This reduces complexity of constructing a channel estimation sequence, shortens a length of the channel estimation sequence, reduces resource occupation, and also reduces a delay of channel estimation, target sensing, or time synchronization and improves efficiency of channel estimation, target sensing, and/or time synchronization.

With reference to the third aspect, in some implementations of the third aspect, the second sequence is one sequence in a zero correlation zone sequence set, and any sequence in the zero correlation zone sequence set is determined based on the loosely synchronized code set.

With reference to the third aspect, in some implementations of the third aspect, a first sequence set and a second sequence set are determined through k iterations based on the first Golay complementary pair and the second Golay complementary pair, sizes of the first sequence set and the second sequence set are 2^{k} respectively, k is a positive integer, and the loosely synchronized code set is generated based on the first sequence set and the second sequence set.

With reference to the third aspect, in some implementations of the third aspect, the fifth sequence is C1, the sixth sequence is S1, and the loosely synchronized code set (LSₖ)ₖ₌₁²^{^{k}}, the first sequence set (Cᵢ^{k})ᵢ₌₁²^{^{k}}, and the second sequence set (Sᵢ^{k})ᵢ₌₁²^{^{k}} satisfy the following relationship:

LSₖ=(Cᵢ^{k}∥0_{z}∥Sᵢ^{k})

Herein, Z is a width of a zero correlation zone.

With reference to the third aspect, in some implementations of the third aspect, that any sequence in the zero correlation zone sequence set is determined based on the loosely synchronized code set includes: CEₖLSk

Herein, CEₖ is the zero correlation zone sequence set.

With reference to the third aspect, in some implementations of the third aspect, k is 3.

With reference to the third aspect, in some implementations of the third aspect, the first sequence is sent through a third antenna, where the third antenna is one of at least one antenna, and the at least one antenna is configured to receive a sequence in the zero correlation zone sequence set.

According to a fourth aspect, a communication method is provided. The method includes: receiving a physical layer protocol data unit, where the physical layer protocol data unit includes a second sequence, the second sequence is determined based on a loosely synchronized code set, the loosely synchronized code set is determined through iterations based on a first Golay complementary pair and a second Golay complementary pair, the second Golay complementary pair includes a third sequence and a fourth sequence, the first Golay complementary pair includes a fifth sequence and a sixth sequence, the third sequence is a sequence obtained by inverting the sixth sequence, and the fourth sequence is a product of −1 and a sequence obtained by inverting the fifth sequence; and performing at least one of channel estimation, target sensing, or time synchronization based on the second sequence.

With reference to the fourth aspect, in some implementations of the fourth aspect, the second sequence is one sequence in a zero correlation zone sequence set, and any sequence in the zero correlation zone sequence set is determined based on the loosely synchronized code set.

With reference to the fourth aspect, in some implementations of the fourth aspect, a first sequence set and a second sequence set are determined through k iterations based on the first Golay complementary pair and the second Golay complementary pair, sizes of the first sequence set and the second sequence set are 2^{k} respectively, k is a positive integer, and the loosely synchronized code set is generated based on the first sequence set and the second sequence set.

With reference to the fourth aspect, in some implementations of the fourth aspect, the fifth sequence is C1, the sixth sequence is S1, and the loosely synchronized code set (LSₖ)ₖ₌₁²^{^{k}}, the first sequence set (Cᵢ^{k})ᵢ₌₁²^{^{k}}, and the second sequence set (Sᵢ^{k})ᵢ₌₁²^{^{k}} satisfy the following relationship:

LSₖ=(Cᵢ^{k}∥0_{z}∥Sᵢ^{k})

Herein, Z is a width of a zero correlation zone.

With reference to the fourth aspect, in some implementations of the fourth aspect, that any sequence in the zero correlation zone sequence set is determined based on the loosely synchronized code set includes: CEₖ=LSk

Herein, CEₖ is the zero correlation zone sequence set.

With reference to the fourth aspect, in some implementations of the fourth aspect, k is 3.

With reference to the fourth aspect, in some implementations of the fourth aspect, the first sequence is received through a fourth antenna, where the fourth antenna is one of at least one antenna, the at least one antenna is configured to receive a sequence in the zero correlation zone sequence set, and the at least one antenna is in a one-to-one correspondence with sequences in the zero correlation zone sequence set.

It should be understood that the method in the fourth aspect is a receive-end method corresponding to the third aspect, and explanations, supplements, and beneficial effects of the third aspect are also applicable to the fourth aspect. Details are not described herein again.

According to a fifth aspect, a communication apparatus is provided. The communication apparatus includes a transceiver unit and a processing unit. The processing unit is configured to generate a first sequence, where the first sequence is determined based on a complete complementary code set, the complete complementary code set is determined based on a Golay pair and a Hadamard matrix through a Kronecker product operation, and the first sequence is used for at least one of channel estimation, target sensing, or time synchronization. The transceiver unit is configured to send a physical layer protocol data unit, where the physical layer protocol data unit includes the first sequence.

With reference to the fifth aspect, in some implementations of the fifth aspect, the first sequence is one sequence in a zero correlation zone sequence set, and any sequence in the zero correlation zone sequence set is determined based on the complete complementary code set.

With reference to the fifth aspect, in some implementations of the fifth aspect, a length of the Golay pair is L, the Hadamard matrix is an n-order matrix, L and n are positive integers, a size of the complete complementary code set is 2n, a size of the zero correlation zone sequence set is 2n, and a length of any sequence in the zero correlation zone sequence set is 4nL.

With reference to the fifth aspect, in some implementations of the fifth aspect, each sequence in the zero correlation zone sequence set is obtained based on the complete complementary code set through a concatenation operation.

With reference to the fifth aspect, in some implementations of the fifth aspect, a sequence in the zero correlation zone sequence set and the complete complementary code set satisfy the following relationship:

$${CE}_{1} = ( {A}_{i , 1} ‖ {A}_{i , 2} ‖ … ‖ {A}_{1 , 2 n - 1} ‖ {A}_{i , 2 n} ‖ - {A}_{i , 1} ‖ {A}_{i , 2} ‖ … ‖ - {A}_{1 , 2 n - 1} ‖ {A}_{i , 2} )$$

Herein, CEᵢ is the sequence in the zero correlation zone sequence set, i is an integer greater than or equal to 1, and A_{i,j} is an element in the complete complementary code set.

With reference to the fifth aspect, in some implementations of the fifth aspect, when n is 4, and L is 128, sequences in the zero correlation zone sequence set and complete complementary code sets satisfy the following relationships:

$${CE}_{1} = ( {A}_{1 , 1} ‖ {A}_{1 , 2} ‖ {A}_{1 , 3} ‖ {A}_{1 , 4} ‖ {A}_{1 , 5} ‖ {A}_{1 , 6} ‖ {A}_{1 , 7} ‖ {A}_{1 , 8} ‖ - {A}_{1 , 1} ‖ {A}_{1 , 2} ‖ - {A}_{1 , 3} ‖ {A}_{1 , 4} ‖ - {A}_{1 , 5} ‖ {A}_{1 , 6} ‖ - {A}_{1 , 7} ‖ {A}_{1 , 8} ) ,$$

$${CE}_{2} = ( {A}_{2 , 1} ‖ {A}_{2 , 2} ‖ {A}_{2 , 3} ‖ {A}_{2 , 4} ‖ {A}_{2 , 5} ‖ {A}_{2 , 6} ‖ {A}_{2 , 7} ‖ {A}_{2 , 8} ‖ - {A}_{2 , 1} ‖ {A}_{2 , 2} ‖ - {A}_{2 , 3} ‖ {A}_{2 , 4} ‖ - {A}_{2 , 5} ‖ {A}_{2 , 6} ‖ - {A}_{2 , 7} ‖ {A}_{2 , 8} ) ,$$

$${CE}_{3} = ( {A}_{3 , 1} ‖ {A}_{3 , 2} ‖ {A}_{3 , 3} ‖ {A}_{3 , 4} ‖ {A}_{3 , 5} ‖ {A}_{3 , 6} ‖ {A}_{3 , 7} ‖ {A}_{3 , 8} ‖ - {A}_{3 , 1} ‖ {A}_{3 , 2} ‖ - {A}_{3 , 3} ‖ {A}_{3 , 4} ‖ - {A}_{3 , 5} ‖ {A}_{3 , 6} ‖ - {A}_{3 , 7} ‖ {A}_{3 , 8} ) ,$$

$${CE}_{4} = ( {A}_{4 , 1} ‖ {A}_{4 , 2} ‖ {A}_{4 , 3} ‖ {A}_{4 , 4} ‖ {A}_{4 , 5} ‖ {A}_{4 , 6} ‖ {A}_{4 , 7} ‖ {A}_{4 , 8} ‖ - {A}_{4 , 1} ‖ {A}_{4 , 2} ‖ - {A}_{4 , 3} ‖ {A}_{4 , 4} ‖ - {A}_{4 , 5} ‖ {A}_{4 , 6} ‖ - {A}_{4 , 7} ‖ {A}_{4 , 8} ) ,$$

$${CE}_{5} = ( {A}_{5 , 1} ‖ {A}_{5 , 2} ‖ {A}_{5 , 3} ‖ {A}_{5 , 4} ‖ {A}_{5 , 5} ‖ {A}_{5 , 6} ‖ {A}_{5 , 7} ‖ {A}_{5 , 8} ‖ - {A}_{5 , 1} ‖ {A}_{5 , 2} ‖ - {A}_{5 , 3} ‖ {A}_{5 , 4} ‖ - {A}_{5 , 5} ‖ {A}_{5 , 6} ‖ - {A}_{5 , 7} ‖ {A}_{5 , 8} ) ,$$

$${CE}_{6} = ( {A}_{6 , 1} ‖ {A}_{6 , 2} ‖ {A}_{6 , 3} ‖ {A}_{6 , 4} ‖ {A}_{6 , 5} ‖ {A}_{6 , 6} ‖ {A}_{6 , 7} ‖ {A}_{6 , 8} ‖ - {A}_{6 , 1} ‖ {A}_{6 , 2} ‖ - {A}_{6 , 3} ‖ {A}_{6 , 4} ‖ - {A}_{6 , 5} ‖ {A}_{6 , 6} ‖ - {A}_{6 , 7} ‖ {A}_{6 , 8} ) ,$$

$${CE}_{7} = ( {A}_{7 , 1} ‖ {A}_{7 , 2} ‖ {A}_{7 , 3} ‖ {A}_{7 , 4} ‖ {A}_{7 , 5} ‖ {A}_{7 , 6} ‖ {A}_{7 , 7} ‖ {A}_{7 , 8} ‖ - {A}_{7 , 1} ‖ {A}_{7 , 2} ‖ - {A}_{7 , 3} ‖ {A}_{7 , 4} ‖ - {A}_{7 , 5} ‖ {A}_{7 , 6} ‖ - {A}_{7 , 7} ‖ {A}_{7 , 8} ) ,$$

$$and$$

$${CE}_{8} = ( {A}_{8 , 1} ‖ {A}_{8 , 2} ‖ {A}_{8 , 3} ‖ {A}_{8 , 4} ‖ {A}_{8 , 5} ‖ {A}_{8 , 6} ‖ {A}_{8 , 7} ‖ {A}_{8 , 8} ‖ - {A}_{8 , 1} ‖ {A}_{8 , 2} ‖ - {A}_{8 , 3} ‖ {A}_{8 , 4} ‖ - {A}_{8 , 5} ‖ {A}_{8 , 6} ‖ - {A}_{8 , 7} ‖ {A}_{8 , 8} ) .$$

With reference to the fifth aspect, in some implementations of the fifth aspect, the transceiver unit sends the first sequence through a first antenna, where the first antenna is one of at least one antenna, and the at least one antenna is configured to send a sequence in the zero correlation zone sequence set.

It should be understood that the fifth aspect is an apparatus-side implementation corresponding to the first aspect, and explanations, supplements, and beneficial effects of the first aspect are also applicable to the fifth aspect. Details are not described herein again.

According to a sixth aspect, a communication apparatus is provided. The communication apparatus includes a processing unit and a transceiver unit. The transceiver unit is used for a physical layer protocol data unit, the physical layer protocol data unit includes a first sequence, the first sequence is determined based on a complete complementary code set, and the complete complementary code set is determined based on a Golay pair and a Hadamard matrix through a Kronecker product operation. The processing unit is configured to perform at least one of channel estimation, target sensing, or time synchronization based on the first sequence.

With reference to the sixth aspect, in some implementations of the sixth aspect, the first sequence is one sequence in a zero correlation zone sequence set, and any sequence in the zero correlation zone sequence set is determined based on the complete complementary code set.

With reference to the sixth aspect, in some implementations of the sixth aspect, a length of the Golay pair is L, the Hadamard matrix is an n-order matrix, L and n are positive integers, a size of the complete complementary code set is 2n, a size of the zero correlation zone sequence set is 2n, and a size of any sequence in the zero correlation zone sequence set is 4nL.

With reference to the sixth aspect, in some implementations of the sixth aspect, each sequence in the zero correlation zone sequence set is obtained based on the complete complementary code set through a concatenation operation.

With reference to the sixth aspect, in some implementations of the sixth aspect, a sequence in the zero correlation zone sequence set and the complete complementary code set satisfy the following relationship:

$${CE}_{1} = ( {A}_{i , 1} ‖ {A}_{i , 2} ‖ … ‖ {A}_{1 , 2 n - 1} ‖ {A}_{i , 2 n} ‖ - {A}_{i , 1} ‖ {A}_{i , 2} ‖ … ‖ - {A}_{1 , 2 n - 1} ‖ {A}_{i , 2} )$$

Herein, CEᵢ is the sequence in the zero correlation zone sequence set, i is an integer greater than or equal to 1, and A_{i,j} is an element in the complete complementary code set.

With reference to the sixth aspect, in some implementations of the sixth aspect, when n is 4, and L is 128, sequences in the zero correlation zone sequence set and complete complementary code sets satisfy the following relationships:

$${CE}_{1} = ( {A}_{1 , 1} ‖ {A}_{1 , 2} ‖ {A}_{1 , 3} ‖ {A}_{1 , 4} ‖ {A}_{1 , 5} ‖ {A}_{1 , 6} ‖ {A}_{1 , 7} ‖ {A}_{1 , 8} ‖ - {A}_{1 , 1} ‖ {A}_{1 , 2} ‖ - {A}_{1 , 3} ‖ {A}_{1 , 4} ‖ - {A}_{1 , 5} ‖ {A}_{1 , 6} ‖ - {A}_{1 , 7} ‖ {A}_{1 , 8} ) ,$$

$${CE}_{2} = ( {A}_{2 , 1} ‖ {A}_{2 , 2} ‖ {A}_{2 , 3} ‖ {A}_{2 , 4} ‖ {A}_{2 , 5} ‖ {A}_{2 , 6} ‖ {A}_{2 , 7} ‖ {A}_{2 , 8} ‖ - {A}_{2 , 1} ‖ {A}_{2 , 2} ‖ - {A}_{2 , 3} ‖ {A}_{2 , 4} ‖ - {A}_{2 , 5} ‖ {A}_{2 , 6} ‖ - {A}_{2 , 7} ‖ {A}_{2 , 8} ) ,$$

$${CE}_{3} = ( {A}_{3 , 1} ‖ {A}_{3 , 2} ‖ {A}_{3 , 3} ‖ {A}_{3 , 4} ‖ {A}_{3 , 5} ‖ {A}_{3 , 6} ‖ {A}_{3 , 7} ‖ {A}_{3 , 8} ‖ - {A}_{3 , 1} ‖ {A}_{3 , 2} ‖ - {A}_{3 , 3} ‖ {A}_{3 , 4} ‖ - {A}_{3 , 5} ‖ {A}_{3 , 6} ‖ - {A}_{3 , 7} ‖ {A}_{3 , 8} ) ,$$

$${CE}_{4} = ( {A}_{4 , 1} ‖ {A}_{4 , 2} ‖ {A}_{4 , 3} ‖ {A}_{4 , 4} ‖ {A}_{4 , 5} ‖ {A}_{4 , 6} ‖ {A}_{4 , 7} ‖ {A}_{4 , 8} ‖ - {A}_{4 , 1} ‖ {A}_{4 , 2} ‖ - {A}_{4 , 3} ‖ {A}_{4 , 4} ‖ - {A}_{4 , 5} ‖ {A}_{4 , 6} ‖ - {A}_{4 , 7} ‖ {A}_{4 , 8} ) ,$$

$${CE}_{5} = ( {A}_{5 , 1} ‖ {A}_{5 , 2} ‖ {A}_{5 , 3} ‖ {A}_{5 , 4} ‖ {A}_{5 , 5} ‖ {A}_{5 , 6} ‖ {A}_{5 , 7} ‖ {A}_{5 , 8} ‖ - {A}_{5 , 1} ‖ {A}_{5 , 2} ‖ - {A}_{5 , 3} ‖ {A}_{5 , 4} ‖ - {A}_{5 , 5} ‖ {A}_{5 , 6} ‖ - {A}_{5 , 7} ‖ {A}_{5 , 8} ) ,$$

$${CE}_{6} = ( {A}_{6 , 1} ‖ {A}_{6 , 2} ‖ {A}_{6 , 3} ‖ {A}_{6 , 4} ‖ {A}_{6 , 5} ‖ {A}_{6 , 6} ‖ {A}_{6 , 7} ‖ {A}_{6 , 8} ‖ - {A}_{6 , 1} ‖ {A}_{6 , 2} ‖ - {A}_{6 , 3} ‖ {A}_{6 , 4} ‖ - {A}_{6 , 5} ‖ {A}_{6 , 6} ‖ - {A}_{6 , 7} ‖ {A}_{6 , 8} ) ,$$

$${CE}_{7} = ( {A}_{7 , 1} ‖ {A}_{7 , 2} ‖ {A}_{7 , 3} ‖ {A}_{7 , 4} ‖ {A}_{7 , 5} ‖ {A}_{7 , 6} ‖ {A}_{7 , 7} ‖ {A}_{7 , 8} ‖ - {A}_{7 , 1} ‖ {A}_{7 , 2} ‖ - {A}_{7 , 3} ‖ {A}_{7 , 4} ‖ - {A}_{7 , 5} ‖ {A}_{7 , 6} ‖ - {A}_{7 , 7} ‖ {A}_{7 , 8} ) ,$$

$$and$$

$${CE}_{8} = ( {A}_{8 , 1} ‖ {A}_{8 , 2} ‖ {A}_{8 , 3} ‖ {A}_{8 , 4} ‖ {A}_{8 , 5} ‖ {A}_{8 , 6} ‖ {A}_{8 , 7} ‖ {A}_{8 , 8} ‖ - {A}_{8 , 1} ‖ {A}_{8 , 2} ‖ - {A}_{8 , 3} ‖ {A}_{8 , 4} ‖ - {A}_{8 , 5} ‖ {A}_{8 , 6} ‖ - {A}_{8 , 7} ‖ {A}_{8 , 8} ) .$$

With reference to the sixth aspect, in some implementations of the sixth aspect, the transceiver unit is configured to receive the first sequence through a second antenna, where the second antenna is one of at least one antenna, and the at least one antenna is configured to receive a sequence in the zero correlation zone sequence set.

It should be understood that the sixth aspect is an apparatus-side implementation corresponding to the second aspect, and explanations, supplements, and beneficial effects of the second aspect are also applicable to the sixth aspect. Details are not described herein again.

According to a seventh aspect, a communication apparatus is provided. The communication apparatus includes a processing unit and a transceiver unit. The processing unit is configured to generate a second sequence, where the second sequence is determined based on a loosely synchronized code set, the loosely synchronized code set is determined through iterations based on a first Golay complementary pair and a second Golay complementary pair, the second Golay complementary pair includes a third sequence and a fourth sequence, the first Golay complementary pair includes a fifth sequence and a sixth sequence, the third sequence is a sequence obtained by inverting the sixth sequence, and the fourth sequence is a product of −1 and a sequence obtained by inverting the fifth sequence, and the second sequence is used for at least one of channel estimation, target sensing, or time synchronization. The transceiver unit is configured to send a physical layer protocol data unit, where the physical layer protocol data unit includes the second sequence.

With reference to the seventh aspect, in some implementations of the seventh aspect, the second sequence is one sequence in a zero correlation zone sequence set, and any sequence in the zero correlation zone sequence set is determined based on the loosely synchronized code set.

With reference to the seventh aspect, in some implementations of the seventh aspect, a first sequence set and a second sequence set are determined through k iterations based on the first Golay complementary pair and the second Golay complementary pair, sizes of the first sequence set and the second sequence set are 2^{k} respectively, k is a positive integer, and the loosely synchronized code set is generated based on the first sequence set and the second sequence set. With reference to the seventh aspect, in some implementations of the seventh aspect, the fifth sequence is C1, the sixth sequence is S1, and the loosely synchronized code set (LSₖ)ₖ₌₁²^{^{k}}, the first sequence set (Cᵢ^{k})ᵢ₌₁²^{^{k}}, and the second sequence set (Sᵢ^{k})ᵢ₌₁²^{^{k}} satisfy the following relationship:

LSₖ=9Cᵢ^{k}∥0_{z}∥Sᵢ^{k})

Herein, Z is a width of a zero correlation zone.

With reference to the seventh aspect, in some implementations of the seventh aspect, that any sequence in the zero correlation zone sequence set is determined based on the loosely synchronized code set includes: CEₖ=LSₖ

Herein, CEₖ is the zero correlation zone sequence set.

With reference to the seventh aspect, in some implementations of the seventh aspect, k is 3.

With reference to the seventh aspect, in some implementations of the seventh aspect, the first sequence is sent through a third antenna, where the third antenna is one of at least one antenna, the at least one antenna is configured to receive a sequence in the zero correlation zone sequence set, and the at least one antenna corresponds to the sequence in the zero correlation zone sequence set.

It should be understood that the seventh aspect is an apparatus-side implementation corresponding to the third aspect, and explanations, supplements, and beneficial effects of the third aspect are also applicable to the seventh aspect. Details are not described herein again.

According to an eighth aspect, a communication apparatus is provided. The communication apparatus includes a processing unit and a transceiver unit. The transceiver unit is configured to receive a physical layer protocol data unit, where the physical layer protocol data unit includes a second sequence, the second sequence is determined based on a loosely synchronized code set, the loosely synchronized code set is determined through iterations based on a first Golay complementary pair and a second Golay complementary pair, the second Golay complementary pair includes a third sequence and a fourth sequence, the first Golay complementary pair includes a fifth sequence and a sixth sequence, the third sequence is a sequence obtained by inverting the sixth sequence, and the fourth sequence is a product of −1 and a sequence obtained by inverting the fifth sequence. The processing unit is configured to perform at least one of channel estimation, target sensing, or time synchronization based on the second sequence.

With reference to the eighth aspect, in some implementations of the eighth aspect, the second sequence is one sequence in a zero correlation zone sequence set, and any sequence in the zero correlation zone sequence set is determined based on the loosely synchronized code set.

With reference to the eighth aspect, in some implementations of the eighth aspect, a first sequence set and a second sequence set are determined through k iterations based on the first

Golay complementary pair and the second Golay complementary pair, sizes of the first sequence set and the second sequence set are 2^{k} respectively, k is a positive integer, and the loosely synchronized code set is generated based on the first sequence set and the second sequence set. With reference to the eighth aspect, in some implementations of the eighth aspect, the fifth sequence is C1, the sixth sequence is S1, and the loosely synchronized code set (LSₖ)ₖ₌₁²^{^{k}}, the first sequence set (Cᵢ^{k})ᵢ₌₁²^{^{k}}, and the second sequence set (Sᵢ^{k})ᵢ₌₁²^{^{k}} satisfy the following relationship:

LSₖ=(Cᵢ^{k}∥0_{z}∥Sᵢ^{k})

Herein, Z is a width of a zero correlation zone.

With reference to the eighth aspect, in some implementations of the eighth aspect, that any sequence in the zero correlation zone sequence set is determined based on the loosely synchronized code set includes: CEₖ=LSₖ

Herein, CEₖ is the zero correlation zone sequence set.

With reference to the eighth aspect, in some implementations of the eighth aspect, k is 3.

With reference to the eighth aspect, in some implementations of the eighth aspect, the first sequence is received through a fourth antenna, where the fourth antenna is one of at least one antenna, and the at least one antenna is configured to receive a sequence in the zero correlation zone sequence set.

It should be understood that the eighth aspect is an apparatus-side implementation corresponding to the fourth aspect, and explanations, supplements, and beneficial effects of the fourth aspect are also applicable to the eighth aspect. Details are not described herein again.

According to a ninth aspect, a computer-readable medium is provided. The computer-readable medium stores program code executed by a communication apparatus, and the program code includes instructions used to perform the communication method according to the first aspect, the second aspect, the third aspect, or the fourth aspect, or any one of the possible implementations of the first aspect, the second aspect, the third aspect, or the fourth aspect, or all the possible implementations of the first aspect, the second aspect, the third aspect, or the fourth aspect.

According to a tenth aspect, a computer program product including instructions is provided. When the computer program product is run on a computer, the computer is enabled to perform the method according to the first aspect, the second aspect, the third aspect, or the fourth aspect, or any one of the possible implementations of the first aspect, the second aspect, the third aspect, or the fourth aspect, or all the possible implementations of the first aspect, the second aspect, the third aspect, or the fourth aspect.

According to an eleventh aspect, a communication system is provided. The communication system includes the method according to the first aspect, the second aspect, the third aspect, or the fourth aspect, or any one of the possible implementations of the first aspect, the second aspect, the third aspect, or the fourth aspect, or all the possible implementations of the first aspect, the second aspect, the third aspect, or the fourth aspect and an apparatus with various possible designed functions.

According to a twelfth aspect, a processor is provided, is coupled to a memory, and is configured to perform the method according to the first aspect, the second aspect, the third aspect, or the fourth aspect, or any one of the possible implementations of the first aspect, the second aspect, the third aspect, or the fourth aspect, or all the possible implementations of the first aspect, the second aspect, the third aspect, or the fourth aspect.

According to a thirteenth aspect, a chip is provided. The chip includes a processor and a communication interface, the communication interface is configured to communicate with an external component or an internal component, and the processor is configured to implement the method according to the first aspect, the second aspect, the third aspect, or the fourth aspect, or any one of the possible implementations of the first aspect, the second aspect, the third aspect, or the fourth aspect, or all the possible implementations of the first aspect, the second aspect, the third aspect, or the fourth aspect.

Optionally, the chip may further include a memory. The memory stores instructions. The processor is configured to execute the instructions stored in the memory or instructions from another module. When the instructions are executed, the processor is configured to implement the method according to any one of the first aspect, the second aspect, the third aspect, the fourth aspect, or the possible implementations of the first aspect, the second aspect, the third aspect, or the fourth aspect.

Optionally, the chip may be integrated into a sending device and/or a receiving device.

### BRIEF DESCRIPTION OF DRAWINGS

FIG. 1 is a diagram of a communication system applicable to an embodiment of this application;

FIG. 2A and FIG. 2B are diagrams of structures of sequences;

FIG. 3 is a diagram of a relationship between sequence correlation and a zone;

FIG. 4 is a diagram of another structure of a sequence;

FIG. 5 is a diagram of another structure of a sequence;

FIG. 6 is a schematic flowchart of a communication method according to an embodiment of this application;

FIG. 7 is a diagram of a sending structure of a sequence according to an embodiment of this application;

FIG. 8 is a schematic flowchart of another communication method according to an embodiment of this application;

FIG. 9 is a diagram of an iteration algorithm according to an embodiment of this application;

FIG. 10 is a diagram of a sending structure of a sequence according to an embodiment of this application;

FIG. 11 is a block diagram of a communication apparatus according to an embodiment of this application; and

FIG. 12 is a block diagram of another communication apparatus according to an embodiment of this application.

### DESCRIPTION OF EMBODIMENTS

The following describes technical solutions of this application with reference to accompanying drawings.

The technical solutions provided in embodiments of this application are applicable to a WLAN scenario, for example, applicable to the IEEE 802.11 series standards such as the 802.11a/b/g standard, the 802.11bf standard, the 802.11ad standard, the 802.11ay standard, or a next-generation standard. 802.11bf includes two categories of standards in low frequency (sub-7 gigahertz (GHz)) and high frequency (60 GHz). An implementation of the standards in sub-7 GHz mainly relies on standards such as 802.11ac, 802.11ax, 802.11be, and a next-generation standard, and an implementation of the standards in 60 GHz mainly relies on standards such as 802.11ad, 802.11ay, and a next-generation standard. 802.11ad may also be referred to as a Directional Multi-Gigabit (DMG) standard. 802.11ay may also be referred to as an Enhanced Directional Multi-Gigabit (EDMG) standard. The technical solutions in embodiments of this application mainly focus on implementation of 802.11bf on the standards in high frequency (802.11ad and 802.11ay), but a related technical principle may be extended to the standards in low frequency (802.11ac, 802.11ax, and 802.11be).

Although embodiments of this application are mainly described by using an example in which a WLAN network, especially a network to which the IEEE 802.11 series standards are applied, is deployed, a person skilled in the art easily understands that various aspects in embodiments of this application may be extended to other networks that use various standards or protocols, for example, Bluetooth, a High Performance Radio Local Area Network (HiperLAN), a wide area network (WAN), a personal area network (PAN), and other networks that are known or developed in the future. Therefore, regardless of a used coverage area and a used wireless access protocol, the various aspects provided in embodiments of this application are applicable to any suitable wireless network.

The technical solutions of embodiments of this application may be further applied to various communication systems, such as a WLAN communication system, a Wi-Fi system, a Global System for Mobile Communications (GSM) system, a code-division multiple access (CDMA) system, a wideband CDMA (WCDMA) system, a General Packet Radio Service (GPRS) system, a Long-Term Evolution (LTE) system, an LTE frequency-division duplex (FDD) system, an LTE time-division duplex (TDD) system, a universal mobile telecommunications system (UMTS), a Worldwide Interoperability for Microwave Access (WiMAX) communication system, a 5th generation (5G) system or a new radio (NR) system, a future 6th generation (6G) system, or a wireless local area network system like an internet of things (IoT) network or a vehicle-to-everything (V2X) network.

The foregoing communication systems applicable to this application are merely examples for descriptions, and the communication systems applicable to this application are not limited thereto. This is uniformly described herein, and details are not described below again.

A terminal in embodiments of this application may be user equipment (UE), an access terminal, a subscriber unit, a subscriber station, a mobile station, a remote station, a remote terminal, a mobile device, a user terminal, a terminal, a wireless communication device, a user agent, or a user apparatus. The terminal may alternatively be a cellular phone, a cordless phone, a Session Initiation Protocol (SIP) phone, a wireless local loop (WLL) station, a personal digital assistant (PDA), a handheld device having a wireless communication function, a computing device, another processing device connected to a wireless modem, a vehicle-mounted device, a wearable device, a terminal device in a 5G network, a terminal device in a future 6G network, a terminal device in a public land mobile network (PLMN), or the like. This is not limited in embodiments of this application.

A network device in embodiments of this application may be a device configured to communicate with the terminal. The network device may be a base transceiver station (BTS) in the GSM or the s, CDMA system, or may be a NodeB (NB) in the WCDMA system, or may be an evolved NodeB (eNB or eNodeB) in the LTE system, or may be a radio controller in a scenario of a cloud radio access network (CRAN). Alternatively, the network device may be a relay station, an access point, a vehicle-mounted device, a wearable device, a network device in the 5G network, a network device in the future 6G network, a network device in the PLMN network, or the like. This is not limited in embodiments of this application.

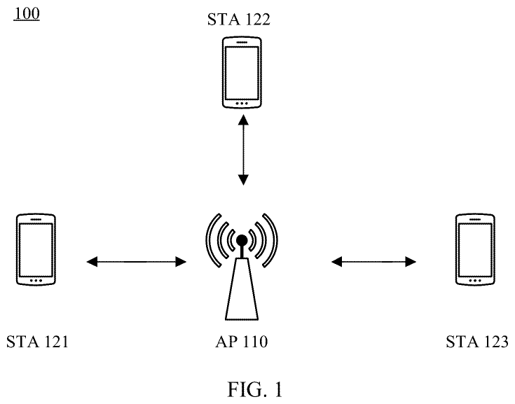

FIG. 1 is a diagram of an application scenario according to this application. In FIG. 1, an AP (for example, an AP 110 shown in FIG. 1) may be a communication server, a router, or a switch, or may be any one of the foregoing network devices. An STA (for example, a STA 121 or a STA 122 shown in FIG. 1) may be a mobile phone or a computer, or may be any one of the foregoing terminals. This is not limited in this embodiment of this application. One or more STAs in station devices may communicate with one or more APs in access point devices after establishing an association relationship. For example, the AP 110 may communicate with the STA 121 after establishing an association relationship, and the AP 110 may communicate with the STA 122 after establishing an association relationship.

It should be understood that a communication system 100 in FIG. 1 is merely an example. The technical solutions in embodiments of this application are applicable to communication between an AP and one or more STAs, are also applicable to mutual communication between APs, and are further applicable to mutual communication between STAs.

The access point may be an access point used by a terminal (for example, a mobile phone) to access a wired (or wireless) network, and is mainly deployed at home, in a building, and in a campus. A typical coverage radius is tens of meters (m) or more than 100 m. Certainly, the access point may alternatively be deployed outdoors. The access point is equivalent to a bridge that connects the wired network and the wireless network. A main function of the access point is to connect various wireless network clients together and then connect the wireless network to the Ethernet. Specifically, the access point may be a terminal device (for example, a mobile phone) or a network device (for example, a router) with a Wi-Fi chip. Optionally, the access point may be a device that supports WLAN standards such as 802.11 series standards. For example, the access point may support the 802.11bf standard, the 802.11ad standard, the 802.11ay standard, or a future Wi-Fi standard.

The station may be a wireless communication chip, a wireless sensor, a wireless communication terminal, or the like, and may also be referred to as a user. For example, the station may be a mobile phone, a tablet computer, a set-top box, a smart television, a smart wearable device, a vehicle-mounted communication device, or a computer that supports a Wi-Fi communication function. Optionally, the station may be a device that supports WLAN standards such as 802.11 series standards. For example, the station may also support the 802.11bf standard, the 802.11ad standard, the 802.11ay standard, or a future Wi-Fi standard.

For example, the access point and the station may be devices used in Internet of Vehicles, Internet of Things nodes, sensors, or the like in the IoT, smart cameras, smart remote controls, smart water or electricity meters, or the like in a smart home, sensors in a smart city, and the like.

A wireless communication system provided in embodiments of this application may be a WLAN or a cellular network. A method may be implemented by a communication device in the wireless communication system or a chip or a processor in the communication device. The communication device may be a wireless communication device that supports parallel transmission on a plurality of links. For example, the communication device is referred to as a multi-link device or a multi-band device. Compared with a device that supports only single-link transmission, the multi-link device has higher transmission efficiency and a higher throughput. The multi-link device includes one or more affiliated stations (STAs). The affiliated STA is a logical station and may work on one link. The affiliated station may be an AP or a non-AP STA. A multi-link device whose affiliated station is an AP may be referred to as a multi-link AP, a multi-link AP device, or an AP multi-link device, and a multi-link device whose affiliated station is a non-AP STA may be referred to as a multi-link STA, a multi-link STA device, or a STA multi-link device.

A signal sent by a Wi-Fi device is usually received by a terminal device only after being reflected, diffracted, and scattered by various obstacles. As a result, an actually received signal is usually obtained by superimposing a plurality of channels of signals. In other words, a channel environment may become complex. However, this also brings convenience for sensing, through a radio signal, a physical environment that the radio signal passes through. An ambient environment can be inferred and sensed by analyzing a radio signal like channel state information (CSI) affected by various obstacles. Therefore, a sensing technology, also referred to as target sensing, is developed.

The sensing technology includes four roles and four steps. The four roles are a sensing initiator, a sensing responder, a sensing transmitter, and a sensing receiver, respectively.

Specifically, the sensing initiator is a station that initiates a sensing procedure; the sensing responder is a station that participates in the sensing procedure initiated by the sensing initiator; the sensing transmitter is a station that sends a physical layer protocol data unit (PPDU) used for sensing measurements in the sensing procedure, where the PPDU used for sensing measurements is referred to as a sensing PPDU for short; and the sensing receiver is a station that receives the sensing PPDU sent by the sensing transmitter and performs sensing measurements in the sensing procedure.

Radar sensing as a sensing technology is typically characterized by self-transmitting and self-receiving. In an annex of the 802.11ay standard, a method for implementing radar sensing based on the 802.11ad standard and the 802.11ay standard is provided. A station (for example, station #1) may implement radar sensing in the following manner:
(1) A PPDU used for sensing measurements, namely, a sensing PPDU, is generated according to the directional multi-gigabit (DMG) standard or the enhanced DMG (EDMG) standard. Both a transmitter address (TA) and a receiver address (RA) in the sensing PPDU are set to a media access control (MAC) address of station #1. If the sensing PPDU is a short sector sweep (SSW) PPDU, a source association identifier (AID) and a destination association identifier in the PPDU are set to a same value.
(2) The sensing PPDU is sent according to an existing channel access mechanism.
(3) After receiving the PPDU, another station (for example, station #2) does not continue to unpack the PPDU after reading the RA, and then respects a transmission opportunity (TXOP) of the station and does not contend for a channel within this period of time.

To facilitate understanding of the technical solutions in embodiments of this application, related concepts are briefly explained in advance.
1. Golay pair: also called Golay complementary sequences. If binary constant modulus sequences x and y whose lengths are N satisfy Formula (1), the binary constant modulus sequences x and y may be referred to as Golay complementary sequences of each other.

$$x ( n ) ⊗ {x}^{*} ( - n ) + y ( n ) ⊗ {y}^{*} ( - n ) = 2 N δ ( n ) \qquad ( 1 )$$

Herein, the superscript * represents a complex conjugate, and the symbol® represents a convolution operation. Based on Golay complementary sequences specified in the 802.11ay standard, (Ga¹_{N}, Gb₁N) and (Ga2N, Gb2N) have zero cross-correlation (ZCC) features, as shown in (2) and (3). In addition, (Ga³_{N}, Gb³_{N}) and (Ga⁴_{N}, Gb⁴_{N}), (Ga⁵_{N}, Gb⁵_{N}) and (Ga⁶_{N}, Gb⁶_{N}), and (Ga⁷_{N}, Gb⁷_{N}) and (Ga⁸_{N}, Gb⁸_{N}) also have the ZCC features.

$${Ga}_{N}^{2} ( - n ) ⊗ {Ga}_{N}^{1} ( n ) + {Gb}_{N}^{2} ( - n ) ⊗ {Gb}_{N}^{1} ( n ) = 0 \qquad ( 2 )$$

$${Ga}_{N}^{1} ( - n ) ⊗ {Ga}_{N}^{2} ( n ) + {Gb}_{N}^{1} ( - n ) ⊗ {Gb}_{N}^{2} ( n ) = 0 \qquad ( 3 )$$

Herein, the superscript represents a Golay complementary sequence number in the 802.11ay standard, and the symbol® represents the convolution operation.

In the 802.11ay SC PHY standard, a chip rate is 1.76 gigabits per second (Gbps), and a spatial one-way distance L corresponding to N is:

$$L = \frac{N \cdot c}{f} \qquad ( 4 )$$

A quantity of chips sent per second is 1.76 G, and therefore f=1.76 GHz. When N=127, one-way L=21.8181 m (namely, a total distance from a transmitter to a target and then to a receiver). In a self-transmitting and self-receiving mode, the transmitter and the receiver are a same device, and a distance to the target satisfies L/2=10.9091 m, which can satisfy most application scenarios in WLAN sensing, that is, a local zone ranges from −127 to +127.
2. Hadamard matrix: The Hadamard matrix is an orthogonal square matrix formed by elements +1 and −1.
3. Time synchronization: Currently, there is a time error like a delay between devices on a communication network. A unified time standard is required for charging, operation management, event recording, and fault determining on the communication network. It is a trend to use a softswitch technology and use the Transmission Control Protocol/Internet Protocol (TCP/IP) time protocol or the Network Time Protocol (NTP) for time synchronization. To implement time synchronization on the communication network, a time source is selected based on different precision and stability requirements, and a proper time transmission technology and calibration method are selected. Two communication parties may perform time synchronization by using a sequence.

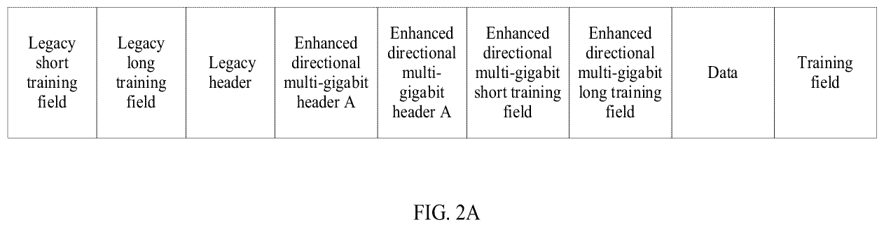

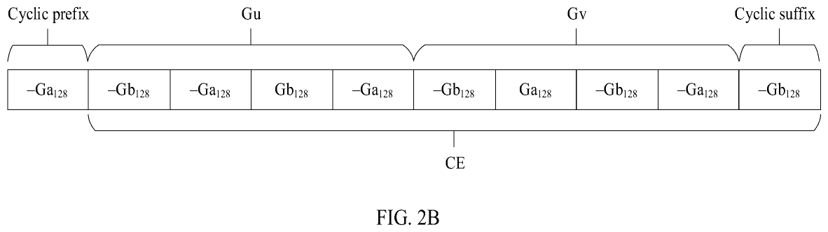

FIG. 2A is an example of an EDMG (11ay) frame structure, namely, an example of a typical structure of an 11ay PPDU. It can be seen that the frame structure includes a legacy short training field (L-STF), a legacy long training field (L-LTF), a legacy header (L-Header), an enhanced directional multi-Gigabit header A (EDMG-Header-A), an EDMG header A (EDMG-Header-A), an EDMG short training field (EDMG-STF), an EDMG long training field (EDMG-LTF), a data field, and a training (TRN) field.

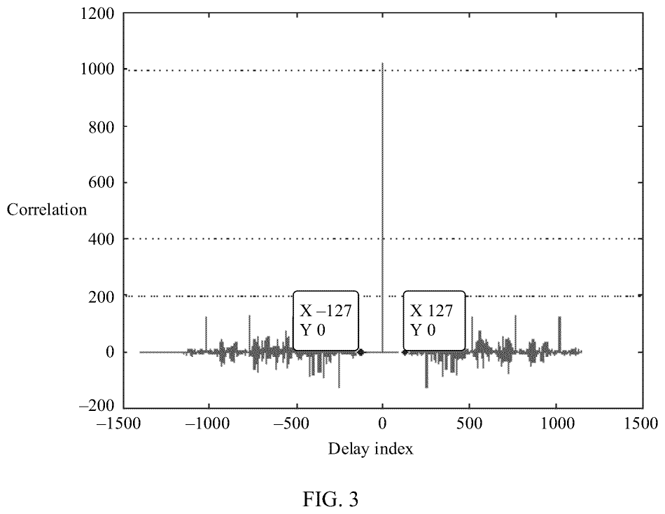

FIG. 2B is a manner of constructing a channel estimation (CE) sequence, where Golay complementary sequences are used to construct the channel estimation sequence. An advantage of using this manner is that autocorrelation of the sequence is zero in a local zone of −127 to +127. FIG. 3 is a diagram of a relationship between autocorrelation of the sequence and N. It can be seen that a side lobe in the local zone is zero. In FIG. 3, a horizontal coordinate represents a delay index, and a vertical coordinate represents correlation. It may be understood that the horizontal coordinate in FIG. 3 may alternatively represent a symbol, an element, or a bit.

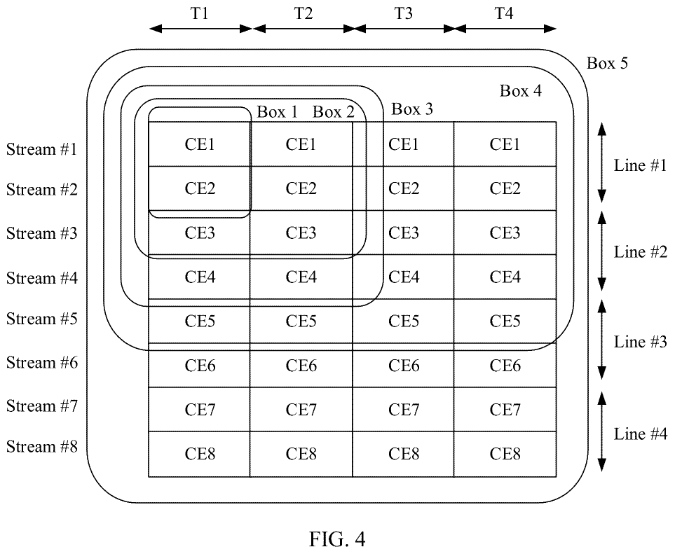

CE sequences are applied to multiple-input multiple-output (MIMO) channel estimation, and are transmitted in a manner shown in FIG. 4 with reference to a P-matrix (Formula (5)).

$$P = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] \qquad ( 5 )$$

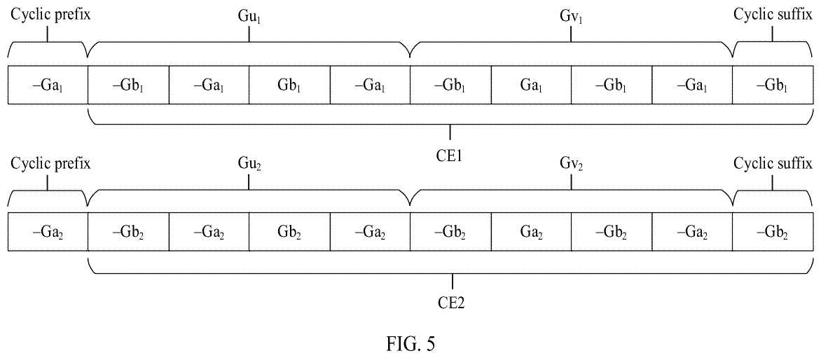

When two streams are transmitted for detection as shown in FIG. 4, CE sequences may be designed as shown in FIG. 5. Gu₁ and Gv₁ are formed by Ga₁ and Gb₁ Golay complementary sequences, and Gu₂ and Gv₂ are formed by Ga₂ and Gb₂ Golay complementary sequences. The two streams of CE sequences have a same structure.

Channel estimation can be performed in time domain and frequency domain, and is analyzed in time domain below. Herein, Cᵢ(n) is set to a combination sequence of a cyclic prefix and CEᵢ, and Uᵢ(n) is a sequence that is the same as Cᵢ(n) but whose cyclic prefix and cyclic suffix are both 0. It is assumed that two-stream sequences are transmitted. In time-domain channel estimation, information received by a first antenna may be defined as follows in time domain:

$${y}_{1} = {h}_{11} ⊗ {C}_{1} ( n ) + {h}_{12} ⊗ {C}_{2} ( n ) + {z}_{1} \qquad ( 6 )$$

Herein, h₁₁ and h₁₂ represent target channel estimation, Z₁ represents noise, ⊗ represents a convolution operation, and a matched filter may be used for resolving.

$${\hat{h}}_{11} = {h}_{11} ⊗ {\underbrace{{C}_{1} ( n ) ⊗ {U}_{1} ( - n )}}_{= 1} + {h}_{12} ⊗ {\underbrace{{C}_{2} ( n ) ⊗ {U}_{1} ( - n )}}_{= 0} + {z}_{1} ⊗ {U}_{1} ( - n ) \qquad ( 7 )$$

According to the property of the convolution operation, it may be obtained that C₁(n)⊗U₁(−n) actually is to calculate correlation of C₁(n) and U₁(n). τ is set to a value for translation during correlation. Only a zone −127≤τ≤127 namely a zero correlation zone is considered herein. According to the property of the Golay complementary pair, it can be seen that only a point of τ=0 for C₁(n)⊗U₁(−n) in −127≤τ≤127 has a value, and C₁(n)⊗U₁(−n) in −127≤τ≤127 all are 0.

Similarly, channel estimation may also be performed on h₁₂ by using the matched filter, as shown in Formula (8):

$${\hat{h}}_{12} = {h}_{11} ⊗ {\underbrace{{C}_{1} ( n ) ⊗ {U}_{2} ( - n )}}_{= 0} + {h}_{12} ⊗ {\underbrace{{C}_{2} ( n ) ⊗ {U}_{2} ( - n )}}_{= 1} + {z}_{2} ⊗ {U}_{2} ( - n ) \qquad ( 8 )$$

When more than two streams of CE sequences are transmitted, the CEs in the local zone do not have the ZCC feature, and in this case, need to be transmitted with reference to a P-matrix. When three or four streams are transmitted, as shown in block 2 and block 3 in FIG. 4, sensing is performed in two periods with reference to a P-matrix. In this case, the P-matrix is as follows:

$$P = [ \begin{matrix}1 & 1 \\ 1 & - 1\end{matrix} ] \qquad ( 9 )$$

When more than four streams of CE sequences are transmitted, as shown in block 4 and block 5 in FIG. 4, sensing is performed in four periods with reference to a P-matrix. In this case, the P-matrix is shown in Formula (5).

MIMO channel estimation can be completed by constructing a plurality of streams of CE sequences above. However, in the foregoing manners of constructing CE sequences, especially, a plurality of streams of CE sequences, a P-matrix is used. This sequence construction process needs to be optimized, and a delay caused to the channel estimation process needs to be reduced.

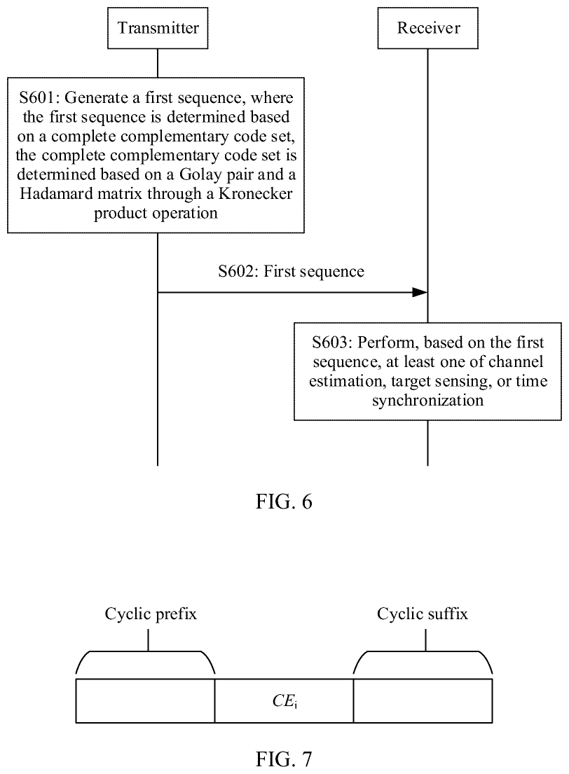

For the foregoing problem, an embodiment of this application provides a communication method, to simplify a CE sequence construction process, further improve channel estimation efficiency, and reduce hardware implementation complexity. As shown in FIG. 6, the method may include the following steps.

S601: A transmitter generates a first sequence, where the first sequence is determined based on a complete complementary code set, the complete complementary code set is determined based on a Golay pair and a Hadamard matrix through a Kronecker product operation, and the first sequence is used for at least one of channel estimation, target sensing, or time synchronization.

The first sequence may be one sequence in a zero correlation zone sequence set, and any sequence in the zero correlation zone sequence set may be determined based on the complete complementary code set. In this case, a whole or a part of the zero correlation zone sequence set may be used for implementation. This is not limited in this embodiment of this application.

It should be understood that the zero correlation sequence set may alternatively include a sequence determined in another manner (not based on the complete complementary code set). This is not limited in this embodiment of this application.

For example, the first sequence may be obtained based on the complete complementary code set through a concatenation operation.

For example, when the first sequence is one sequence in the zero correlation zone sequence set, the first sequence and the complete complementary code set may satisfy the following relationship:

$${CE}_{i} = ( {A}_{i , 1} ‖ {A}_{i , 2} ‖ ⋯ ‖ {A}_{i , 2 n - 1} ‖ {A}_{i , 2 n} ‖ - {A}_{i , 1} ‖ {A}_{i , 2} ‖ ⋯ ‖ - {A}_{i , 2 n - 1} ‖ {A}_{i , 2} ‖ )$$

Herein, P represents the concatenation operation. CEᵢ is the sequence in the zero correlation zone sequence set, i is an integer greater than or equal to 1, and A_{i,j} is an element in the complete complementary code set.

It may be understood that a length of the first sequence is correlated to a size of the complete complementary code set. For example, if the size of the complete complementary code set is 2n, and a length of a Golay pair used to determine the complete complementary code set is L, the length of the first sequence is 4nL, where n and L are positive integers. Herein, n is an order of a Hadamard matrix used to determine the complete complementary code set. For example, the Hadamard matrix is an n-order matrix. The length of the first sequence may be understood as a quantity of elements included in the sequence, the size of the complete complementary code set may be understood as a quantity of sequences included in the complete complementary code set, and the length of the Golay pair may be understood as a quantity of elements included in any sequence used as the Golay pair.

The following provides a manner of generating a complete complementary code set.

Golay pairs (a, b) and (c, d) with a length of L and an n-order matrix Hadamard matrix are given:

$$H = {[ {h}_{ij} ]}_{n \times n}$$

A complete complementary code set with a size of 2n is constructed based on the foregoing Golay pairs and Hadamard matrix:

$$A = [ \begin{matrix}A 1 \\ A 2 \\ ⋮ \\ A 2 n\end{matrix} ] = [ \begin{matrix}H ⊙ a & H ⊙ b \\ H ⊙ c & H ⊙ d\end{matrix} ]$$

e represents a Kronecker (Kronecker) product, that is,

$${A}_{i} = ( \begin{matrix}{A}_{i , 1} & {A}_{i , 2} & K & {A}_{i , 2 n}\end{matrix} ) = \{ \begin{matrix}( {H}_{i , 1} \cdot a , L {H}_{i , n} \cdot a , {H}_{i , 1} \cdot b , L {H}_{i , n} \cdot b ) , & i = 1 , L , n \\ ( {H}_{i , 1} \cdot c , L {H}_{i , n} \cdot c , {H}_{i , 1} \cdot d , L {H}_{i , n} \cdot d ) , & i = n + 1 , L , 2 n\end{matrix}$$

It is assumed that a value of n is 4 and a value of Z is 128.

In a possible implementation, it is assumed that a=Ga¹₁₂₈, b=Gb¹₁₂₈, C=Ga²₁₂₈, and d=Gb²₁₂₈, where Ga¹₁₂₈, Gb¹₁₂₈, Ga²₁₂₈, and Gb²₁₂₈ are Golay sequences whose lengths are 128 in the IEEE 802.11ay standard, and a fourth-order Hadamard matrix is used:

$$H = ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} )$$

In this way, a complete complementary code set may be obtained as follows:

A=[A₁,A₂,A₃,A₄,A₅,A₆,A₇,A₈]

Specifically,

$${A}_{1} = [ {Ga}_{128}^{1} , {Ga}_{128}^{1} , {Ga}_{128}^{1} , {Ga}_{128}^{1} , {Gb}_{128}^{1} , {Gb}_{128}^{1} , {Gb}_{128}^{1} , {Gb}_{128}^{1} ] ,$$

$${A}_{2} = [ {Ga}_{128}^{1} , - {Ga}_{128}^{1} , {Ga}_{128}^{1} , - {Ga}_{128}^{1} , {Gb}_{128}^{1} , - {Gb}_{128}^{1} , {Gb}_{128}^{1} , - {Gb}_{128}^{1} ] ,$$

$${A}_{3} = [ {Ga}_{128}^{1} , {Ga}_{128}^{1} , - {Ga}_{128}^{1} , - {Ga}_{128}^{1} , {Gb}_{128}^{1} , {Gb}_{128}^{1} , - {Gb}_{128}^{1} , - {Gb}_{128}^{1} ] ,$$

$${A}_{4} = [ {Ga}_{128}^{1} , - {Ga}_{128}^{1} , - {Ga}_{128}^{1} , {Ga}_{128}^{1} , {Gb}_{128}^{1} , - {Gb}_{128}^{1} , - {Gb}_{128}^{1} , {Gb}_{128}^{1} ] ,$$

$${A}_{5} = [ {Ga}_{128}^{2} , {Ga}_{128}^{2} , {Ga}_{128}^{2} , {Ga}_{128}^{2} , {Gb}_{128}^{2} , {Gb}_{128}^{2} , {Gb}_{128}^{2} , {Gb}_{128}^{2} ] ,$$

$${A}_{6} = [ {Ga}_{128}^{2} , - {Ga}_{128}^{2} , {Ga}_{128}^{2} , - {Ga}_{128}^{2} , {Gb}_{128}^{2} , - {Gb}_{128}^{2} , {Gb}_{128}^{2} , - {Gb}_{128}^{2} ] ,$$

$${A}_{7} = [ {Ga}_{128}^{2} , {Ga}_{128}^{2} , - {Ga}_{128}^{2} , - {Ga}_{128}^{2} , {Gb}_{128}^{2} , {Gb}_{128}^{2} , - {Gb}_{128}^{2} , - {Gb}_{128}^{2} ] ,$$

$$and$$

$${A}_{8} = [ {Ga}_{128}^{2} , - {Ga}_{128}^{2} , - {Ga}_{128}^{2} , {Ga}_{128}^{2} , {Gb}_{128}^{2} , - {Gb}_{128}^{2} , - {Gb}_{128}^{2} , {Gb}_{128}^{2} ] .$$

In this case, an 8-stream periodic zero correlation zone sequence set may be generated:

CE=[CE₁,CE₂,CE₃,CE₄,CE₅,CE₆,CE₇,CE₈]

Specifically,

$${CE}_{1} = ( {A}_{1 , 1} ‖ {A}_{1 , 2} ‖ {A}_{1 , 3} ‖ {A}_{1 , 4} ‖ {A}_{1 , 5} ‖ {A}_{1 , 6} ‖ {A}_{1 , 7} ‖ {A}_{1 , 8} ‖ - {A}_{1 , 1} ‖ {A}_{1 , 2} ‖ - {A}_{1 , 3} ‖ {A}_{1 , 4} ‖ - {A}_{1 , 5} ‖ {A}_{1 , 6} ‖ - {A}_{1 , 7} ‖ {A}_{1 , 8} ) ,$$

$${CE}_{2} = ( {A}_{2 , 1} ‖ {A}_{2 , 2} ‖ {A}_{2 , 3} ‖ {A}_{2 , 4} ‖ {A}_{2 , 5} ‖ {A}_{2 , 6} ‖ {A}_{2 , 7} ‖ {A}_{2 , 8} ‖ - {A}_{2 , 1} ‖ {A}_{2 , 2} ‖ - {A}_{2 , 3} ‖ {A}_{2 , 4} ‖ - {A}_{2 , 5} ‖ {A}_{2 , 6} ‖ - {A}_{2 , 7} ‖ {A}_{2 , 8} ) ,$$

$${CE}_{3} = ( {A}_{3 , 1} ‖ {A}_{3 , 2} ‖ {A}_{3 , 3} ‖ {A}_{3 , 4} ‖ {A}_{3 , 5} ‖ {A}_{3 , 6} ‖ {A}_{3 , 7} ‖ {A}_{3 , 8} ‖ - {A}_{3 , 1} ‖ {A}_{3 , 2} ‖ - {A}_{3 , 3} ‖ {A}_{3 , 4} ‖ - {A}_{3 , 5} ‖ {A}_{3 , 6} ‖ - {A}_{3 , 7} ‖ {A}_{3 , 8} ) ,$$

$${CE}_{4} = ( {A}_{4 , 1} ‖ {A}_{4 , 2} ‖ {A}_{4 , 3} ‖ {A}_{4 , 4} ‖ {A}_{4 , 5} ‖ {A}_{4 , 6} ‖ {A}_{4 , 7} ‖ {A}_{4 , 8} ‖ - {A}_{4 , 1} ‖ {A}_{4 , 2} ‖ - {A}_{4 , 3} ‖ {A}_{4 , 4} ‖ - {A}_{4 , 5} ‖ {A}_{4 , 6} ‖ - {A}_{4 , 7} ‖ {A}_{4 , 8} ) ,$$

$${CE}_{5} = ( {A}_{5 , 1} ‖ {A}_{5 , 2} ‖ {A}_{5 , 3} ‖ {A}_{5 , 4} ‖ {A}_{5 , 5} ‖ {A}_{5 , 6} ‖ {A}_{5 , 7} ‖ {A}_{5 , 8} ‖ - {A}_{5 , 1} ‖ {A}_{5 , 2} ‖ - {A}_{5 , 3} ‖ {A}_{5 , 4} ‖ - {A}_{5 , 5} ‖ {A}_{5 , 6} ‖ - {A}_{5 , 7} ‖ {A}_{5 , 8} ) ,$$

$${CE}_{6} = ( {A}_{6 , 1} ‖ {A}_{6 , 2} ‖ {A}_{6 , 3} ‖ {A}_{6 , 4} ‖ {A}_{6 , 5} ‖ {A}_{6 , 6} ‖ {A}_{6 , 7} ‖ {A}_{6 , 8} ‖ - {A}_{6 , 1} ‖ {A}_{6 , 2} ‖ - {A}_{6 , 3} ‖ {A}_{6 , 4} ‖ - {A}_{6 , 5} ‖ {A}_{6 , 6} ‖ - {A}_{6 , 7} ‖ {A}_{6 , 8} ) ,$$

$${CE}_{7} = ( {A}_{7 , 1} ‖ {A}_{7 , 2} ‖ {A}_{7 , 3} ‖ {A}_{7 , 4} ‖ {A}_{7 , 5} ‖ {A}_{7 , 6} ‖ {A}_{7 , 7} ‖ {A}_{7 , 8} ‖ - {A}_{7 , 1} ‖ {A}_{7 , 2} ‖ - {A}_{7 , 3} ‖ {A}_{7 , 4} ‖ - {A}_{7 , 5} ‖ {A}_{7 , 6} ‖ - {A}_{7 , 7} ‖ {A}_{7 , 8} ) , and$$

$${CE}_{8} = ( {A}_{8 , 1} ‖ {A}_{8 , 2} ‖ {A}_{8 , 3} ‖ {A}_{8 , 4} ‖ {A}_{8 , 5} ‖ {A}_{8 , 6} ‖ {A}_{8 , 7} ‖ {A}_{8 , 8} ‖ - {A}_{8 , 1} ‖ {A}_{8 , 2} ‖ - {A}_{8 , 3} ‖ {A}_{8 , 4} ‖ - {A}_{8 , 5} ‖ {A}_{8 , 6} ‖ - {A}_{8 , 7} ‖ {A}_{8 , 8} ) .$$

Periodic cross-correlation peaks of the sequence set in a zone of −127 to 127 are shown in Table 1.

TABLE 1
Cross-correlation peak

| | CE₁ | CE₂ | CE₃ | CE₄ | CE₅ | CE₆ | CE₇ | CE₈ |
|---|---|---|---|---|---|---|---|---|
| CE₁ | 2048 | 0 | 0 | 0 | 0 | 0 | 0 | 0 |
| CE₂ | 0 | 2048 | 0 | 0 | 0 | 0 | 0 | 0 |
| CE₃ | 0 | 0 | 2048 | 0 | 0 | 0 | 0 | 0 |
| CE₄ | 0 | 0 | 0 | 2048 | 0 | 0 | 0 | 0 |
| CE₅ | 0 | 0 | 0 | 0 | 2048 | 0 | 0 | 0 |
| CE₆ | 0 | 0 | 0 | 0 | 0 | 2048 | 0 | 0 |
| CE₇ | 0 | 0 | 0 | 0 | 0 | 0 | 2048 | 0 |
| CE₈ | 0 | 0 | 0 | 0 | 0 | 0 | 0 | 2048 |

In another possible implementation, in a possible implementation, it is assumed that a=Ga³₁₂₈, b=Gb³₁₂₈, c=Ga⁴₁₂₈, and d=Gb⁴₁₂₈, where Ga³₁₂₈, Gb³₁₂₈, Ga⁴₁₂₈, and Gb⁴₁₂₈ are Golay sequences whose lengths are 128 in the IEEE 802.11ay standard, and a fourth-order Hadamard matrix is used:

$$H = ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} )$$

In this way, a complete complementary code set may be obtained as follows:

A=[A₁,A₂,A₃,A₄,A₅,A₆,A₇,A₈]

Specifically,

$${A}_{1} = [ {Ga}_{128}^{3} , {Ga}_{128}^{3} , {Ga}_{128}^{3} , {Ga}_{128}^{3} , {Gb}_{128}^{3} , {Gb}_{128}^{3} , {Gb}_{128}^{3} , {Gb}_{128}^{3} ] ,$$

$${A}_{2} = [ {Ga}_{128}^{3} , - {Ga}_{128}^{3} , {Ga}_{128}^{3} , - {Ga}_{128}^{3} , {Gb}_{128}^{3} , - {Gb}_{128}^{3} , {Gb}_{128}^{3} , - {Gb}_{128}^{3} ] ,$$

$${A}_{3} = [ {Ga}_{128}^{3} , {Ga}_{128}^{3} , - {Ga}_{128}^{3} , - {Ga}_{128}^{3} , {Gb}_{128}^{3} , {Gb}_{128}^{3} , - {Gb}_{128}^{3} , - {Gb}_{128}^{3} ] ,$$

$${A}_{4} = [ {Ga}_{128}^{3} , - {Ga}_{128}^{3} , - {Ga}_{128}^{3} , {Ga}_{128}^{3} , {Gb}_{128}^{3} , - {Gb}_{128}^{3} , - {Gb}_{128}^{3} , {Gb}_{128}^{3} ] ,$$

$${A}_{5} = [ {Ga}_{128}^{4} , {Ga}_{128}^{4} , {Ga}_{128}^{4} , {Ga}_{128}^{4} , {Gb}_{128}^{4} , {Gb}_{128}^{4} , {Gb}_{128}^{4} , {Gb}_{128}^{4} ] ,$$

$${A}_{6} = [ {Ga}_{128}^{4} , - {Ga}_{128}^{4} , {Ga}_{128}^{4} , - {Ga}_{128}^{4} , {Gb}_{128}^{4} , - {Gb}_{128}^{4} , {Gb}_{128}^{4} , - {Gb}_{128}^{4} ] ,$$

$${A}_{7} = [ {Ga}_{128}^{4} , {Ga}_{128}^{4} , - {Ga}_{128}^{4} , - {Ga}_{128}^{4} , {Gb}_{128}^{4} , {Gb}_{128}^{4} , - {Gb}_{128}^{4} , - {Gb}_{128}^{4} ] ,$$

$$and$$

$${A}_{8} = [ {Ga}_{128}^{4} , - {Ga}_{128}^{4} , - {Ga}_{128}^{4} , {Ga}_{128}^{4} , {Gb}_{128}^{4} , - {Gb}_{128}^{4} , - {Gb}_{128}^{4} , {Gb}_{128}^{4} ] .$$

In this case, an 8-stream periodic zero correlation zone sequence set may be generated:

CE=[CE₁,CE₂,CE₃,CE₄,CE₅,CE₆,CE₇,CE₈]

Specifically,

$${CE}_{1} = ( {A}_{1 , 1} ‖ {A}_{1 , 2} ‖ {A}_{1 , 3} ‖ {A}_{1 , 4} ‖ {A}_{1 , 5} ‖ {A}_{1 , 6} ‖ {A}_{1 , 7} ‖ {A}_{1 , 8} ‖ - {A}_{1 , 1} ‖ {A}_{1 , 2} ‖ - {A}_{1 , 3} ‖ {A}_{1 , 4} ‖ - {A}_{1 , 5} ‖ {A}_{1 , 6} ‖ - {A}_{1 , 7} ‖ {A}_{1 , 8} ) ,$$

$${CE}_{2} = ( {A}_{2 , 1} ‖ {A}_{2 , 2} ‖ {A}_{2 , 3} ‖ {A}_{2 , 4} ‖ {A}_{2 , 5} ‖ {A}_{2 , 6} ‖ {A}_{2 , 7} ‖ {A}_{2 , 8} ‖ - {A}_{2 , 1} ‖ {A}_{2 , 2} ‖ - {A}_{2 , 3} ‖ {A}_{2 , 4} ‖ - {A}_{2 , 5} ‖ {A}_{2 , 6} ‖ - {A}_{2 , 7} ‖ {A}_{2 , 8} ) ,$$

$${CE}_{3} = ( {A}_{3 , 1} ‖ {A}_{3 , 2} ‖ {A}_{3 , 3} ‖ {A}_{3 , 4} ‖ {A}_{3 , 5} ‖ {A}_{3 , 6} ‖ {A}_{3 , 7} ‖ {A}_{3 , 8} ‖ - {A}_{3 , 1} ‖ {A}_{3 , 2} ‖ - {A}_{3 , 3} ‖ {A}_{3 , 4} ‖ - {A}_{3 , 5} ‖ {A}_{3 , 6} ‖ - {A}_{3 , 7} ‖ {A}_{3 , 8} ) ,$$

$${CE}_{4} = ( {A}_{4 , 1} ‖ {A}_{4 , 2} ‖ {A}_{4 , 3} ‖ {A}_{4 , 4} ‖ {A}_{4 , 5} ‖ {A}_{4 , 6} ‖ {A}_{4 , 7} ‖ {A}_{4 , 8} ‖ - {A}_{4 , 1} ‖ {A}_{4 , 2} ‖ - {A}_{4 , 3} ‖ {A}_{4 , 4} ‖ - {A}_{4 , 5} ‖ {A}_{4 , 6} ‖ - {A}_{4 , 7} ‖ {A}_{4 , 8} ) ,$$

$${CE}_{5} = ( {A}_{5 , 1} ‖ {A}_{5 , 2} ‖ {A}_{5 , 3} ‖ {A}_{5 , 4} ‖ {A}_{5 , 5} ‖ {A}_{5 , 6} ‖ {A}_{5 , 7} ‖ {A}_{5 , 8} ‖ - {A}_{5 , 1} ‖ {A}_{5 , 2} ‖ - {A}_{5 , 3} ‖ {A}_{5 , 4} ‖ - {A}_{5 , 5} ‖ {A}_{5 , 6} ‖ - {A}_{5 , 7} ‖ {A}_{5 , 8} ) ,$$

$${CE}_{6} = ( {A}_{6 , 1} ‖ {A}_{6 , 2} ‖ {A}_{6 , 3} ‖ {A}_{6 , 4} ‖ {A}_{6 , 5} ‖ {A}_{6 , 6} ‖ {A}_{6 , 7} ‖ {A}_{6 , 8} ‖ - {A}_{6 , 1} ‖ {A}_{6 , 2} ‖ - {A}_{6 , 3} ‖ {A}_{6 , 4} ‖ - {A}_{6 , 5} ‖ {A}_{6 , 6} ‖ - {A}_{6 , 7} ‖ {A}_{6 , 8} ) ,$$

$${CE}_{7} = ( {A}_{7 , 1} ‖ {A}_{7 , 2} ‖ {A}_{7 , 3} ‖ {A}_{7 , 4} ‖ {A}_{7 , 5} ‖ {A}_{7 , 6} ‖ {A}_{7 , 7} ‖ {A}_{7 , 8} ‖ - {A}_{7 , 1} ‖ {A}_{7 , 2} ‖ - {A}_{7 , 3} ‖ {A}_{7 , 4} ‖ - {A}_{7 , 5} ‖ {A}_{7 , 6} ‖ - {A}_{7 , 7} ‖ {A}_{7 , 8} ) , and$$

$${CE}_{8} = ( {A}_{8 , 1} ‖ {A}_{8 , 2} ‖ {A}_{8 , 3} ‖ {A}_{8 , 4} ‖ {A}_{8 , 5} ‖ {A}_{8 , 6} ‖ {A}_{8 , 7} ‖ {A}_{8 , 8} ‖ - {A}_{8 , 1} ‖ {A}_{8 , 2} ‖ - {A}_{8 , 3} ‖ {A}_{8 , 4} ‖ - {A}_{8 , 5} ‖ {A}_{8 , 6} ‖ - {A}_{8 , 7} ‖ {A}_{8 , 8} ) .$$

Periodic cross-correlation peaks of the sequence set in a zone of −127 to 127 are shown in Table 2.

TABLE 2
Cross-correlation peak

| | CE₁ | CE₂ | CE₃ | CE₄ | CE₅ | CE₆ | CE₇ | CE₈ |
|---|---|---|---|---|---|---|---|---|
| CE₁ | 2048 | 0 | 0 | 0 | 0 | 0 | 0 | 0 |
| CE₂ | 0 | 2048 | 0 | 0 | 0 | 0 | 0 | 0 |
| CE₃ | 0 | 0 | 2048 | 0 | 0 | 0 | 0 | 0 |
| CE₄ | 0 | 0 | 0 | 2048 | 0 | 0 | 0 | 0 |
| CE₅ | 0 | 0 | 0 | 0 | 2048 | 0 | 0 | 0 |
| CE₆ | 0 | 0 | 0 | 0 | 0 | 2048 | 0 | 0 |
| CE₇ | 0 | 0 | 0 | 0 | 0 | 0 | 2048 | 0 |
| CE₈ | 0 | 0 | 0 | 0 | 0 | 0 | 0 | 2048 |

In still another possible implementation, it is assumed that a=Ga³ ₁₂₈, b=Gb⁵₁₂₈, c=Ga⁶₁₂₈, and d=Gb⁶₁₂₈, where Ga⁵₁₂₈, Gb⁵₁₂₈, Ga⁶₁₂₈, and Gb⁶₁₂₈ are Golay sequences whose lengths are 128 in the IEEE 802.11ay standard, and a fourth-order Hadamard matrix is used:

$$H = ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} )$$

In this way, a complete complementary code set may be obtained as follows:

A=[A₁,A₂,A₃,A₄,A₅,A₆,A₇,A₈]

Specifically,

$${A}_{1} = [ {Ga}_{128}^{5} , {Ga}_{128}^{5} , {Ga}_{128}^{5} , {Ga}_{128}^{5} , {Gb}_{128}^{5} , {Gb}_{128}^{5} , {Gb}_{128}^{5} , {Gb}_{128}^{5} ] ,$$

$${A}_{2} = [ {Ga}_{128}^{5} , - {Ga}_{128}^{5} , {Ga}_{128}^{5} , - {Ga}_{128}^{5} , {Gb}_{128}^{5} , - {Gb}_{128}^{5} , {Gb}_{128}^{5} , - {Gb}_{128}^{5} ] ,$$

$${A}_{3} = [ {Ga}_{128}^{5} , {Ga}_{128}^{5} , - {Ga}_{128}^{5} , - {Ga}_{128}^{5} , {Gb}_{128}^{5} , {Gb}_{128}^{5} , - {Gb}_{128}^{5} , - {Gb}_{128}^{5} ] ,$$

$${A}_{4} = [ {Ga}_{128}^{5} , - {Ga}_{128}^{5} , - {Ga}_{128}^{5} , {Ga}_{128}^{5} , {Gb}_{128}^{5} , - {Gb}_{128}^{5} , - {Gb}_{128}^{5} , {Gb}_{128}^{5} ] ,$$

$${A}_{5} = [ {Ga}_{128}^{6} , {Ga}_{128}^{6} , {Ga}_{128}^{6} , {Ga}_{128}^{6} , {Gb}_{128}^{6} , {Gb}_{128}^{6} , {Gb}_{128}^{6} , {Gb}_{128}^{6} ] ,$$

$${A}_{6} = [ {Ga}_{128}^{6} , - {Ga}_{128}^{6} , {Ga}_{128}^{6} , - {Ga}_{128}^{6} , {Gb}_{128}^{6} , - {Gb}_{128}^{6} , {Gb}_{128}^{6} , - {Gb}_{128}^{6} ] ,$$

$${A}_{7} = [ {Ga}_{128}^{6} , {Ga}_{128}^{6} , - {Ga}_{128}^{6} , - {Ga}_{128}^{6} , {Gb}_{128}^{6} , {Gb}_{128}^{6} , - {Gb}_{128}^{6} , - {Gb}_{128}^{6} ] ,$$

$$and$$

$${A}_{8} = [ {Ga}_{128}^{6} , - {Ga}_{128}^{6} , - {Ga}_{128}^{6} , {Ga}_{128}^{6} , {Gb}_{128}^{6} , - {Gb}_{128}^{6} , - {Gb}_{128}^{6} , {Gb}_{128}^{6} ] .$$

In this case, an 8-stream periodic zero correlation zone sequence set may be generated:

CE=[CE₁,CE₂,CE₃,CE₄,CE₅,CE₆,CE₇,CE₈]

Specifically,

$${CE}_{1} = ( {A}_{1 , 1} ‖ {A}_{1 , 2} ‖ {A}_{1 , 3} ‖ {A}_{1 , 4} ‖ {A}_{1 , 5} ‖ {A}_{1 , 6} ‖ {A}_{1 , 7} ‖ {A}_{1 , 8} ‖ - {A}_{1 , 1} ‖ {A}_{1 , 2} ‖ - {A}_{1 , 3} ‖ {A}_{1 , 4} ‖ - {A}_{1 , 5} ‖ {A}_{1 , 6} ‖ - {A}_{1 , 7} ‖ {A}_{1 , 8} ) ,$$

$${CE}_{2} = ( {A}_{2 , 1} ‖ {A}_{2 , 2} ‖ {A}_{2 , 3} ‖ {A}_{2 , 4} ‖ {A}_{2 , 5} ‖ {A}_{2 , 6} ‖ {A}_{2 , 7} ‖ {A}_{2 , 8} ‖ - {A}_{2 , 1} ‖ {A}_{2 , 2} ‖ - {A}_{2 , 3} ‖ {A}_{2 , 4} ‖ - {A}_{2 , 5} ‖ {A}_{2 , 6} ‖ - {A}_{2 , 7} ‖ {A}_{2 , 8} ) ,$$

$${CE}_{3} = ( {A}_{3 , 1} ‖ {A}_{3 , 2} ‖ {A}_{3 , 3} ‖ {A}_{3 , 4} ‖ {A}_{3 , 5} ‖ {A}_{3 , 6} ‖ {A}_{3 , 7} ‖ {A}_{3 , 8} ‖ - {A}_{3 , 1} ‖ {A}_{3 , 2} ‖ - {A}_{3 , 3} ‖ {A}_{3 , 4} ‖ - {A}_{3 , 5} ‖ {A}_{3 , 6} ‖ - {A}_{3 , 7} ‖ {A}_{3 , 8} ) ,$$

$${CE}_{4} = ( {A}_{4 , 1} ‖ {A}_{4 , 2} ‖ {A}_{4 , 3} ‖ {A}_{4 , 4} ‖ {A}_{4 , 5} ‖ {A}_{4 , 6} ‖ {A}_{4 , 7} ‖ {A}_{4 , 8} ‖ - {A}_{4 , 1} ‖ {A}_{4 , 2} ‖ - {A}_{4 , 3} ‖ {A}_{4 , 4} ‖ - {A}_{4 , 5} ‖ {A}_{4 , 6} ‖ - {A}_{4 , 7} ‖ {A}_{4 , 8} ) ,$$

$${CE}_{5} = ( {A}_{5 , 1} ‖ {A}_{5 , 2} ‖ {A}_{5 , 3} ‖ {A}_{5 , 4} ‖ {A}_{5 , 5} ‖ {A}_{5 , 6} ‖ {A}_{5 , 7} ‖ {A}_{5 , 8} ‖ - {A}_{5 , 1} ‖ {A}_{5 , 2} ‖ - {A}_{5 , 3} ‖ {A}_{5 , 4} ‖ - {A}_{5 , 5} ‖ {A}_{5 , 6} ‖ - {A}_{5 , 7} ‖ {A}_{5 , 8} ) ,$$

$${CE}_{6} = ( {A}_{6 , 1} ‖ {A}_{6 , 2} ‖ {A}_{6 , 3} ‖ {A}_{6 , 4} ‖ {A}_{6 , 5} ‖ {A}_{6 , 6} ‖ {A}_{6 , 7} ‖ {A}_{6 , 8} ‖ - {A}_{6 , 1} ‖ {A}_{6 , 2} ‖ - {A}_{6 , 3} ‖ {A}_{6 , 4} ‖ - {A}_{6 , 5} ‖ {A}_{6 , 6} ‖ - {A}_{6 , 7} ‖ {A}_{6 , 8} ) ,$$

$${CE}_{7} = ( {A}_{7 , 1} ‖ {A}_{7 , 2} ‖ {A}_{7 , 3} ‖ {A}_{7 , 4} ‖ {A}_{7 , 5} ‖ {A}_{7 , 6} ‖ {A}_{7 , 7} ‖ {A}_{7 , 8} ‖ - {A}_{7 , 1} ‖ {A}_{7 , 2} ‖ - {A}_{7 , 3} ‖ {A}_{7 , 4} ‖ - {A}_{7 , 5} ‖ {A}_{7 , 6} ‖ - {A}_{7 , 7} ‖ {A}_{7 , 8} ) , and$$

$${CE}_{8} = ( {A}_{8 , 1} ‖ {A}_{8 , 2} ‖ {A}_{8 , 3} ‖ {A}_{8 , 4} ‖ {A}_{8 , 5} ‖ {A}_{8 , 6} ‖ {A}_{8 , 7} ‖ {A}_{8 , 8} ‖ - {A}_{8 , 1} ‖ {A}_{8 , 2} ‖ - {A}_{8 , 3} ‖ {A}_{8 , 4} ‖ - {A}_{8 , 5} ‖ {A}_{8 , 6} ‖ - {A}_{8 , 7} ‖ {A}_{8 , 8} ) .$$

Periodic cross-correlation peaks of the sequence set in a zone of −127 to 127 are shown in Table 3.

TABLE 3
Cross-correlation peak

| | CE₁ | CE₂ | CE₃ | CE₄ | CE₅ | CE₆ | CE₇ | CE₈ |
|---|---|---|---|---|---|---|---|---|
| CE₁ | 2048 | 0 | 0 | 0 | 0 | 0 | 0 | 0 |
| CE₂ | 0 | 2048 | 0 | 0 | 0 | 0 | 0 | 0 |
| CE₃ | 0 | 0 | 2048 | 0 | 0 | 0 | 0 | 0 |
| CE₄ | 0 | 0 | 0 | 2048 | 0 | 0 | 0 | 0 |
| CE₅ | 0 | 0 | 0 | 0 | 2048 | 0 | 0 | 0 |
| CE₆ | 0 | 0 | 0 | 0 | 0 | 2048 | 0 | 0 |
| CE₇ | 0 | 0 | 0 | 0 | 0 | 0 | 2048 | 0 |
| CE₈ | 0 | 0 | 0 | 0 | 0 | 0 | 0 | 2048 |

In yet another possible implementation, it is assumed that a=Ga⁷₁₂₈, b=Gb⁷₁₂₈, c=Ga⁸₁₂₈, and d=Gb⁸₁₂₈, where Ga⁷₁₂₈, Gb⁷₁₂₈, Ga³₁₂₈, and Gb⁸₁₂₈ are Golay sequences whose lengths are 128 in the IEEE 802.11ay standard, and a fourth-order Hadamard matrix is used:

$$H = ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} )$$

In this way, a complete complementary code set may be obtained as follows:

A=[A₁,A₂,A₃,A₄,A₅,A₆,A₇,A₈]

Specifically,

$${A}_{1} = [ {Ga}_{128}^{7} , {Ga}_{128}^{7} , {Ga}_{128}^{7} , {Ga}_{128}^{7} , {Gb}_{128}^{7} , {Gb}_{128}^{7} , {Gb}_{128}^{7} , {Gb}_{128}^{7} ] ,$$

$${A}_{2} = [ {Ga}_{128}^{7} , - {Ga}_{128}^{7} , {Ga}_{128}^{7} , - {Ga}_{128}^{7} , {Gb}_{128}^{7} , - {Gb}_{128}^{7} , {Gb}_{128}^{7} , - {Gb}_{128}^{7} ] ,$$

$${A}_{3} = [ {Ga}_{128}^{7} , {Ga}_{128}^{7} , - {Ga}_{128}^{7} , - {Ga}_{128}^{7} , {Gb}_{128}^{7} , {Gb}_{128}^{7} , - {Gb}_{128}^{7} , - {Gb}_{128}^{7} ] ,$$

$${A}_{4} = [ {Ga}_{128}^{7} , - {Ga}_{128}^{7} , - {Ga}_{128}^{7} , {Ga}_{128}^{7} , {Gb}_{128}^{7} , - {Gb}_{128}^{7} , - {Gb}_{128}^{7} , {Gb}_{128}^{7} ] ,$$

$${A}_{5} = [ {Ga}_{128}^{8} , {Ga}_{128}^{8} , {Ga}_{128}^{8} , {Ga}_{128}^{8} , {Gb}_{128}^{8} , {Gb}_{128}^{8} , {Gb}_{128}^{8} , {Gb}_{128}^{8} ] ,$$

$${A}_{6} = [ {Ga}_{128}^{8} , - {Ga}_{128}^{8} , {Ga}_{128}^{8} , - {Ga}_{128}^{8} , {Gb}_{128}^{8} , - {Gb}_{128}^{8} , {Gb}_{128}^{8} , - {Gb}_{128}^{8} ] ,$$

$${A}_{7} = [ {Ga}_{128}^{8} , {Ga}_{128}^{8} , - {Ga}_{128}^{8} , - {Ga}_{128}^{8} , {Gb}_{128}^{8} , {Gb}_{128}^{8} , - {Gb}_{128}^{8} , - {Gb}_{128}^{8} ] ,$$

$$and$$

$${A}_{8} = [ {Ga}_{128}^{8} , - {Ga}_{128}^{8} , - {Ga}_{128}^{8} , {Ga}_{128}^{8} , {Gb}_{128}^{8} , - {Gb}_{128}^{8} , - {Gb}_{128}^{8} , {Gb}_{128}^{8} ] .$$

In this case, an 8-stream periodic zero correlation zone sequence set may be generated:

CE=[CE₁,CE₂,CE₃,CE₄,CE₅,CE₆,CE₇,CE₈]

Specifically,

$${CE}_{1} = ( {A}_{1 , 1} ‖ {A}_{1 , 2} ‖ {A}_{1 , 3} ‖ {A}_{1 , 4} ‖ {A}_{1 , 5} ‖ {A}_{1 , 6} ‖ {A}_{1 , 7} ‖ {A}_{1 , 8} ‖ - {A}_{1 , 1} ‖ {A}_{1 , 2} ‖ - {A}_{1 , 3} ‖ {A}_{1 , 4} ‖ - {A}_{1 , 5} ‖ {A}_{1 , 6} ‖ - {A}_{1 , 7} ‖ {A}_{1 , 8} ) ,$$

$${CE}_{2} = ( {A}_{2 , 1} ‖ {A}_{2 , 2} ‖ {A}_{2 , 3} ‖ {A}_{2 , 4} ‖ {A}_{2 , 5} ‖ {A}_{2 , 6} ‖ {A}_{2 ,} 7 ‖ {A}_{2 , 8} ‖ - {A}_{2 , 1} ‖ {A}_{2 , 2} ‖ - {A}_{2 , 3} ‖ {A}_{2 , 4} ‖ - {A}_{2 , 5} ‖ {A}_{2 , 6} ‖ - {A}_{2 , 7} ‖ {A}_{2 , 8} ) ,$$

$${CE}_{3} = ( {A}_{3 , 1} ‖ {A}_{3 , 2} ‖ {A}_{3 , 3} ‖ {A}_{3 , 4} ‖ {A}_{3 , 5} ‖ {A}_{3 , 6} ‖ {A}_{3 , 7} ‖ {A}_{3 , 8} ‖ - {A}_{3 , 1} ‖ {A}_{3 , 2} ‖ - {A}_{3 , 3} ‖ {A}_{3 , 4} ‖ - {A}_{3 , 5} ‖ {A}_{3 , 6} ‖ - {A}_{3 , 7} ‖ {A}_{3 , 8} ) ,$$

$${CE}_{4} = ( {A}_{4 , 1} ‖ {A}_{4 , 2} ‖ {A}_{4 , 3} ‖ {A}_{4 , 4} ‖ {A}_{4 , 5} ‖ {A}_{4 , 6} ‖ {A}_{4 , 7} ‖ {A}_{4 , 8} ‖ - {A}_{4 , 1} ‖ {A}_{4 , 2} ‖ - {A}_{4 , 3} ‖ {A}_{4 , 4} ‖ - {A}_{4 , 5} ‖ {A}_{4 , 6} ‖ - {A}_{4 , 7} ‖ {A}_{4 , 8} ) ,$$

$${CE}_{5} = ( {A}_{5 , 1} ‖ {A}_{5 , 2} ‖ {A}_{5 , 3} ‖ {A}_{5 , 4} ‖ {A}_{5 , 5} ‖ {A}_{5 , 6} ‖ {A}_{5 , 7} ‖ {A}_{5 , 8} ‖ - {A}_{5 , 1} ‖ {A}_{5 , 2} ‖ - {A}_{5 , 3} ‖ {A}_{5 , 4} ‖ - {A}_{5 , 5} ‖ {A}_{5 , 6} ‖ - {A}_{5 , 7} ‖ {A}_{5 , 8} ) ,$$

$${CE}_{6} = ( {A}_{6 , 1} ‖ {A}_{6 , 2} ‖ {A}_{6 , 3} ‖ {A}_{6 , 4} ‖ {A}_{6 , 5} ‖ {A}_{6 , 6} ‖ {A}_{6 , 7} ‖ {A}_{6 , 8} ‖ - {A}_{6 , 1} ‖ {A}_{6 , 2} ‖ - {A}_{6 , 3} ‖ {A}_{6 , 4} ‖ - {A}_{6 , 5} ‖ {A}_{6 , 6} ‖ - {A}_{6 , 7} ‖ {A}_{6 , 8} ) ,$$

$${CE}_{7} = ( {A}_{7 , 1} ‖ {A}_{7 , 2} ‖ {A}_{7 , 3} ‖ {A}_{7 , 4} ‖ {A}_{7 , 5} ‖ {A}_{7 , 6} ‖ {A}_{7 , 7} ‖ {A}_{7 , 8} ‖ - {A}_{7 , 1} ‖ {A}_{7 , 2} ‖ - {A}_{7 , 3} ‖ {A}_{7 , 4} ‖ - {A}_{7 , 5} ‖ {A}_{7 , 6} ‖ - {A}_{7 , 7} ‖ {A}_{7 , 8} ) , and$$

$${CE}_{8} = ( {A}_{8 , 1} ‖ {A}_{8 , 2} ‖ {A}_{8 , 3} ‖ {A}_{8 , 4} ‖ {A}_{8 , 5} ‖ {A}_{8 , 6} ‖ {A}_{8 , 7} ‖ {A}_{8 , 8} ‖ - {A}_{8 , 1} ‖ {A}_{8 , 2} ‖ - {A}_{8 , 3} ‖ {A}_{8 , 4} ‖ - {A}_{8 , 5} ‖ {A}_{8 , 6} ‖ - {A}_{8 , 7} ‖ {A}_{8 , 8} ) .$$

Periodic cross-correlation peaks of the sequence set in a zone of −127 to 127 are shown in Table 4.

TABLE 4
Cross-correlation peak

| | CE₁ | CE₂ | CE₃ | CE₄ | CE₅ | CE₆ | CE₇ | CE₈ |
|---|---|---|---|---|---|---|---|---|
| CE₁ | 2048 | 0 | 0 | 0 | 0 | 0 | 0 | 0 |
| CE₂ | 0 | 2048 | 0 | 0 | 0 | 0 | 0 | 0 |
| CE₃ | 0 | 0 | 2048 | 0 | 0 | 0 | 0 | 0 |
| CE₄ | 0 | 0 | 0 | 2048 | 0 | 0 | 0 | 0 |
| CE₅ | 0 | 0 | 0 | 0 | 2048 | 0 | 0 | 0 |
| CE₆ | 0 | 0 | 0 | 0 | 0 | 2048 | 0 | 0 |
| CE₇ | 0 | 0 | 0 | 0 | 0 | 0 | 2048 | 0 |
| CE₈ | 0 | 0 | 0 | 0 | 0 | 0 | 0 | 2048 |

S602: The transmitter sends the first sequence to a receiver, and correspondingly, the receiver receives the first sequence.

For example, the transmitter sends a physical layer protocol data unit PPDU to the receiver, where the physical layer protocol data unit includes the first sequence.

The transmitter may send the first sequence to the receiver through an antenna. In a possible manner, a sending structure of the i^{th} antenna in a reflection period is shown in FIG. 7.

The transmitter may send the first sequence to the receiver through an antenna, and all antennas of the receiver may receive the first sequence. For example, when a value of a quantity of streams is 8, each of the eight antennas at the transmitter is configured to send a sequence. For example, the eight antennas at the transmitter are configured to send eight sequences, the eight sequences are used for channel estimation, and sequences sent through the eight antennas may be different from each other. Eight antennas at the receiver are configured to receive the eight sequences, the eight antennas at the receiver may separately receive sequences that are different from each other, and each of the eight antennas at the receiver may also receive a plurality of sequences. This is not limited in this embodiment of this application.

It should be understood that the transmitter in step S601 and step 602 may be the network device or the terminal device described above, and the receiver may be the network device or the terminal device described above. This is not limited in this embodiment of this application.

S603: The receiver performs at least one of channel estimation, target sensing, or time synchronization based on the first sequence.

Optionally, the channel estimation may be MIMO channel estimation in a high frequency standard (for example, 802.11ay).

In the method, use of a P-matrix is avoided in a process of constructing a plurality of streams of zero correlation sequences. This reduces complexity of constructing a CE sequence, shortens a length of the CE sequence, reduces resource occupation, and also reduces a channel estimation delay and improves channel estimation efficiency.

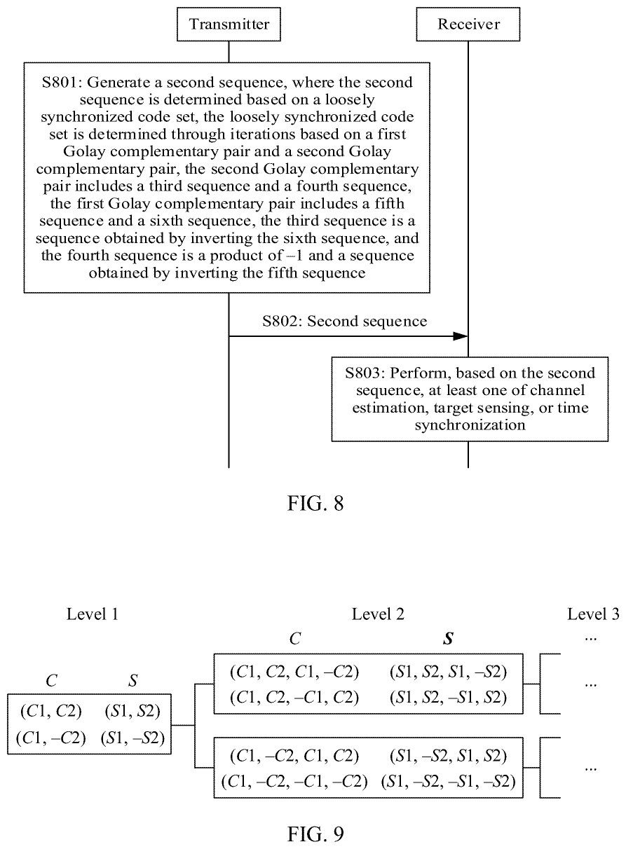

An embodiment of this application provides another communication method. As shown in FIG. 8, the method includes the following steps.

S801: A transmitter generates a second sequence, where the second sequence is determined based on a loosely synchronized (LS) code set, the loosely synchronized code set is determined through iterations based on a first Golay complementary pair and a second Golay complementary pair, the second Golay complementary pair includes a third sequence and a fourth sequence, the first Golay complementary pair includes a fifth sequence and a sixth sequence, the third sequence is a sequence obtained by inverting the sixth sequence, the fourth sequence is a product of −1 and a sequence obtained by inverting the fifth sequence, and the second sequence is used for at least one of channel estimation, target sensing, or time synchronization.

The second sequence may be one sequence in a zero correlation zone sequence set, and any sequence in the zero correlation zone sequence set may be determined based on the loosely synchronized code set.

The following provides a manner of determining the loosely synchronized code set. A first sequence set and a second sequence set are generated based on the first Golay complementary pair and the second Golay complementary pair. For example, a Golay complementary pair (C1, S1) with a length of L is given, the Golay complementary pair is the first Golay complementary pair, C1 is the fifth sequence, and S1 is the sixth sequence. It is assumed that C2=S̅1̅ and S2=C̅1̅, where S̅1̅ (namely, the third sequence) and C̅1̅ (namely, the fourth sequence) are sequences obtained by inverting S1 and C1, respectively. k iterations shown in FIG. 9 are performed on the first Golay complementary pair and the second Golay complementary pair for construction, to generate a new sequence set C=(Cᵢ^{k})ᵢ₌₁²^{^{k}} with a size of 2^{k}, namely, the first sequence set, and S=(Sᵢ^{k})ᵢ₌₁²^{^{k}}, namely, the second sequence set. k is a positive integer.

ALS code set LS=(LSₖ)ₖ₌₁²^{^{k}} may be generated based on the first sequence set and the second sequence set, where (LSₖ=(Cᵢ^{k}∥0_{z}∥Sᵢ^{k})), and Z is a width of a zero correlation zone.

Further, a CE sequence set may be generated based on the LS code set. For example, CEₖ=LSₖ.

In a possible implementation, it is assumed that C1=Ga¹₁₂₈, S1=Gb¹₁₂₈, C2=S̅1̅=Ga₁₂₈², and S2=C̅1̅=Gb₁₂₈², where Ga¹₁₂₈, Gb¹₁₂₈, Ga²₁₂₈, and Gb²₁₂₈ are Golay sequences whose lengths are 128 in the IEEE 802.11ay standard. It is assumed that three iterations are performed, and the following may be obtained:

C=(C₁³, C₂³,C₃³,C₄³,C₅³,C₆³,C₇³,C₈³)

S=(S₁³,S₂³,S₃³,S₄³,S₅³, S₆³,S₇³,S₈³)

Specifically:

$${C}_{1}^{3} = [ {Ga}_{128}^{3} ‖ {Ga}_{128}^{4} ‖ {Ga}_{128}^{3} ‖ - {Ga}_{128}^{4} ‖ {Ga}_{128}^{3} ‖ {Ga}_{128}^{4} ‖ - {Ga}_{128}^{3} ‖ {Ga}_{128}^{4} ] ,$$

$${C}_{2}^{3} = [ {Ga}_{128}^{3} ‖ {Ga}_{128}^{4} ‖ {Ga}_{128}^{3} ‖ - {Ga}_{128}^{4} ‖ - {Ga}_{128}^{3} ‖ - {Ga}_{128}^{4} ‖ {Ga}_{128}^{3} ‖ - {Ga}_{128}^{4} ] ,$$

$${C}_{3}^{3} = [ {Ga}_{128}^{3} ‖ {Ga}_{128}^{4} ‖ - {Ga}_{128}^{3} ‖ {Ga}_{128}^{4} ‖ {Ga}_{128}^{3} ‖ {Ga}_{128}^{4} ‖ {Ga}_{128}^{3} ‖ - {Ga}_{128}^{4} ] ,$$

$${C}_{4}^{3} = [ {Ga}_{128}^{3} ‖ {Ga}_{128}^{4} ‖ - {Ga}_{128}^{3} ‖ {Ga}_{128}^{4} ‖ - {Ga}_{128}^{3} ‖ - {Ga}_{128}^{4} ‖ - {Ga}_{128}^{3} ‖ {Ga}_{128}^{4} ] ,$$

$${C}_{5}^{3} = [ {Ga}_{128}^{3} ‖ - {Ga}_{128}^{4} ‖ {Ga}_{128}^{3} ‖ {Ga}_{128}^{4} ‖ {Ga}_{128}^{3} ‖ - {Ga}_{128}^{4} ‖ - {Ga}_{128}^{3} ‖ - {Ga}_{128}^{4} ] ,$$

$${C}_{6}^{3} = [ {Ga}_{128}^{3} ‖ - {Ga}_{128}^{4} ‖ {Ga}_{128}^{3} ‖ {Ga}_{128}^{4} ‖ - {Ga}_{128}^{3} ‖ {Ga}_{128}^{4} ‖ {Ga}_{128}^{3} ‖ {Ga}_{128}^{4} ] ,$$

$${C}_{7}^{3} = [ {Ga}_{128}^{3} ‖ - {Ga}_{128}^{4} ‖ - {Ga}_{128}^{3} ‖ - {Ga}_{128}^{4} ‖ {Ga}_{128}^{3} ‖ - {Ga}_{128}^{4} ‖ {Ga}_{128}^{3} ‖ {Ga}_{128}^{4} ] ,$$

$${C}_{8}^{3} = [ {Ga}_{128}^{3} ‖ - {Ga}_{128}^{4} ‖ - {Ga}_{128}^{3} ‖ - {Ga}_{128}^{4} ‖ - {Ga}_{128}^{3} ‖ {Ga}_{128}^{4} ‖ - {Ga}_{128}^{3} ‖ - {Ga}_{128}^{4} ] ,$$

$${S}_{1}^{3} = [ {Gb}_{128}^{3} ‖ {Gb}_{128}^{4} ‖ {Gb}_{128}^{3} ‖ - {Gb}_{128}^{4} ‖ {Gb}_{128}^{3} ‖ {Gb}_{128}^{4} ‖ - {Gb}_{128}^{3} ‖ {Gb}_{128}^{4} ] ,$$

$${S}_{2}^{3} = [ {Gb}_{128}^{3} ‖ {Gb}_{128}^{4} ‖ {Gb}_{128}^{3} ‖ - {Gb}_{128}^{4} ‖ - {Gb}_{128}^{3} ‖ - {Gb}_{128}^{4} ‖ {Gb}_{128}^{3} ‖ - {Gb}_{128}^{4} ] ,$$

$${S}_{3}^{3} = [ {Gb}_{128}^{3} ‖ {Gb}_{128}^{4} ‖ - {Gb}_{128}^{3} ‖ {Gb}_{128}^{4} ‖ {Gb}_{128}^{3} ‖ {Gb}_{128}^{4} ‖ {Gb}_{128}^{3} ‖ - {Gb}_{128}^{4} ] ,$$

$${S}_{4}^{3} = [ {Gb}_{128}^{3} ‖ {Gb}_{128}^{4} ‖ - {Gb}_{128}^{3} ‖ {Gb}_{128}^{4} ‖ - {Gb}_{128}^{3} ‖ - {Gb}_{128}^{4} ‖ - {Gb}_{128}^{3} ‖ {Gb}_{128}^{4} ] ,$$

$${S}_{5}^{3} = [ {Gb}_{128}^{3} ‖ - {Gb}_{128}^{4} ‖ {Gb}_{128}^{3} ‖ {Gb}_{128}^{4} ‖ {Gb}_{128}^{3} ‖ - {Gb}_{128}^{4} ‖ {Gb}_{128}^{3} ‖ - {Gb}_{128}^{4} ] ,$$

$${S}_{6}^{3} = [ {Gb}_{128}^{3} ‖ - {Gb}_{128}^{4} ‖ {Gb}_{128}^{3} ‖ {Gb}_{128}^{4} ‖ - {Gb}_{128}^{3} ‖ {Gb}_{128}^{4} ‖ {Gb}_{128}^{3} ‖ {Gb}_{128}^{4} ] ,$$

$${S}_{7}^{3} = [ {Gb}_{128}^{3} ‖ - {Gb}_{128}^{4} ‖ - {Gb}_{128}^{3} ‖ - {Gb}_{128}^{4} ‖ {Gb}_{128}^{3} ‖ - {Gb}_{128}^{4} ‖ {Gb}_{128}^{3} ‖ {Gb}_{128}^{4} ] ,$$

$${S}_{8}^{3} = [ {Gb}_{128}^{3} ‖ - {Gb}_{128}^{4} ‖ - {Gb}_{128}^{3} ‖ - {Gb}_{128}^{4} ‖ - {Gb}_{128}^{3} ‖ {Gb}_{128}^{4} ‖ - {Gb}_{128}^{3} ‖ - {Gb}_{128}^{4} ] .$$

In this case, an 8-stream aperiodic zero correlation zone sequence set may be generated:

CE=[CE₁,CE₂,CE₃,CE₄,CE₅,CE₆,CE₇, CE₈]

Specifically:

$${CE}_{1} = ( {Ga}_{128}^{1} {PGa}_{128}^{2} {PGa}_{128}^{1} P - {Ga}_{128}^{2} {PGa}_{128}^{1} {PGa}_{128}^{2} P - {Ga}_{128}^{1} {PGa}_{128}^{2} P {0}_{128} {PGb}_{128}^{1} {PGb}_{128}^{2} {PGb}_{128}^{1} P - {Gb}_{128}^{2} {PGb}_{128}^{1} {PGb}_{128}^{2} P - {Gb}_{128}^{1} {PGb}_{128}^{2} )$$

$${CE}_{2} = ( {Ga}_{128}^{1} {PGa}_{128}^{2} {PGa}_{128}^{1} P - {Ga}_{128}^{2} P - {Ga}_{128}^{1} P - {Ga}_{128}^{2} {PGa}_{128}^{1} P - {Ga}_{128}^{2} P {0}_{128} {PGb}_{128}^{1} {PGb}_{128}^{2} {PGb}_{128}^{1} P - {Gb}_{128}^{2} P - {Gb}_{128}^{1} P - {Gb}_{128}^{2} {PGb}_{128}^{1} P - {Gb}_{128}^{2} )$$

$${CE}_{3} = ( {Ga}_{128}^{1} {PGa}_{128}^{2} P - {Ga}_{128}^{1} {PGa}_{128}^{2} {PGa}_{128}^{1} {PGa}_{128}^{2} {PGa}_{128}^{1} P - {Ga}_{128}^{2} P {0}_{128} {PGb}_{128}^{1} {PGb}_{128}^{2} P - {Gb}_{128}^{1} P - {Gb}_{128}^{2} {PGb}_{128}^{1} {PGb}_{128}^{2} {PGb}_{128}^{1} P - {Gb}_{128}^{2} )$$

$${CE}_{4} = ( {Ga}_{128}^{1} {PGa}_{128}^{2} P - {Ga}_{128}^{1} {PGa}_{128}^{2} P - {Ga}_{128}^{1} P - {Ga}_{128}^{2} P - {Ga}_{128}^{1} {PGa}_{128}^{2} P {0}_{128} {PGb}_{128}^{1} {PGb}_{128}^{2} P - {Gb}_{128}^{1} {PGb}_{128}^{2} P - {Gb}_{128}^{1} P - {Gb}_{128}^{2} P - {Gb}_{128}^{1} {PGb}_{128}^{2} )$$

$${CE}_{5} = ( {Ga}_{128}^{1} P - {Ga}_{128}^{2} {PGa}_{128}^{1} {PGa}_{128}^{2} {PGa}_{128}^{1} P - {Ga}_{128}^{2} P - {Ga}_{128}^{1} P - {Ga}_{128}^{2} P {0}_{128} {PGb}_{128}^{1} P - {Gb}_{128}^{2} P - {Gb}_{128}^{1} {PGb}_{128}^{2} {PGb}_{128}^{1} P - {Gb}_{128}^{2} P - {Gb}_{128}^{1} P - {Gb}_{128}^{2} )$$

$${CE}_{6} = ( {Ga}_{128}^{1} P - {Ga}_{128}^{2} {PGa}_{128}^{1} {PGa}_{128}^{2} P - {Ga}_{128}^{1} {PGa}_{128}^{2} {PGa}_{128}^{1} {PGa}_{128}^{2} P {0}_{128} {PGb}_{128}^{1} P - {Gb}_{128}^{2} {PGb}_{128}^{1} {PGb}_{128}^{2} P - {Gb}_{128}^{1} {PGb}_{128}^{2} {PGb}_{128}^{1} {PGb}_{128}^{2} )$$

$${CE}_{7} = ( {Ga}_{128}^{1} P - {Ga}_{128}^{2} P - {Ga}_{128}^{1} P - {Ga}_{128}^{2} {PGa}_{128}^{1} P - {Ga}_{128}^{2} {PGa}_{128}^{1} {PGa}_{128}^{2} P {0}_{128} {PGb}_{128}^{1} P - {Gb}_{128}^{2} P - {Gb}_{128}^{1} P - {Gb}_{128}^{2} {PGb}_{128}^{1} P - {Gb}_{128}^{2} {PGb}_{128}^{1} {PGb}_{128}^{2} )$$

$${CE}_{8} = ( {Ga}_{128}^{1} P - {Ga}_{128}^{2} P - {Ga}_{128}^{1} P - {Ga}_{128}^{2} P - {Ga}_{128}^{1} {PGa}_{128}^{2} P - {Ga}_{128}^{1} P - {Ga}_{128}^{2} P {0}_{128} P - {Gb}_{128}^{1} P - {Gb}_{128}^{2} P - {Gb}_{128}^{1} P - {Gb}_{128}^{2} {PGb}_{128}^{1} {PGb}_{128}^{2} P - {Gb}_{128}^{1} P - {Gb}_{128}^{2} )$$

Aperiodic cross-correlation peaks of the CE sequence set in a zone of −127 to 127 are shown in Table 5.

TABLE 5
Cross-correlation peak

| | CE₁ | CE₂ | CE₃ | CE₄ | CE₅ | CE₆ | CE₇ | CE₈ |
|---|---|---|---|---|---|---|---|---|
| CE₁ | 2048 | 0 | 0 | 0 | 0 | 0 | 0 | 0 |
| CE₂ | 0 | 2048 | 0 | 0 | 0 | 0 | 0 | 0 |
| CE₃ | 0 | 0 | 2048 | 0 | 0 | 0 | 0 | 0 |
| CE₄ | 0 | 0 | 0 | 2048 | 0 | 0 | 0 | 0 |
| CE₅ | 0 | 0 | 0 | 0 | 2048 | 0 | 0 | 0 |
| CE₆ | 0 | 0 | 0 | 0 | 0 | 2048 | 0 | 0 |
| CE₇ | 0 | 0 | 0 | 0 | 0 | 0 | 2048 | 0 |
| CE₈ | 0 | 0 | 0 | 0 | 0 | 0 | 0 | 2048 |

In a possible implementation, it is assumed that C1=Ga³₁₂₈, S1=Gb⁴₁₂₈, C2=S̅1̅=Ga₁₂₈, and S2=−C̅1̅=Gb₁₂₈⁴, where Ga³₁₂₈, Gb³₁₂₈, Ga⁴₁₂₈, and Gb⁴₁₂₈ are Golay sequences whose lengths are 128 in the IEEE 802.11ay standard. It is assumed that three iterations are performed, and the following may be obtained:

C=(C₁³,C₂³,C₃³,C₄³,C₅³,C₆³,C₇³, C₈³)

S=(S₁³,S₂³,S₃³,S₄³,S₅³,S₆³,S₇³,S₈³)

Specifically:

$${C}_{1}^{3} = [ {Ga}_{128}^{3} ‖ {Ga}_{128}^{4} ‖ {Ga}_{128}^{3} ‖ - {Ga}_{128}^{4} ‖ {Ga}_{128}^{3} ‖ {Ga}_{128}^{4} ‖ - {Ga}_{128}^{3} ‖ {Ga}_{128}^{4} ] ,$$

$${C}_{2}^{3} = [ {Ga}_{128}^{3} ‖ {Ga}_{128}^{4} ‖ {Ga}_{128}^{3} ‖ - {Ga}_{128}^{4} ‖ - {Ga}_{128}^{3} ‖ - {Ga}_{128}^{4} ‖ {Ga}_{128}^{3} ‖ - {Ga}_{128}^{4} ] ,$$

$${C}_{3}^{3} = [ {Ga}_{128}^{3} ‖ {Ga}_{128}^{4} ‖ - {Ga}_{128}^{3} ‖ {Ga}_{128}^{4} ‖ {Ga}_{128}^{3} ‖ {Ga}_{128}^{4} ‖ {Ga}_{128}^{3} ‖ - {Ga}_{128}^{4} ] ,$$

$${C}_{4}^{3} = [ {Ga}_{128}^{3} ‖ {Ga}_{128}^{4} ‖ - {Ga}_{128}^{3} ‖ {Ga}_{128}^{4} ‖ - {Ga}_{128}^{3} ‖ - {Ga}_{128}^{4} ‖ - {Ga}_{128}^{3} ‖ {Ga}_{128}^{4} ] ,$$

$${C}_{5}^{3} = [ {Ga}_{128}^{3} ‖ - {Ga}_{128}^{4} ‖ {Ga}_{128}^{3} ‖ {Ga}_{128}^{4} ‖ {Ga}_{128}^{3} ‖ - {Ga}_{128}^{4} ‖ - {Ga}_{128}^{3} ‖ - {Ga}_{128}^{4} ] ,$$

$${C}_{6}^{3} = [ {Ga}_{128}^{3} ‖ - {Ga}_{128}^{4} ‖ {Ga}_{128}^{3} ‖ {Ga}_{128}^{4} ‖ - {Ga}_{128}^{3} ‖ {Ga}_{128}^{4} ‖ {Ga}_{128}^{3} ‖ {Ga}_{128}^{4} ] ,$$

$${C}_{7}^{3} = [ {Ga}_{128}^{3} ‖ - {Ga}_{128}^{4} ‖ - {Ga}_{128}^{3} ‖ - {Ga}_{128}^{4} ‖ {Ga}_{128}^{3} ‖ - {Ga}_{128}^{4} ‖ {Ga}_{128}^{3} ‖ {Ga}_{128}^{4} ] ,$$

$${C}_{8}^{3} = [ {Ga}_{128}^{3} ‖ - {Ga}_{128}^{4} ‖ - {Ga}_{128}^{3} ‖ - {Ga}_{128}^{4} ‖ - {Ga}_{128}^{3} ‖ {Ga}_{128}^{4} ‖ - {Ga}_{128}^{3} ‖ - {Ga}_{128}^{4} ] ,$$

$${S}_{1}^{3} = [ {Gb}_{128}^{3} ‖ {Gb}_{128}^{4} ‖ {Gb}_{128}^{3} ‖ - {Gb}_{128}^{4} ‖ {Gb}_{128}^{3} ‖ {Gb}_{128}^{4} ‖ - {Gb}_{128}^{3} ‖ {Gb}_{128}^{4} ] ,$$

$${S}_{2}^{3} = [ {Gb}_{128}^{3} ‖ {Gb}_{128}^{4} ‖ {Gb}_{128}^{3} ‖ - {Gb}_{128}^{4} ‖ - {Gb}_{128}^{3} ‖ - {Gb}_{128}^{4} ‖ {Gb}_{128}^{3} ‖ - {Gb}_{128}^{4} ] ,$$

$${S}_{3}^{3} = [ {Gb}_{128}^{3} ‖ {Gb}_{128}^{4} ‖ - {Gb}_{128}^{3} ‖ {Gb}_{128}^{4} ‖ {Gb}_{128}^{3} ‖ {Gb}_{128}^{4} ‖ {Gb}_{128}^{3} ‖ - {Gb}_{128}^{4} ] ,$$

$${S}_{4}^{3} = [ {Gb}_{128}^{3} ‖ {Gb}_{128}^{4} ‖ - {Gb}_{128}^{3} ‖ {Gb}_{128}^{4} ‖ - {Gb}_{128}^{3} ‖ - {Gb}_{128}^{4} ‖ - {Gb}_{128}^{3} ‖ {Gb}_{128}^{4} ] ,$$

$${S}_{5}^{3} = [ {Gb}_{128}^{3} ‖ - {Gb}_{128}^{4} ‖ {Gb}_{128}^{3} ‖ {Gb}_{128}^{4} ‖ {Gb}_{128}^{3} ‖ - {Gb}_{128}^{4} ‖ {Gb}_{128}^{3} ‖ - {Gb}_{128}^{4} ] ,$$

$${S}_{6}^{3} = [ {Gb}_{128}^{3} ‖ - {Gb}_{128}^{4} ‖ {Gb}_{128}^{3} ‖ {Gb}_{128}^{4} ‖ - {Gb}_{128}^{3} ‖ {Gb}_{128}^{4} ‖ {Gb}_{128}^{3} ‖ {Gb}_{128}^{4} ] ,$$

$${S}_{7}^{3} = [ {Gb}_{128}^{3} ‖ - {Gb}_{128}^{4} ‖ - {Gb}_{128}^{3} ‖ - {Gb}_{128}^{4} ‖ {Gb}_{128}^{3} ‖ - {Gb}_{128}^{4} ‖ {Gb}_{128}^{3} ‖ {Gb}_{128}^{4} ] ,$$

$${S}_{8}^{3} = [ {Gb}_{128}^{3} ‖ - {Gb}_{128}^{4} ‖ - {Gb}_{128}^{3} ‖ - {Gb}_{128}^{4} ‖ - {Gb}_{128}^{3} ‖ {Gb}_{128}^{4} ‖ - {Gb}_{128}^{3} ‖ - {Gb}_{128}^{4} ] .$$

In this case, an 8-stream aperiodic zero correlation zone sequence set may be generated:

CE=[CE₁,CE₂,CE₃,CE₄,CE₅,CE₆,CE₇,CE₈]

Specifically:

$${CE}_{1} = ( {Ga}_{128}^{3} ‖ {Ga}_{128}^{4} ‖ {Ga}_{128}^{3} ‖ - {Ga}_{128}^{4} ‖ {Ga}_{128}^{3} ‖ {Ga}_{128}^{4} ‖ - {Ga}_{128}^{3} ‖ {Ga}_{128}^{4} ‖ {0}_{128} ‖ {Gb}_{128}^{3} ‖ {Gb}_{128}^{4} ‖ {Gb}_{128}^{3} ‖ - {Gb}_{128}^{4} ‖ {Gb}_{128}^{3} ‖ {Gb}_{128}^{4} ‖ - {Gb}_{128}^{3} ‖ {Gb}_{128}^{4} ‖ ) ,$$

$${CE}_{2} = ( {Ga}_{128}^{3} ‖ {Ga}_{128}^{4} ‖ {Ga}_{128}^{3} ‖ - {Ga}_{128}^{4} ‖ - {Ga}_{128}^{3} ‖ - {Ga}_{128}^{4} ‖ {Ga}_{128}^{3} ‖ - {Ga}_{128}^{4} ‖ {0}_{128} ‖ {Gb}_{128}^{3} ‖ {Gb}_{128}^{4} ‖ {Gb}_{128}^{3} ‖ - {Gb}_{128}^{4} ‖ - {Gb}_{128}^{3} ‖ - {Gb}_{128}^{4} ‖ - {Gb}_{128}^{3} ‖ {Gb}_{128}^{4} ‖ ) ,$$

$${CE}_{3} = ( {Ga}_{128}^{3} ‖ {Ga}_{128}^{4} ‖ - {Ga}_{128}^{3} ‖ {Ga}_{128}^{4} ‖ {Ga}_{128}^{3} ‖ {Ga}_{128}^{4} ‖ {Ga}_{128}^{3} ‖ - {Ga}_{128}^{4} ‖ {0}_{128} ‖ {Gb}_{128}^{3} ‖ {Gb}_{128}^{4} ‖ - {Gb}_{128}^{3} ‖ {Gb}_{128}^{4} ‖ {Gb}_{128}^{3} ‖ {Gb}_{128}^{4} ‖ {Gb}_{128}^{3} ‖ - {Gb}_{128}^{4} ‖ ) ,$$

$${CE}_{4} = ( {Ga}_{128}^{3} ‖ {Ga}_{128}^{4} ‖ - {Ga}_{128}^{3} ‖ {Ga}_{128}^{4} ‖ - {Ga}_{128}^{3} ‖ - {Ga}_{128}^{4} ‖ - {Ga}_{128}^{3} ‖ {Ga}_{128}^{4} ‖ {0}_{128} ‖ {Gb}_{128}^{3} ‖ {Gb}_{128}^{4} ‖ - {Gb}_{128}^{3} ‖ {Gb}_{128}^{4} ‖ - {Gb}_{128}^{3} ‖ - {Gb}_{128}^{4} ‖ - {Gb}_{128}^{3} ‖ {Gb}_{128}^{4} ‖ ) ,$$

$${CE}_{5} = ( {Ga}_{128}^{3} ‖ - {Ga}_{128}^{4} ‖ {Ga}_{128}^{3} ‖ {Ga}_{128}^{4} ‖ {Ga}_{128}^{3} ‖ - {Ga}_{128}^{4} ‖ - {Ga}_{128}^{3} ‖ - {Ga}_{128}^{4} ‖ {0}_{128} ‖ {Gb}_{128}^{3} ‖ - {Gb}_{128}^{4} ‖ {Gb}_{128}^{3} ‖ {Gb}_{128}^{4} ‖ {Gb}_{128}^{3} ‖ - {Gb}_{128}^{4} ‖ - {Gb}_{128}^{3} ‖ - {Gb}_{128}^{4} ‖ ) ,$$

$${CE}_{6} = ( {Ga}_{128}^{3} ‖ - {Ga}_{128}^{4} ‖ {Ga}_{128}^{3} ‖ - {Ga}_{128}^{4} ‖ {Ga}_{128}^{3} ‖ {Ga}_{128}^{4} ‖ {Ga}_{128}^{3} ‖ {Ga}_{128}^{4} ‖ {0}_{128} ‖ {Gb}_{128}^{3} ‖ - {Gb}_{128}^{4} ‖ {Gb}_{128}^{3} ‖ {Gb}_{128}^{4} ‖ - {Gb}_{128}^{3} ‖ {Gb}_{128}^{4} ‖ {Gb}_{128}^{3} ‖ {Gb}_{128}^{4} ‖ ) ,$$

$${CE}_{7} = ( {Ga}_{128}^{3} ‖ - {Ga}_{128}^{4} ‖ - {Ga}_{128}^{3} ‖ - {Ga}_{128}^{4} ‖ {Ga}_{128}^{3} ‖ - {Ga}_{128}^{4} ‖ {Ga}_{128}^{3} ‖ {Ga}_{128}^{4} ‖ {0}_{128} ‖ {Gb}_{128}^{3} ‖ - {Gb}_{128}^{4} ‖ - {Gb}_{128}^{3} ‖ {Gb}_{128}^{4} ‖ {Gb}_{128}^{3} ‖ - {Gb}_{128}^{4} ‖ {Gb}_{128}^{3} ‖ {Gb}_{128}^{4} ‖ ) ,$$

$${CE}_{8} = ( {Ga}_{128}^{3} ‖ - {Ga}_{128}^{4} ‖ - {Ga}_{128}^{3} ‖ - {Ga}_{128}^{4} ‖ - {Ga}_{128}^{3} ‖ {Ga}_{128}^{4} ‖ - {Ga}_{128}^{3} ‖ - {Ga}_{128}^{4} ‖ {0}_{128} ‖ - {Gb}_{128}^{3} ‖ - {Gb}_{128}^{4} ‖ - {Gb}_{128}^{3} ‖ - {Gb}_{128}^{4} ‖ {Gb}_{128}^{3} ‖ {Gb}_{128}^{4} ‖ - {Gb}_{128}^{3} ‖ - {Gb}_{128}^{4} ‖ )$$

Aperiodic cross-correlation peaks of the CE sequence set in a zone of −127 to 127 are shown in Table 6.

TABLE 6
Cross-correlation peak

| | CE₁ | CE₂ | CE₃ | CE₄ | CE₅ | CE₆ | CE₇ | CE₈ |
|---|---|---|---|---|---|---|---|---|
| CE₁ | 2048 | 0 | 0 | 0 | 0 | 0 | 0 | 0 |
| CE₂ | 0 | 2048 | 0 | 0 | 0 | 0 | 0 | 0 |
| CE₃ | 0 | 0 | 2048 | 0 | 0 | 0 | 0 | 0 |
| CE₄ | 0 | 0 | 0 | 2048 | 0 | 0 | 0 | 0 |
| CE₅ | 0 | 0 | 0 | 0 | 2048 | 0 | 0 | 0 |
| CE₆ | 0 | 0 | 0 | 0 | 0 | 2048 | 0 | 0 |
| CE₇ | 0 | 0 | 0 | 0 | 0 | 0 | 2048 | 0 |
| CE₈ | 0 | 0 | 0 | 0 | 0 | 0 | 0 | 2048 |

In a possible implementation, it is assumed that C1=Ga⁵₁₂₈, S1=Gb⁶₁₂₈, C2=S̅1̅=Ga₁₂₈⁵, and S2=−C̅1̅=Gb₁₂₈⁶, where Ga⁵₁₂₈, Gb⁵₁₂₈, Ga⁶₁₂₈, and Gb⁶₁₂₈ are Golay sequences whose lengths are 128 in the IEEE 802.11ay standard. It is assumed that three iterations are performed, and the following may be obtained:

C=(C₁³,C₂³,C₃³,C₄³,C₅³,C₆³,C₇³,C₈³)

S=(S₁³,S₂³,S₃³,S₄³,S₅³,S₆³,S₇³,S₈³)

Specifically:

$${C}_{1}^{3} = [ {Ga}_{128}^{5} ‖ {Ga}_{128}^{6} ‖ {Ga}_{128}^{5} ‖ - {Ga}_{128}^{6} ‖ {Ga}_{128}^{5} ‖ {Ga}_{128}^{6} ‖ - {Ga}_{128}^{5} ‖ {Ga}_{128}^{6} ] ,$$

$${C}_{2}^{3} = [ {Ga}_{128}^{5} ‖ {Ga}_{128}^{6} ‖ {Ga}_{128}^{5} ‖ - {Ga}_{128}^{6} ‖ - {Ga}_{128}^{5} ‖ - {Ga}_{128}^{6} ‖ {Ga}_{128}^{5} ‖ - {Ga}_{128}^{6} ] ,$$

$${C}_{3}^{3} = [ {Ga}_{128}^{5} ‖ {Ga}_{128}^{6} ‖ - {Ga}_{128}^{5} ‖ {Ga}_{128}^{6} ‖ {Ga}_{128}^{5} ‖ {Ga}_{128}^{6} ‖ {Ga}_{128}^{5} ‖ - {Ga}_{128}^{6} ] ,$$

$${C}_{4}^{3} = [ {Ga}_{128}^{5} ‖ {Ga}_{128}^{6} ‖ - {Ga}_{128}^{5} ‖ {Ga}_{128}^{6} ‖ - {Ga}_{128}^{5} ‖ - {Ga}_{128}^{6} ‖ - {Ga}_{128}^{5} ‖ {Ga}_{128}^{6} ] ,$$

$${C}_{5}^{3} = [ {Ga}_{128}^{5} ‖ - {Ga}_{128}^{6} ‖ {Ga}_{128}^{5} ‖ {Ga}_{128}^{6} ‖ {Ga}_{128}^{5} ‖ - {Ga}_{128}^{6} ‖ - {Ga}_{128}^{5} ‖ - {Ga}_{128}^{6} ] ,$$

$${C}_{6}^{3} = [ {Ga}_{128}^{5} ‖ - {Ga}_{128}^{6} ‖ {Ga}_{128}^{5} ‖ {Ga}_{128}^{6} ‖ - {Ga}_{128}^{5} ‖ {Ga}_{128}^{6} ‖ {Ga}_{128}^{5} ‖ {Ga}_{128}^{6} ] ,$$

$${C}_{7}^{3} = [ {Ga}_{128}^{5} ‖ - {Ga}_{128}^{6} ‖ - {Ga}_{128}^{5} ‖ - {Ga}_{128}^{6} ‖ {Ga}_{128}^{5} ‖ - {Ga}_{128}^{6} ‖ {Ga}_{128}^{5} ‖ {Ga}_{128}^{6} ] ,$$

$${C}_{8}^{3} = [ {Ga}_{128}^{5} ‖ - {Ga}_{128}^{6} ‖ - {Ga}_{128}^{5} ‖ - {Ga}_{128}^{6} ‖ - {Ga}_{128}^{5} ‖ {Ga}_{128}^{6} ‖ - {Ga}_{128}^{5} ‖ - {Ga}_{128}^{6} ] ,$$

$${S}_{1}^{3} = [ {Gb}_{128}^{5} ‖ {Gb}_{128}^{6} ‖ {Gb}_{128}^{5} ‖ - {Gb}_{128}^{6} ‖ {Gb}_{128}^{5} ‖ {Gb}_{128}^{6} ‖ - {Gb}_{128}^{5} ‖ {Gb}_{128}^{6} ] ,$$

$${S}_{2}^{3} = [ {Gb}_{128}^{5} ‖ {Gb}_{128}^{6} ‖ {Gb}_{128}^{5} ‖ - {Gb}_{128}^{6} ‖ - {Gb}_{128}^{5} ‖ - {Gb}_{128}^{6} ‖ {Gb}_{128}^{5} ‖ - {Gb}_{128}^{6} ] ,$$

$${S}_{3}^{3} = [ {Gb}_{128}^{5} ‖ {Gb}_{128}^{6} ‖ - {Gb}_{128}^{5} ‖ {Gb}_{128}^{6} ‖ {Gb}_{128}^{5} ‖ {Gb}_{128}^{6} ‖ {Gb}_{128}^{5} ‖ - {Gb}_{128}^{6} ] ,$$

$${S}_{4}^{3} = [ {Gb}_{128}^{5} ‖ {Gb}_{128}^{6} ‖ - {Gb}_{128}^{5} ‖ {Gb}_{128}^{6} ‖ - {Gb}_{128}^{5} ‖ - {Gb}_{128}^{6} ‖ - {Gb}_{128}^{5} ‖ {Gb}_{128}^{6} ] ,$$

$${S}_{5}^{3} = [ {Gb}_{128}^{5} ‖ - {Gb}_{128}^{6} ‖ {Gb}_{128}^{5} ‖ {Gb}_{128}^{6} ‖ {Gb}_{128}^{5} ‖ - {Gb}_{128}^{6} ‖ {Gb}_{128}^{5} ‖ - {Gb}_{128}^{6} ] ,$$

$${S}_{6}^{3} = [ {Gb}_{128}^{5} ‖ - {Gb}_{128}^{6} ‖ {Gb}_{128}^{5} ‖ {Gb}_{128}^{6} ‖ - {Gb}_{128}^{5} ‖ {Gb}_{128}^{6} ‖ {Gb}_{128}^{5} ‖ {Gb}_{128}^{6} ] ,$$

$${S}_{7}^{3} = [ {Gb}_{128}^{5} ‖ - {Gb}_{128}^{6} ‖ - {Gb}_{128}^{5} ‖ - {Gb}_{128}^{6} ‖ {Gb}_{128}^{5} ‖ - {Gb}_{128}^{6} ‖ {Gb}_{128}^{5} ‖ {Gb}_{128}^{6} ] ,$$

$${S}_{8}^{3} = [ {Gb}_{128}^{5} ‖ - {Gb}_{128}^{6} ‖ - {Gb}_{128}^{5} ‖ - {Gb}_{128}^{6} ‖ - {Gb}_{128}^{5} ‖ {Gb}_{128}^{6} ‖ - {Gb}_{128}^{5} ‖ - {Gb}_{128}^{6} ] .$$

In this case, an 8-stream aperiodic zero correlation zone sequence set may be generated:

CE=[CE₁,CE₂,CE₃,CE₄,CE₅,CE₆,CE₇,CE₈]

Specifically:

$${CE}_{1} = ( {Ga}_{128}^{5} ‖ {Ga}_{128}^{6} ‖ {Ga}_{128}^{5} ‖ - {Ga}_{128}^{6} ‖ {Ga}_{128}^{5} ‖ {Ga}_{128}^{6} ‖ - {Ga}_{128}^{5} ‖ {Ga}_{128}^{6} ‖ {0}_{128} ‖ {Gb}_{128}^{5} ‖ {Gb}_{128}^{6} ‖ {Gb}_{128}^{5} ‖ - {Gb}_{128}^{6} ‖ {Gb}_{128}^{5} ‖ {Gb}_{128}^{6} ‖ - {Gb}_{128}^{5} ‖ {Gb}_{128}^{6} ‖ ) ,$$

$${CE}_{2} = ( {Ga}_{128}^{5} ‖ {Ga}_{128}^{6} ‖ {Ga}_{128}^{5} ‖ - {Ga}_{128}^{6} ‖ - {Ga}_{128}^{5} ‖ - {Ga}_{128}^{6} ‖ {Ga}_{128}^{5} ‖ - {Ga}_{128}^{6} ‖ {0}_{128} ‖ {Gb}_{128}^{5} ‖ {Gb}_{128}^{6} ‖ {Gb}_{128}^{5} ‖ - {Gb}_{128}^{6} ‖ - {Gb}_{128}^{5} ‖ - {Gb}_{128}^{6} ‖ - {Gb}_{128}^{5} ‖ {Gb}_{128}^{6} ‖ ) ,$$

$${CE}_{3} = ( {Ga}_{128}^{5} ‖ {Ga}_{128}^{6} ‖ - {Ga}_{128}^{5} ‖ {Ga}_{128}^{6} ‖ {Ga}_{128}^{5} ‖ {Ga}_{128}^{6} ‖ {Ga}_{128}^{5} ‖ - {Ga}_{128}^{6} ‖ {0}_{128} ‖ {Gb}_{128}^{5} ‖ {Gb}_{128}^{6} ‖ - {Gb}_{128}^{5} ‖ {Gb}_{128}^{6} ‖ {Gb}_{128}^{5} ‖ {Gb}_{128}^{6} ‖ {Gb}_{128}^{5} ‖ - {Gb}_{128}^{6} ‖ ) ,$$

$${CE}_{4} = ( {Ga}_{128}^{5} ‖ {Ga}_{128}^{6} ‖ - {Ga}_{128}^{5} ‖ {Ga}_{128}^{6} ‖ - {Ga}_{128}^{5} ‖ - {Ga}_{128}^{6} ‖ - {Ga}_{128}^{5} ‖ {Ga}_{128}^{6} ‖ {0}_{128} ‖ {Gb}_{128}^{5} ‖ {Gb}_{128}^{6} ‖ - {Gb}_{128}^{5} ‖ {Gb}_{128}^{6} ‖ - {Gb}_{128}^{5} ‖ - {Gb}_{128}^{6} ‖ - {Gb}_{128}^{5} ‖ {Gb}_{128}^{6} ‖ ) ,$$

$${CE}_{5} = ( {Ga}_{128}^{5} ‖ - {Ga}_{128}^{6} ‖ {Ga}_{128}^{5} ‖ {Ga}_{128}^{6} ‖ {Ga}_{128}^{5} ‖ - {Ga}_{128}^{6} ‖ - {Ga}_{128}^{5} ‖ - {Ga}_{128}^{6} ‖ {0}_{128} ‖ {Gb}_{128}^{5} ‖ - {Gb}_{128}^{6} ‖ {Gb}_{128}^{5} ‖ {Gb}_{128}^{6} ‖ {Gb}_{128}^{5} ‖ - {Gb}_{128}^{6} ‖ - {Gb}_{128}^{5} ‖ - {Gb}_{128}^{6} ‖ ) ,$$

$${CE}_{6} = ( {Ga}_{128}^{5} ‖ - {Ga}_{128}^{6} ‖ {Ga}_{128}^{5} ‖ {Ga}_{128}^{6} ‖ - {Ga}_{128}^{5} ‖ {Ga}_{128}^{6} ‖ {Ga}_{128}^{5} ‖ {Ga}_{128}^{6} ‖ {0}_{128} ‖ {Gb}_{128}^{5} ‖ - {Gb}_{128}^{6} ‖ {Gb}_{128}^{5} ‖ {Gb}_{128}^{6} ‖ - {Gb}_{128}^{5} ‖ {Gb}_{128}^{6} ‖ {Gb}_{128}^{5} ‖ {Gb}_{128}^{6} ‖ ) ,$$

$${CE}_{7} = ( {Ga}_{128}^{5} ‖ - {Ga}_{128}^{6} ‖ - {Ga}_{128}^{5} ‖ - {Ga}_{128}^{6} ‖ {Ga}_{128}^{5} ‖ - {Ga}_{128}^{6} ‖ {Ga}_{128}^{5} ‖ {Ga}_{128}^{6} ‖ {0}_{128} ‖ {Gb}_{128}^{5} ‖ - {Gb}_{128}^{6} ‖ - {Gb}_{128}^{5} ‖ {Gb}_{128}^{6} ‖ {Gb}_{128}^{5} ‖ - {Gb}_{128}^{6} ‖ {Gb}_{128}^{5} ‖ {Gb}_{128}^{6} ‖ ) ,$$

$${CE}_{8} = ( {Ga}_{128}^{5} ‖ - {Ga}_{128}^{6} ‖ - {Ga}_{128}^{5} ‖ - {Ga}_{128}^{6} ‖ - {Ga}_{128}^{5} ‖ {Ga}_{128}^{6} ‖ - {Ga}_{128}^{5} ‖ - {Ga}_{128}^{6} ‖ {0}_{128} ‖ - {Gb}_{128}^{5} ‖ - {Gb}_{128}^{6} ‖ - {Gb}_{128}^{5} ‖ - {Gb}_{128}^{6} ‖ {Gb}_{128}^{5} ‖ {Gb}_{128}^{6} ‖ - {Gb}_{128}^{5} ‖ - {Gb}_{128}^{6} ‖ ) .$$

Aperiodic cross-correlation peaks of the CE sequence set in a zone of −127 to 127 are shown in Table 7.

TABLE 7
Cross-correlation peak

| | CE₁ | CE₂ | CE₃ | CE₄ | CE₅ | CE₆ | CE₇ | CE₈ |
|---|---|---|---|---|---|---|---|---|
| CE₁ | 2048 | 0 | 0 | 0 | 0 | 0 | 0 | 0 |
| CE₂ | 0 | 2048 | 0 | 0 | 0 | 0 | 0 | 0 |
| CE₃ | 0 | 0 | 2048 | 0 | 0 | 0 | 0 | 0 |
| CE₄ | 0 | 0 | 0 | 2048 | 0 | 0 | 0 | 0 |
| CE₅ | 0 | 0 | 0 | 0 | 2048 | 0 | 0 | 0 |
| CE₆ | 0 | 0 | 0 | 0 | 0 | 2048 | 0 | 0 |
| CE₇ | 0 | 0 | 0 | 0 | 0 | 0 | 2048 | 0 |
| CE₈ | 0 | 0 | 0 | 0 | 0 | 0 | 0 | 2048 |

In a possible implementation, it is assumed that C1=Ga⁷₁₂₈, S1=Gb⁸₁₂₈, C2=S̅1̅=Ga₁₂₈⁷, and S2=− [symbol] =Gb₁₂₈⁸, where Ga⁷₁₂₈, Gb⁷₁₂₈, Ga⁸₁₂₈, and Gb⁸₁₂₈ are Golay sequences whose lengths are 128 in the IEEE 802.11ay standard. It is assumed that three iterations are performed, and the following may be obtained:

C=(C₁³,C₂³,C₃³,C₄³,C₅³,C₆³,C₇³,C₈³)

S=(S₁³,S₂³,S₃³,S₄³,S₅³,S₆³,S₇³,S₈³)

Specifically:

$${C}_{1}^{3} = [ {Ga}_{128}^{7} ‖ {Ga}_{128}^{8} ‖ {Ga}_{128}^{7} ‖ - {Ga}_{128}^{8} ‖ {Ga}_{128}^{7} ‖ {Ga}_{128}^{8} ‖ - {Ga}_{128}^{7} ‖ {Ga}_{128}^{8} ] ,$$

$${C}_{2}^{3} = [ {Ga}_{128}^{7} ‖ {Ga}_{128}^{8} ‖ {Ga}_{128}^{7} ‖ - {Ga}_{128}^{8} ‖ - {Ga}_{128}^{7} ‖ - {Ga}_{128}^{8} ‖ {Ga}_{128}^{7} ‖ - {Ga}_{128}^{8} ] ,$$

$${C}_{3}^{3} = [ {Ga}_{128}^{7} ‖ {Ga}_{128}^{8} ‖ - {Ga}_{128}^{7} ‖ {Ga}_{128}^{8} ‖ {Ga}_{128}^{7} ‖ {Ga}_{128}^{8} ‖ {Ga}_{128}^{7} ‖ - {Ga}_{128}^{8} ] ,$$

$${C}_{4}^{3} = [ {Ga}_{128}^{7} ‖ {Ga}_{128}^{8} ‖ - {Ga}_{128}^{7} ‖ {Ga}_{128}^{8} ‖ - {Ga}_{128}^{7} ‖ - {Ga}_{128}^{8} ‖ - {Ga}_{128}^{7} ‖ {Ga}_{128}^{8} ] ,$$

$${C}_{5}^{3} = [ {Ga}_{128}^{7} ‖ - {Ga}_{128}^{8} ‖ {Ga}_{128}^{7} ‖ {Ga}_{128}^{8} ‖ {Ga}_{128}^{7} ‖ - {Ga}_{128}^{8} ‖ - {Ga}_{128}^{7} ‖ - {Ga}_{128}^{8} ] ,$$

$${C}_{6}^{3} = [ {Ga}_{128}^{7} ‖ - {Ga}_{128}^{8} ‖ {Ga}_{128}^{7} ‖ {Ga}_{128}^{8} ‖ - {Ga}_{128}^{7} ‖ {Ga}_{128}^{8} ‖ {Ga}_{128}^{7} ‖ {Ga}_{128}^{8} ] ,$$

$${C}_{7}^{3} = [ {Ga}_{128}^{7} ‖ - {Ga}_{128}^{8} ‖ - {Ga}_{128}^{7} ‖ - {Ga}_{128}^{8} ‖ {Ga}_{128}^{7} ‖ - {Ga}_{128}^{8} ‖ {Ga}_{128}^{7} ‖ {Ga}_{128}^{8} ] ,$$

$${C}_{8}^{3} = [ {Ga}_{128}^{7} ‖ - {Ga}_{128}^{8} ‖ - {Ga}_{128}^{7} ‖ - {Ga}_{128}^{8} ‖ - {Ga}_{128}^{7} ‖ {Ga}_{128}^{8} ‖ - {Ga}_{128}^{7} ‖ - {Ga}_{128}^{8} ] ,$$

$${S}_{1}^{3} = [ {Gb}_{128}^{7} ‖ {Gb}_{128}^{8} ‖ {Gb}_{128}^{7} ‖ - {Gb}_{128}^{8} ‖ {Gb}_{128}^{7} ‖ {Gb}_{128}^{8} ‖ - {Gb}_{128}^{7} ‖ {Gb}_{128}^{8} ] ,$$

$${S}_{2}^{3} = [ {Gb}_{128}^{7} ‖ {Gb}_{128}^{8} ‖ {Gb}_{128}^{7} ‖ - {Gb}_{128}^{8} ‖ - {Gb}_{128}^{7} ‖ - {Gb}_{128}^{8} ‖ {Gb}_{128}^{7} ‖ - {Gb}_{128}^{8} ] ,$$

$${S}_{3}^{3} = [ {Gb}_{128}^{7} ‖ {Gb}_{128}^{8} ‖ - {Gb}_{128}^{7} ‖ {Gb}_{128}^{8} ‖ {Gb}_{128}^{7} ‖ {Gb}_{128}^{8} ‖ {Gb}_{128}^{7} ‖ - {Gb}_{128}^{8} ] ,$$

$${S}_{4}^{3} = [ {Gb}_{128}^{7} ‖ {Gb}_{128}^{8} ‖ - {Gb}_{128}^{7} ‖ {Gb}_{128}^{8} ‖ - {Gb}_{128}^{7} ‖ - {Gb}_{128}^{8} ‖ - {Gb}_{128}^{7} ‖ {Gb}_{128}^{8} ] ,$$

$${S}_{5}^{3} = [ {Gb}_{128}^{7} ‖ - {Gb}_{128}^{8} ‖ {Gb}_{128}^{7} ‖ {Gb}_{128}^{8} ‖ {Gb}_{128}^{7} ‖ - {Gb}_{128}^{8} ‖ {Gb}_{128}^{7} ‖ - {Gb}_{128}^{8} ] ,$$

$${S}_{6}^{3} = [ {Gb}_{128}^{7} ‖ - {Gb}_{128}^{8} ‖ {Gb}_{128}^{7} ‖ {Gb}_{128}^{8} ‖ - {Gb}_{128}^{7} ‖ {Gb}_{128}^{8} ‖ {Gb}_{128}^{7} ‖ {Gb}_{128}^{8} ] ,$$

$${S}_{7}^{3} = [ {Gb}_{128}^{7} ‖ - {Gb}_{128}^{8} ‖ - {Gb}_{128}^{7} ‖ - {Gb}_{128}^{8} ‖ {Gb}_{128}^{7} ‖ - {Gb}_{128}^{8} ‖ {Gb}_{128}^{7} ‖ {Gb}_{128}^{8} ] ,$$

$${S}_{8}^{3} = [ {Gb}_{128}^{7} ‖ - {Gb}_{128}^{8} ‖ - {Gb}_{128}^{7} ‖ - {Gb}_{128}^{8} ‖ - {Gb}_{128}^{7} ‖ {Gb}_{128}^{8} ‖ - {Gb}_{128}^{7} ‖ - {Gb}_{128}^{8} ] .$$

In this case, an 8-stream aperiodic zero correlation zone sequence set may be generated:

CE=[CE₁,CE₂,CE₃,CE₄,CE₅,CE₆,CE₇,CE₈]

Specifically:

$${CE}_{1} = ( {Ga}_{128}^{7} ‖ {Ga}_{128}^{8} ‖ {Ga}_{128}^{7} ‖ - {Ga}_{128}^{8} ‖ {Ga}_{128}^{7} ‖ {Ga}_{128}^{8} ‖ - {Ga}_{128}^{7} ‖ {Ga}_{128}^{8} ‖ {0}_{128} ‖ {Gb}_{128}^{7} ‖ {Gb}_{128}^{8} ‖ {Gb}_{128}^{7} ‖ - {Gb}_{128}^{8} ‖ {Gb}_{128}^{7} ‖ {Gb}_{128}^{8} ‖ - {Gb}_{128}^{7} ‖ {Gb}_{128}^{8} ‖ ) ,$$

$${CE}_{2} = ( {Ga}_{128}^{7} ‖ {Ga}_{128}^{8} ‖ {Ga}_{128}^{7} ‖ - {Ga}_{128}^{8} ‖ - {Ga}_{128}^{7} ‖ - {Ga}_{128}^{8} ‖ {Ga}_{128}^{7} ‖ - {Ga}_{128}^{8} ‖ {0}_{128} ‖ {Gb}_{128}^{7} ‖ {Gb}_{128}^{8} ‖ {Gb}_{128}^{7} ‖ - {Gb}_{128}^{8} ‖ - {Gb}_{128}^{7} ‖ - {Gb}_{128}^{8} ‖ - {Gb}_{128}^{7} ‖ {Gb}_{128}^{8} ‖ ) ,$$

$${CE}_{3} = ( {Ga}_{128}^{7} ‖ {Ga}_{128}^{8} ‖ - {Ga}_{128}^{7} ‖ {Ga}_{128}^{8} ‖ {Ga}_{128}^{7} ‖ {Ga}_{128}^{8} ‖ {Ga}_{128}^{7} ‖ - {Ga}_{128}^{8} ‖ {0}_{128} ‖ {Gb}_{128}^{7} ‖ {Gb}_{128}^{8} ‖ - {Gb}_{128}^{7} ‖ {Gb}_{128}^{8} ‖ {Gb}_{128}^{7} ‖ {Gb}_{128}^{8} ‖ {Gb}_{128}^{7} ‖ - {Gb}_{128}^{8} ‖ ) ,$$

$${CE}_{4} = ( {Ga}_{128}^{7} ‖ {Ga}_{128}^{8} ‖ - {Ga}_{128}^{7} ‖ {Ga}_{128}^{8} ‖ - {Ga}_{128}^{7} ‖ - {Ga}_{128}^{8} ‖ - {Ga}_{128}^{7} ‖ {Ga}_{128}^{8} ‖ {0}_{128} ‖ {Gb}_{128}^{7} ‖ {Gb}_{128}^{8} ‖ - {Gb}_{128}^{7} ‖ {Gb}_{128}^{8} ‖ - {Gb}_{128}^{7} ‖ - {Gb}_{128}^{8} ‖ - {Gb}_{128}^{7} ‖ {Gb}_{128}^{8} ‖ ) ,$$

$${CE}_{5} = ( {Ga}_{128}^{7} ‖ - {Ga}_{128}^{8} ‖ {Ga}_{128}^{7} ‖ {Ga}_{128}^{8} ‖ {Ga}_{128}^{7} ‖ - {Ga}_{128}^{8} ‖ - {Ga}_{128}^{7} ‖ - {Ga}_{128}^{8} ‖ {0}_{128} ‖ {Gb}_{128}^{7} ‖ - {Gb}_{128}^{8} ‖ {Gb}_{128}^{7} ‖ {Gb}_{128}^{8} ‖ {Gb}_{128}^{7} ‖ - {Gb}_{128}^{8} ‖ - {Gb}_{128}^{7} ‖ - {Gb}_{128}^{8} ‖ ) ,$$

$${CE}_{6} = ( {Ga}_{128}^{7} ‖ - {Ga}_{128}^{8} ‖ {Ga}_{128}^{7} ‖ {Ga}_{128}^{8} ‖ - {Ga}_{128}^{7} ‖ {Ga}_{128}^{8} ‖ {Ga}_{128}^{7} ‖ {Ga}_{128}^{8} ‖ {0}_{128} ‖ {Gb}_{128}^{7} ‖ - {Gb}_{128}^{8} ‖ {Gb}_{128}^{7} ‖ {Gb}_{128}^{8} ‖ - {Gb}_{128}^{7} ‖ {Gb}_{128}^{8} ‖ {Gb}_{128}^{7} ‖ {Gb}_{128}^{8} ‖ ) ,$$

$${CE}_{7} = ( {Ga}_{128}^{7} ‖ - {Ga}_{128}^{8} ‖ - {Ga}_{128}^{7} ‖ - {Ga}_{128}^{8} ‖ {Ga}_{128}^{7} ‖ - {Ga}_{128}^{8} ‖ {Ga}_{128}^{7} ‖ {Ga}_{128}^{8} ‖ {0}_{128} ‖ {Gb}_{128}^{7} ‖ - {Gb}_{128}^{8} ‖ - {Gb}_{128}^{7} ‖ - {Gb}_{128}^{8} ‖ {Gb}_{128}^{7} ‖ - {Gb}_{128}^{8} ‖ {Gb}_{128}^{7} ‖ {Gb}_{128}^{8} ‖ ) ,$$

$${CE}_{8} = ( {Ga}_{128}^{7} ‖ - {Ga}_{128}^{8} ‖ - {Ga}_{128}^{7} ‖ - {Ga}_{128}^{8} ‖ - {Ga}_{128}^{7} ‖ {Ga}_{128}^{8} ‖ - {Ga}_{128}^{7} ‖ - {Ga}_{128}^{8} ‖ {0}_{128} ‖ - {Gb}_{128}^{7} ‖ - {Gb}_{128}^{8} ‖ - {Gb}_{128}^{7} ‖ - {Gb}_{128}^{8} ‖ {Gb}_{128}^{7} ‖ {Gb}_{128}^{8} ‖ - {Gb}_{128}^{7} ‖ - {Gb}_{128}^{8} ‖ ) ,$$

Aperiodic cross-correlation peaks of the CE sequence set in a zone of −127 to 127 are shown in Table 8.

TABLE 8
Cross-correlation peak

| | CE₁ | CE₂ | CE₃ | CE₄ | CE₅ | CE₆ | CE₇ | CE₈ |
|---|---|---|---|---|---|---|---|---|
| CE₁ | 2048 | 0 | 0 | 0 | 0 | 0 | 0 | 0 |
| CE₂ | 0 | 2048 | 0 | 0 | 0 | 0 | 0 | 0 |
| CE₃ | 0 | 0 | 2048 | 0 | 0 | 0 | 0 | 0 |
| CE₄ | 0 | 0 | 0 | 2048 | 0 | 0 | 0 | 0 |
| CE₅ | 0 | 0 | 0 | 0 | 2048 | 0 | 0 | 0 |
| CE₆ | 0 | 0 | 0 | 0 | 0 | 2048 | 0 | 0 |
| CE₇ | 0 | 0 | 0 | 0 | 0 | 0 | 2048 | 0 |
| CE₈ | 0 | 0 | 0 | 0 | 0 | 0 | 0 | 2048 |

S802: The transmitter sends the second sequence to a receiver, and correspondingly, the receiver receives the second sequence.

For example, the transmitter sends a physical layer protocol data unit (PPDU) to the receiver, where the physical layer protocol data unit includes the second sequence.

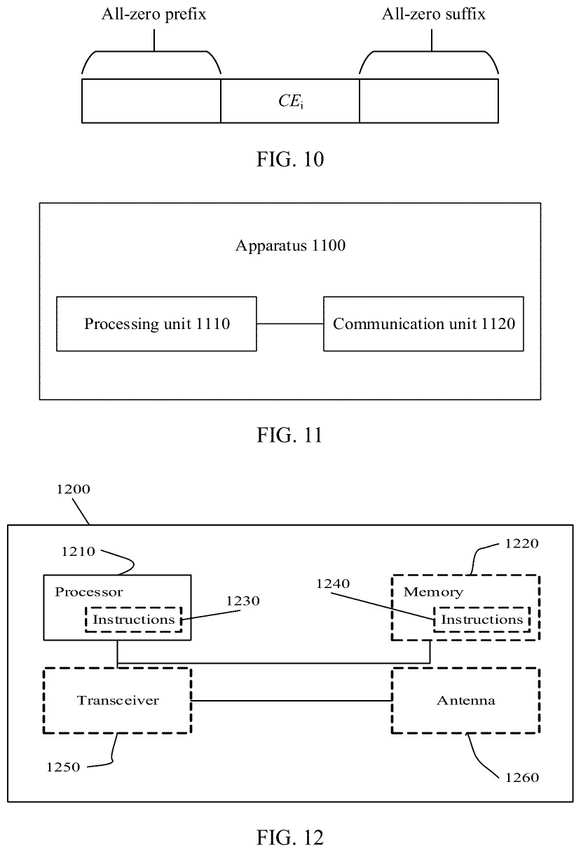

It may be understood that the second sequence may be any sequence in the CE sequence set in S801. An example of a structure in which the transmitter sends the second sequence is shown in FIG. 10.

For a manner in which the transmitter sends the second sequence and a manner in which the receiver receives the second sequence, refer to related descriptions in S602. Details are not described herein again.

S803: The receiver performs at least one of channel estimation, target sensing, or time synchronization based on the second sequence.

Optionally, the channel estimation may be MIMO channel estimation in a high frequency standard (for example, 802.11ay).

In the method, use of P-matrix is avoided in a process of constructing a plurality of streams of aperiodic zero correlation sequences. This reduces complexity of constructing a CE sequence, shortens a length of the CE sequence, reduces resource occupation, and also reduces a channel estimation delay and improves channel estimation efficiency.

It may be understood that the channel estimation is merely used as an example of application of embodiments of this application. This is not limited. For example, embodiments of this application may be further used in a related frame of WLAN sensing, and the sequence in embodiments of this application is used as a synchronization field to implement synchronization between a plurality of devices, and implement bistatic/multistatic sensing. Alternatively, the sequence in embodiments of this application may be used in a training (TRN) part in a high frequency standard (for example, 802.11ay SC PHY or 802.11ad) for transmission. The TRN field is mainly used for beam training, and a length of the TRN field is variable, so that a designed sequence can be flexibly transmitted. Alternatively, channel estimation or perception may be performed in a channel estimation field (CEF) or TRN in 802.11ad (11ad does not support MIMO) in any one of the CE sequence construction manners proposed in embodiments of this application.

Embodiments described in this specification may be independent solutions, or may be combined based on internal logic. All these solutions fall within the protection scope of this application. It should be understood that the steps in the foregoing embodiments are merely intended to clearly describe the technical solutions of embodiments, and a sequence of performing the steps is not limited.

In the foregoing embodiments provided in this application, the method provided in embodiments of this application is described from a perspective of interaction between devices. To implement functions in the method provided in the foregoing embodiments of this application, the network device or the terminal device may include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

In this embodiment of this application, module division is an example, and is merely a logical function division. In actual implementation, another division manner may be used. In addition, functional modules in embodiments of this application may be integrated into one processor, or may exist alone physically, or two or more modules may be integrated into one module. The integrated module may be implemented in a form of hardware, or may be implemented in a form of a software functional module.

The following describes in detail a communication apparatus provided in embodiments of this application with reference to FIG. 11 and FIG. 12. It should be understood that descriptions of apparatus embodiments correspond to descriptions of method embodiments. Therefore, for content that is not described in detail, refer to the method embodiments. For brevity, details are not described herein again.

Same as the foregoing concept, as shown in FIG. 11, an embodiment of this application further provides an apparatus 1100 that is configured to implement functions of a session management function network element in the foregoing methods. For example, the apparatus may be a software module or a chip system. In this embodiment of this application, the chip system may include a chip, or may include a chip and another discrete component. The apparatus 1100 may include a processing unit 1110 and a communication unit 1120.

In this embodiment of this application, the communication unit may also be referred to as a transceiver unit, and may include a sending unit and/or a receiving unit, which are respectively configured to perform steps of sending and receiving by the session management function network element in the foregoing method embodiments.

The communication unit may also be referred to as a transceiver, a transceiver machine, a transceiver apparatus, or the like. The processing unit may also be referred to as a processor, a processing board, a processing module, a processing apparatus, or the like. Optionally, a component that is in the communication unit 1120 and that is configured to implement a receiving function may be considered as the receiving unit, and a component that is in the communication unit 1120 and that is configured to implement a sending function may be considered as the sending unit. In other words, the communication unit 1120 includes the receiving unit and the sending unit. The communication unit sometimes may also be referred to as a transceiver machine, a transceiver, an interface circuit, or the like. The receiving unit sometimes may also be referred to as a receiver machine, a receiver, a receive circuit, or the like. The sending unit sometimes may also be referred to as a transmitter machine, a transmitter, a transmit circuit, or the like.

When the communication apparatus 1100 performs a function of the transmitter in the procedure shown in any one of FIG. 6 to FIG. 10 in the foregoing embodiments. The communication unit may be configured to send a first sequence or a second sequence; and the processing unit may be configured to generate the first sequence or the second sequence.

When the communication apparatus 1100 performs a function of the receiver in the procedure shown in any one of FIG. 6 to FIG. 10 in the foregoing embodiments. The communication unit may be configured to receive a first sequence or a second sequence; and the processing unit may be configured to perform channel estimation or the like based on the first sequence or the second sequence.

The foregoing is merely an example. The processing unit 1110 and the communication unit 1120 may further perform other functions. For more detailed descriptions, refer to the related descriptions in the method embodiments shown in FIG. 6 to FIG. 10 or other method embodiments. Details are not described herein again.

FIG. 12 shows an apparatus 1200 according to an embodiment of this application. The apparatus shown in FIG. 12 may be an implementation of a hardware circuit of the apparatus shown in FIG. 12. The communication apparatus is applicable to the foregoing flowcharts, and performs the functions of the terminal device or the network device in the foregoing method embodiments. For ease of description, FIG. 12 merely shows main components of the communication apparatus.

The communication apparatus 1200 may be a terminal device, and can implement functions of the first terminal apparatus or the second terminal apparatus in the methods provided in embodiments of this application. Alternatively, the communication apparatus 1200 may be an apparatus that can support the first terminal apparatus or the second terminal apparatus in implementing corresponding functions in the methods provided in embodiments of this application. The communication apparatus 1200 may be a chip system. In this embodiment of this application, the chip system may include a chip, or may include a chip and another discrete component. For specific functions, refer to the descriptions of the foregoing method embodiments.

The communication apparatus 1200 includes one or more processors 1210, configured to implement or support the communication apparatus 1200 in implementing functions of the first terminal apparatus or the second terminal apparatus in the methods provided in embodiments of this application. For details, refer to detailed descriptions in the method examples. Details are not described herein again. The processor 1210 may also be referred to as a processing unit or a processing module, and may implement a specific control function. The processor 1210 may be a general-purpose processor, a dedicated processor, or the like. For example, the processor includes a central processing unit, an application processor, a modem processor, a graphics processing unit, an image signal processor, a digital signal processor, a video codec processor, a controller, a memory, and/or a neural network processor. The central processing unit may be configured to control the communication apparatus 1200, execute a software program, and/or process data. Different processors may be independent devices, or may be integrated into one or more processors, for example, integrated into one or more application-specific integrated circuits. It may be understood that, the processor in embodiments of this application may be a central processing unit (CPU), or may be another general-purpose processor, a digital signal processor (DSP), an application-specific integrated circuit (ASIC), a field-programmable gate array (FPGA) or another programmable logic device, a transistor logic device, a hardware component, or any combination thereof. The general-purpose processor may be a microprocessor or any regular processor or the like.

Optionally, the communication apparatus 1200 includes one or more memories 1220, configured to store instructions 1240. The instructions may be run on the processor 1210, to enable the communication apparatus 1200 to perform the method described in the foregoing method embodiments. The memory 1220 is coupled to the processor 1210. The coupling in this embodiment of this application may be an indirect coupling or a communication connection between apparatuses, units, or modules in an electrical form, a mechanical form, or another form, and is used for information exchange between the apparatuses, the units, or the modules. The processor 1210 may perform a cooperative operation with the memory 1220. At least one of the at least one memory may be included in the processor. It should be noted that the memory 1220 is not necessary, and therefore is shown by using dashed lines in FIG. 12.

Optionally, the memory 1220 may further store data. The processor and the memory may be separately disposed, or may be integrated together. In this embodiment of this application, the memory 1220 may be a non-volatile memory, such as a hard disk drive (HDD) or a solid-state drive (SSD), or may be a volatile memory such as a random-access memory (RAM). Alternatively, the processor in this embodiment of this application may be a flash memory, a read-only memory (ROM), a programmable ROM (PROM), an erasable PROM (EPROM), an electrically EPROM (EEPROM), a register, a hard disk, a removable hard disk, a compact disc (CD)-ROM, or a storage medium of any other form well known in the art. For example, a storage medium is coupled to a processor, so that the processor can read information from the storage medium and write information into the storage medium. Certainly, the storage medium may be a component of the processor. The processor and the storage medium may be disposed in an ASIC. In addition, the ASIC may be located in a network device or a terminal device. Certainly, the processor and the storage medium may alternatively exist as discrete components in a network device or a terminal device.

The memory is any other medium that can carry or store expected program code in a form of an instruction or a data structure and that can be accessed by a computer, but is not limited thereto. The memory in embodiments of this application may alternatively be a circuit or any other apparatus that can implement a storage function, and is configured to store the program instructions and/or the data.

Optionally, the communication apparatus 1200 may include instructions 1230 (which may also be referred to as code or programs sometimes). The instructions 1230 may be run on the processor, to enable the communication apparatus 1200 to perform the method described in the foregoing embodiments. The processor 1210 may store data.

Optionally, the communication apparatus 1200 may further include a transceiver 1250 and an antenna 1206. The transceiver 1250 may be referred to as a transceiver unit, a transceiver module, a transceiver machine, a transceiver circuit, a transceiver, an input/output interface, or the like, and is configured to implement a transceiver function of the communication apparatus 1200 through the antenna 1206.

The processor 1210 and the transceiver 1250 described in this application may be implemented on an integrated circuit (IC), an analog IC, a radio frequency integrated circuit (RFID), a mixed-signal IC, an ASIC, a printed circuit board (PCB), an electronic device, or the like. The communication apparatus described in this specification may be implemented by an independent device (for example, an independent integrated circuit or a mobile phone), or may be a part of a large device (for example, a module that may be embedded in another device). For details, refer to the foregoing descriptions about the terminal device and the network device. Details are not described herein again.

Optionally, the communication apparatus 1200 may further include one or more of the following components: a wireless communication module, an audio module, an external memory interface, an internal memory, a Universal Serial Bus (USB) interface, a power management module, an antenna, a speaker, a microphone, an input/output module, a sensor module, a motor, a camera, a display, or the like. It may be understood that, in some embodiments, the communication apparatus 1200 may include more or fewer components, some components are integrated, or some components are split. These components may be implemented by hardware, software, or a combination of software and hardware.

A person skilled in the art should understand that embodiments of this application may be provided as a method, a system, or a computer program product. Therefore, this application may use a form of hardware only embodiments, software only embodiments, or embodiments with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

It is clear that a person skilled in the art can make various modifications and variations to this application without departing from the scope of this application. This application is intended to cover these modifications and variations of this application provided that they fall within the scope of protection defined by the following claims and their equivalent technologies.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A method comprising:
generating a first sequence based on a complete complementary code set through a concatenation operation, wherein the complete complementary code set is based on a Golay pair and a Hadamard matrix through a Kronecker product operation; and
sending a physical layer protocol data unit comprising the first sequence.

2. The method of claim 1, further comprising generating a zero correlation zone sequence set comprising the first sequence, wherein the physical layer protocol data unit comprises the zero correlation zone sequence set.

3. The method of claim 2, wherein a length of the Golay pair is L, wherein the Hadamard matrix is an n-order matrix, wherein L and n are positive integers, wherein a size of the complete complementary code set is 2n, wherein a size of the zero correlation zone sequence set is 2n, and wherein a length of the first sequence in the zero correlation zone sequence set is 4nL.

4. The method of claim 2, wherein each sequence in the zero correlation zone sequence set and the complete complementary code set satisfies the following relationship:
$$\begin{matrix}{CE}_{i} = ( {A}_{i , 1} ‖ {A}_{i , 2} ‖ … ‖ {A}_{i , 2 n - 1} ‖ - {A}_{i , 1} ‖ {A}_{i , 2} ‖ … ‖ - {A}_{i , 2 n - 1} ‖ {A}_{i , 2} ) , \\ \underline{{CE}_{i} = ( {A}_{i , 1} P {A}_{i , 2} P … P {A}_{i , 2 n - 1} P {A}_{i , 2 n} P - {A}_{i , 1} P {A}_{i , 2} P … P - {A}_{i , 2 n - 1} P {A}_{i , 2 n} )}\end{matrix}$$
wherein CEᵢ is the sequence in the zero correlation zone sequence set, wherein i is an integer greater than or equal to 1, and wherein A_{i,j} is an element in the complete complementary code set.

5. The method of claim 4, wherein when n is 4 and a length (L) of the Golay pair is 128, sequences in the zero correlation zone sequence set and complete complementary code sets satisfy the following relationships:
$${CE}_{1} = ( {A}_{1 , 1} {PA}_{1 , 2} {PA}_{1 , 3} {PA}_{1 , 4} {PA}_{1 , 5} {PA}_{1 , 6} {PA}_{1 , 7} {PA}_{1 , 8} P - {A}_{1 , 1} {PA}_{1 , 2} P - {A}_{1 , 3} {PA}_{1 , 4} P - {A}_{1 , 5} {PA}_{1 , 6} P - {A}_{1 , 7} {PA}_{1 , 8} ) ,$$
$${CE}_{2} = ( {A}_{2 , 1} {PA}_{2 , 2} {PA}_{2 , 3} {PA}_{2 , 4} {PA}_{2 , 5} {PA}_{2 , 6} {PA}_{2 , 7} {PA}_{2 , 8} P - {A}_{2 , 1} {PA}_{2 , 2} P - {A}_{2 , 3} {PA}_{2 , 4} P - {A}_{2 , 5} {PA}_{2 , 6} P - {A}_{2 , 7} {PA}_{2 , 8} ) ,$$
$${CE}_{3} = ( {A}_{3 , 1} {PA}_{3 , 2} {PA}_{3 , 3} {PA}_{3 , 4} {PA}_{3 , 5} {PA}_{3 , 6} {PA}_{3 , 7} {PA}_{3 , 8} P - {A}_{3 , 1} {PA}_{3 , 2} P - {A}_{3 , 3} {PA}_{3 , 4} P - {A}_{3 , 5} {PA}_{3 , 6} P - {A}_{3 , 7} {PA}_{3 , 8} ) ,$$
$${CE}_{4} = ( {A}_{4 , 1} {PA}_{4 , 2} {PA}_{4 , 3} {PA}_{4 , 4} {PA}_{4 , 5} {PA}_{4 , 6} {PA}_{4 , 7} {PA}_{4 , 8} P - {A}_{4 , 1} {PA}_{4 , 2} P - {A}_{4 , 3} {PA}_{4 , 4} P - {A}_{4 , 5} {PA}_{4 , 6} P - {A}_{4 , 7} {PA}_{4 , 8} ) ,$$
$${CE}_{5} = ( {A}_{5 , 1} {PA}_{5 , 2} {PA}_{5 , 3} {PA}_{5 , 4} {PA}_{5 , 5} {PA}_{5 , 6} {PA}_{5 , 7} {PA}_{5 , 8} P - {A}_{5 , 1} {PA}_{5 , 2} P - {A}_{5 , 3} {PA}_{5 , 4} P - {A}_{5 , 5} {PA}_{5 , 6} P - {A}_{5 , 7} {PA}_{5 , 8} ) ,$$
$${CE}_{6} = ( {A}_{6 , 1} {PA}_{6 , 2} {PA}_{6 , 3} {PA}_{6 , 4} {PA}_{6 , 5} {PA}_{6 , 6} {PA}_{6 , 7} {PA}_{6 , 8} P - {A}_{6 , 1} {PA}_{6 , 2} P - {A}_{6 , 3} {PA}_{6 , 4} P - {A}_{6 , 5} {PA}_{6 , 6} P - {A}_{6 , 7} {PA}_{6 , 8} ) ,$$
$${CE}_{7} = ( {A}_{7 , 1} {PA}_{7 , 2} {PA}_{7 , 3} {PA}_{7 , 4} {PA}_{7 , 5} {PA}_{7 , 6} {PA}_{7 , 7} {PA}_{7 , 8} P - {A}_{7 , 1} {PA}_{7 , 2} P - {A}_{7 , 3} {PA}_{7 , 4} P - {A}_{7 , 5} {PA}_{7 , 6} P - {A}_{7 , 7} {PA}_{7 , 8} ) ,$$
$${CE}_{8} = ( {A}_{8 , 1} {PA}_{8 , 2} {PA}_{8 , 3} {PA}_{8 , 4} {PA}_{8 , 5} {PA}_{8 , 6} {PA}_{8 , 7} {PA}_{8 , 8} P - {A}_{8 , 1} {PA}_{8 , 2} P - {A}_{8 , 3} {PA}_{8 , 4} P - {A}_{8 , 5} {PA}_{8 , 6} P - {A}_{8 , 7} {PA}_{8 , 8} ) .$$
$${CE}_{1} = ( {A}_{1 , 1} ‖ {A}_{1 , 2} ‖ {A}_{1 , 3} ‖ {A}_{1 , 4} ‖ {A}_{1 , 5} ‖ {A}_{1 , 6} ‖ {A}_{1 , 7} ‖ {A}_{1 , 8} ‖ - {A}_{1 , 1} ‖ {A}_{1 , 2} ‖ - {A}_{1 , 3} ‖ {A}_{1 , 4} ‖ - {A}_{1 , 5} ‖ {A}_{1 , 6} ‖ - {A}_{1 , 7} ‖ {A}_{1 , 8} ) ,$$
$${CE}_{2} = ( {A}_{2 , 1} ‖ {A}_{2 , 2} ‖ {A}_{2 , 3} ‖ {A}_{2 , 4} ‖ {A}_{2 , 5} ‖ {A}_{2 , 6} ‖ {A}_{2 ,} 7 ‖ {A}_{2 , 8} ‖ - {A}_{2 , 1} ‖ {A}_{2 , 2} ‖ - {A}_{2 , 3} ‖ {A}_{2 , 4} ‖ - {A}_{2 , 5} ‖ {A}_{2 , 6} ‖ - {A}_{2 , 7} ‖ {A}_{2 , 8} ) ,$$
$${CE}_{3} = ( {A}_{3 , 1} ‖ {A}_{3 , 2} ‖ {A}_{3 , 3} ‖ {A}_{3 , 4} ‖ {A}_{3 , 5} ‖ {A}_{3 , 6} ‖ {A}_{3 , 7} ‖ {A}_{3 , 8} ‖ - {A}_{3 , 1} ‖ {A}_{3 , 2} ‖ - {A}_{3 , 3} ‖ {A}_{3 , 4} ‖ - {A}_{3 , 5} ‖ {A}_{3 , 6} ‖ - {A}_{3 , 7} ‖ {A}_{3 , 8} ) ,$$
$${CE}_{4} = ( {A}_{4 , 1} ‖ {A}_{4 , 2} ‖ {A}_{4 , 3} ‖ {A}_{4 , 4} ‖ {A}_{4 , 5} ‖ {A}_{4 , 6} ‖ {A}_{4 , 7} ‖ {A}_{4 , 8} ‖ - {A}_{4 , 1} ‖ {A}_{4 , 2} ‖ - {A}_{4 , 3} ‖ {A}_{4 , 4} ‖ - {A}_{4 , 5} ‖ {A}_{4 , 6} ‖ - {A}_{4 , 7} ‖ {A}_{4 , 8} ) ,$$
$${CE}_{5} = ( {A}_{5 , 1} ‖ {A}_{5 , 2} ‖ {A}_{5 , 3} ‖ {A}_{5 , 4} ‖ {A}_{5 , 5} ‖ {A}_{5 , 6} ‖ {A}_{5 , 7} ‖ {A}_{5 , 8} ‖ - {A}_{5 , 1} ‖ {A}_{5 , 2} ‖ - {A}_{5 , 3} ‖ {A}_{5 , 4} ‖ - {A}_{5 , 5} ‖ {A}_{5 , 6} ‖ - {A}_{5 , 7} ‖ {A}_{5 , 8} ) ,$$
$${CE}_{6} = ( {A}_{6 , 1} ‖ {A}_{6 , 2} ‖ {A}_{6 , 3} ‖ {A}_{6 , 4} ‖ {A}_{6 , 5} ‖ {A}_{6 , 6} ‖ {A}_{6 , 7} ‖ {A}_{6 , 8} ‖ - {A}_{6 , 1} ‖ {A}_{6 , 2} ‖ - {A}_{6 , 3} ‖ {A}_{6 , 4} ‖ - {A}_{6 , 5} ‖ {A}_{6 , 6} ‖ - {A}_{6 , 7} ‖ {A}_{6 , 8} ) ,$$
$${CE}_{7} = ( {A}_{7 , 1} ‖ {A}_{7 , 2} ‖ {A}_{7 , 3} ‖ {A}_{7 , 4} ‖ {A}_{7 , 5} ‖ {A}_{7 , 6} ‖ {A}_{7 , 7} ‖ {A}_{7 , 8} ‖ - {A}_{7 , 1} ‖ {A}_{7 , 2} ‖ - {A}_{7 , 3} ‖ {A}_{7 , 4} ‖ - {A}_{7 , 5} ‖ {A}_{7 , 6} ‖ - {A}_{7 , 7} ‖ {A}_{7 , 8} ) , and$$
$${CE}_{8} = ( {A}_{8 , 1} ‖ {A}_{8 , 2} ‖ {A}_{8 , 3} ‖ {A}_{8 , 4} ‖ {A}_{8 , 5} ‖ {A}_{8 , 6} ‖ {A}_{8 , 7} ‖ {A}_{8 , 8} ‖ - {A}_{8 , 1} ‖ {A}_{8 , 2} ‖ - {A}_{8 , 3} ‖ {A}_{8 , 4} ‖ - {A}_{8 , 5} ‖ {A}_{8 , 6} ‖ - {A}_{8 , 7} ‖ {A}_{8 , 8} ) .$$

6. The method of claim 1, wherein the first sequence is for at least one of channel estimation, target sensing, or time synchronization.

7. The method of claim 1, further comprising sending the first sequence using a first antenna, wherein the first antenna corresponds to the first sequence in a zero correlation zone sequence set.

8. A communication apparatus, comprising:
a memory configured to store instructions; and
one or more processors coupled to the memory and configured to execute the instructions to cause the communication apparatus to:
generate a first sequence based on a complete complementary code set through a concatenation operation, wherein the complete complementary code set is based on a Golay pair and a Hadamard matrix through a Kronecker product operation; and
send a physical layer protocol data unit comprising the first sequence.

9. The communication apparatus of claim 8, wherein the one or more processors are further configured to execute the instructions to cause the communication apparatus to generating-generate a zero correlation zone sequence set comprising the first sequence, and wherein the physical layer protocol data unit comprises the zero correlation zone sequence set.

10. The communication apparatus of claim 9, wherein a length of the Golay pair is L, wherein the Hadamard matrix is an n-order matrix, wherein L and n are positive integers, wherein a size of the complete complementary code set is 2n, wherein a size of the zero correlation zone sequence set is 2n, and wherein a length of the first sequence in the zero correlation zone sequence set is 4nL.

11. The communication apparatus of claim 9, wherein each sequence in the zero correlation zone sequence set and the complete complementary code set satisfies the following relationship:
$${CE}_{i} = ( {A}_{i , 1} ‖ {A}_{i , 2} ‖ ⋯ ‖ {A}_{i , 2 n - 1} ‖ {A}_{i , 2 n} ‖ - {A}_{i , 1} ‖ {A}_{i , 2} ‖ ⋯ ‖ - {A}_{i , 2 n - 1} ‖ {A}_{i , 2} ) ,$$
$${CE}_{i} = ( {A}_{i , 1} {PA}_{i , 2} P⋯ {PA}_{i , 2 n - 1} {PA}_{i , 2 n} P - {A}_{i , 1} {PA}_{i , 2} P⋯ {PA}_{i , 2 n - 1} {PA}_{i , 2 n} )$$
wherein CEᵢ is the sequence in the zero correlation zone sequence set, wherein i is an integer greater than or equal to 1, and wherein A_{i,j} is an element in the complete complementary code set.

12. The communication apparatus of claim 11, wherein when n is 4 and a length (L) of the Golay pair is 128, sequences in the zero correlation zone sequence set and complete complementary code sets satisfy the following relationships:
$${CE}_{1} = ( {A}_{1 , 1} ‖ {A}_{1 , 2} ‖ {A}_{1 , 3} ‖ {A}_{1 , 4} ‖ {A}_{1 , 5} ‖ {A}_{1 , 6} ‖ {A}_{1 , 7} ‖ {A}_{1 , 8} ‖ - {A}_{1 , 1} ‖ {A}_{1 , 2} ‖ - {A}_{1 , 3} ‖ {A}_{1 , 4} ‖ - {A}_{1 , 5} ‖ {A}_{1 , 6} ‖ - {A}_{1 , 7} ‖ {A}_{1 , 8} ) ,$$
$${CE}_{2} = ( {A}_{2 , 1} ‖ {A}_{2 , 2} ‖ {A}_{2 , 3} ‖ {A}_{2 , 4} ‖ {A}_{2 , 5} ‖ {A}_{2 , 6} ‖ {A}_{2 ,} 7 ‖ {A}_{2 , 8} ‖ - {A}_{2 , 1} ‖ {A}_{2 , 2} ‖ - {A}_{2 , 3} ‖ {A}_{2 , 4} ‖ - {A}_{2 , 5} ‖ {A}_{2 , 6} ‖ - {A}_{2 , 7} ‖ {A}_{2 , 8} ) ,$$
$${CE}_{3} = ( {A}_{3 , 1} ‖ {A}_{3 , 2} ‖ {A}_{3 , 3} ‖ {A}_{3 , 4} ‖ {A}_{3 , 5} ‖ {A}_{3 , 6} ‖ {A}_{3 , 7} ‖ {A}_{3 , 8} ‖ - {A}_{3 , 1} ‖ {A}_{3 , 2} ‖ - {A}_{3 , 3} ‖ {A}_{3 , 4} ‖ - {A}_{3 , 5} ‖ {A}_{3 , 6} ‖ - {A}_{3 , 7} ‖ {A}_{3 , 8} ) ,$$
$${CE}_{4} = ( {A}_{4 , 1} ‖ {A}_{4 , 2} ‖ {A}_{4 , 3} ‖ {A}_{4 , 4} ‖ {A}_{4 , 5} ‖ {A}_{4 , 6} ‖ {A}_{4 , 7} ‖ {A}_{4 , 8} ‖ - {A}_{4 , 1} ‖ {A}_{4 , 2} ‖ - {A}_{4 , 3} ‖ {A}_{4 , 4} ‖ - {A}_{4 , 5} ‖ {A}_{4 , 6} ‖ - {A}_{4 , 7} ‖ {A}_{4 , 8} ) ,$$
$${CE}_{5} = ( {A}_{5 , 1} ‖ {A}_{5 , 2} ‖ {A}_{5 , 3} ‖ {A}_{5 , 4} ‖ {A}_{5 , 5} ‖ {A}_{5 , 6} ‖ {A}_{5 , 7} ‖ {A}_{5 , 8} ‖ - {A}_{5 , 1} ‖ {A}_{5 , 2} ‖ - {A}_{5 , 3} ‖ {A}_{5 , 4} ‖ - {A}_{5 , 5} ‖ {A}_{5 , 6} ‖ - {A}_{5 , 7} ‖ {A}_{5 , 8} ) ,$$
$${CE}_{6} = ( {A}_{6 , 1} ‖ {A}_{6 , 2} ‖ {A}_{6 , 3} ‖ {A}_{6 , 4} ‖ {A}_{6 , 5} ‖ {A}_{6 , 6} ‖ {A}_{6 , 7} ‖ {A}_{6 , 8} ‖ - {A}_{6 , 1} ‖ {A}_{6 , 2} ‖ - {A}_{6 , 3} ‖ {A}_{6 , 4} ‖ - {A}_{6 , 5} ‖ {A}_{6 , 6} ‖ - {A}_{6 , 7} ‖ {A}_{6 , 8} ) ,$$
$${CE}_{7} = ( {A}_{7 , 1} ‖ {A}_{7 , 2} ‖ {A}_{7 , 3} ‖ {A}_{7 , 4} ‖ {A}_{7 , 5} ‖ {A}_{7 , 6} ‖ {A}_{7 , 7} ‖ {A}_{7 , 8} ‖ - {A}_{7 , 1} ‖ {A}_{7 , 2} ‖ - {A}_{7 , 3} ‖ {A}_{7 , 4} ‖ - {A}_{7 , 5} ‖ {A}_{7 , 6} ‖ - {A}_{7 , 7} ‖ {A}_{7 , 8} ) , and$$
$${CE}_{8} = ( {A}_{8 , 1} ‖ {A}_{8 , 2} ‖ {A}_{8 , 3} ‖ {A}_{8 , 4} ‖ {A}_{8 , 5} ‖ {A}_{8 , 6} ‖ {A}_{8 , 7} ‖ {A}_{8 , 8} ‖ - {A}_{8 , 1} ‖ {A}_{8 , 2} ‖ - {A}_{8 , 3} ‖ {A}_{8 , 4} ‖ - {A}_{8 , 5} ‖ {A}_{8 , 6} ‖ - {A}_{8 , 7} ‖ {A}_{8 , 8} ) .$$
$${CE}_{1} = ( {A}_{1 , 1} {PA}_{1 , 2} {PA}_{1 , 3} {PA}_{1 , 4} {PA}_{1 , 5} {PA}_{1 , 6} {PA}_{1 , 7} {PA}_{1 , 8} P - {A}_{1 , 1} {PA}_{1 , 2} P - {A}_{1 , 3} {PA}_{1 , 4} P - {A}_{1 , 5} {PA}_{1 , 6} P - {A}_{1 , 7} {PA}_{1 , 8} ) ,$$
$${CE}_{2} = ( {A}_{2 , 1} {PA}_{2 , 2} {PA}_{2 , 3} {PA}_{2 , 4} {PA}_{2 , 5} {PA}_{2 , 6} {PA}_{2 , 7} {PA}_{2 , 8} P - {A}_{2 , 1} {PA}_{2 , 2} P - {A}_{2 , 3} {PA}_{2 , 4} P - {A}_{2 , 5} {PA}_{2 , 6} P - {A}_{2 , 7} {PA}_{2 , 8} ) ,$$
$${CE}_{3} = ( {A}_{3 , 1} {PA}_{3 , 2} {PA}_{3 , 3} {PA}_{3 , 4} {PA}_{3 , 5} {PA}_{3 , 6} {PA}_{3 , 7} {PA}_{3 , 8} P - {A}_{3 , 1} {PA}_{3 , 2} P - {A}_{3 , 3} {PA}_{3 , 4} P - {A}_{3 , 5} {PA}_{3 , 6} P - {A}_{3 , 7} {PA}_{3 , 8} ) ,$$
$${CE}_{4} = ( {A}_{4 , 1} {PA}_{4 , 2} {PA}_{4 , 3} {PA}_{4 , 4} {PA}_{4 , 5} {PA}_{4 , 6} {PA}_{4 , 7} {PA}_{4 , 8} P - {A}_{4 , 1} {PA}_{4 , 2} P - {A}_{4 , 3} {PA}_{4 , 4} P - {A}_{4 , 5} {PA}_{4 , 6} P - {A}_{4 , 7} {PA}_{4 , 8} ) ,$$
$${CE}_{5} = ( {A}_{5 , 1} {PA}_{5 , 2} {PA}_{5 , 3} {PA}_{5 , 4} {PA}_{5 , 5} {PA}_{5 , 6} {PA}_{5 , 7} {PA}_{5 , 8} P - {A}_{5 , 1} {PA}_{5 , 2} P - {A}_{5 , 3} {PA}_{5 , 4} P - {A}_{5 , 5} {PA}_{5 , 6} P - {A}_{5 , 7} {PA}_{5 , 8} ) ,$$
$${CE}_{6} = ( {A}_{6 , 1} {PA}_{6 , 2} {PA}_{6 , 3} {PA}_{6 , 4} {PA}_{6 , 5} {PA}_{6 , 6} {PA}_{6 , 7} {PA}_{6 , 8} P - {A}_{6 , 1} {PA}_{6 , 2} P - {A}_{6 , 3} {PA}_{6 , 4} P - {A}_{6 , 5} {PA}_{6 , 6} P - {A}_{6 , 7} {PA}_{6 , 8} ) ,$$
$${CE}_{7} = ( {A}_{7 , 1} {PA}_{7 , 2} {PA}_{7 , 3} {PA}_{7 , 4} {PA}_{7 , 5} {PA}_{7 , 6} {PA}_{7 , 7} {PA}_{7 , 8} P - {A}_{7 , 1} {PA}_{7 , 2} P - {A}_{7 , 3} {PA}_{7 , 4} P - {A}_{7 , 5} {PA}_{7 , 6} P - {A}_{7 , 7} {PA}_{7 , 8} ) , and$$
$${CE}_{8} = ( {A}_{8 , 1} {PA}_{8 , 2} {PA}_{8 , 3} {PA}_{8 , 4} {PA}_{8 , 5} {PA}_{8 , 6} {PA}_{8 , 7} {PA}_{8 , 8} P - {A}_{8 , 1} {PA}_{8 , 2} P - {A}_{8 , 3} {PA}_{8 , 4} P - {A}_{8 , 5} {PA}_{8 , 6} P - {A}_{8 , 7} {PA}_{8 , 8} ) .$$

13. The communication apparatus of claim 8, wherein the first sequence is for at least one of channel estimation, target sensing, or time synchronization.

14. The communication apparatus of claim 8, wherein the one or more processors are further configured to execute the instructions to cause the communication apparatus to send the first sequence using a first antenna, and wherein the first antenna corresponds to the first sequence in a zero correlation zone sequence set.

15. A communication apparatus, comprising:
a memory configured to store instructions; and
one or more processors coupled to the memory and configured to execute the instructions to cause the communication apparatus to:
receive a physical layer protocol data unit comprising a first sequence, wherein the first sequence is based on a complete complementary code set through a concatenation operation, and wherein the complete complementary code set is based on a Golay pair and a Hadamard matrix through a Kronecker product operation; and
perform at least one of channel estimation, target sensing, or time synchronization based on the first sequence.

16. The communication apparatus of claim 15, wherein the first sequence is in a zero correlation zone sequence set.

17. The communication apparatus of claim 16, wherein a length of the Golay pair is L, wherein the Hadamard matrix is an n-order matrix, wherein L and n are positive integers, wherein a size of the complete complementary code set is 2n, wherein a size of the zero correlation zone sequence set is 2n, and wherein a length of the first sequence in the zero correlation zone sequence set is 4nL.

18. The communication apparatus of claim 15, wherein each sequence in a zero correlation zone sequence set is based on the complete complementary code set through the concatenation operation.

19. The communication apparatus of claim 18, wherein each sequence in the zero correlation zone sequence set and the complete complementary code set satisfies the following relationship:
$${CE}_{i} = ( {A}_{i , 1} ‖ {A}_{i , 2} ‖ ⋯ ‖ {A}_{i , 2 n - 1} ‖ {A}_{i , 2 n} ‖ - {A}_{i , 1} ‖ {A}_{i , 2} ‖ ⋯ ‖ - {A}_{i , 2 n - 1} ‖ {A}_{i , 2} ) ,$$
$${CE}_{i} = ( {A}_{i , 1} {PA}_{i , 2} P⋯ {PA}_{i , 2 n - 1} {PA}_{i , 2 n} P - {A}_{i , 1} {PA}_{i , 2} P⋯ {PA}_{i , 2 n - 1} {PA}_{i , 2 n} )$$
wherein CEᵢ is the sequence in the zero correlation zone sequence set, wherein i is an integer greater than or equal to 1, and wherein A_{i,j} is an element in the complete complementary code set.

20. The communication apparatus of claim 19, wherein when n is 4 and a length (L) of the Golay pair is 128, sequences in the zero correlation zone sequence set and complete complementary code sets satisfy the following relationships:
$${CE}_{1} = ( {A}_{1 , 1} ‖ {A}_{1 , 2} ‖ {A}_{1 , 3} ‖ {A}_{1 , 4} ‖ {A}_{1 , 5} ‖ {A}_{1 , 6} ‖ {A}_{1 , 7} ‖ {A}_{1 , 8} ‖ - {A}_{1 , 1} ‖ {A}_{1 , 2} ‖ - {A}_{1 , 3} ‖ {A}_{1 , 4} ‖ - {A}_{1 , 5} ‖ {A}_{1 , 6} ‖ - {A}_{1 , 7} ‖ {A}_{1 , 8} ) ,$$
$${CE}_{2} = ( {A}_{2 , 1} ‖ {A}_{2 , 2} ‖ {A}_{2 , 3} ‖ {A}_{2 , 4} ‖ {A}_{2 , 5} ‖ {A}_{2 , 6} ‖ {A}_{2 ,} 7 ‖ {A}_{2 , 8} ‖ - {A}_{2 , 1} ‖ {A}_{2 , 2} ‖ - {A}_{2 , 3} ‖ {A}_{2 , 4} ‖ - {A}_{2 , 5} ‖ {A}_{2 , 6} ‖ - {A}_{2 , 7} ‖ {A}_{2 , 8} ) ,$$
$${CE}_{3} = ( {A}_{3 , 1} ‖ {A}_{3 , 2} ‖ {A}_{3 , 3} ‖ {A}_{3 , 4} ‖ {A}_{3 , 5} ‖ {A}_{3 , 6} ‖ {A}_{3 , 7} ‖ {A}_{3 , 8} ‖ - {A}_{3 , 1} ‖ {A}_{3 , 2} ‖ - {A}_{3 , 3} ‖ {A}_{3 , 4} ‖ - {A}_{3 , 5} ‖ {A}_{3 , 6} ‖ - {A}_{3 , 7} ‖ {A}_{3 , 8} ) ,$$
$${CE}_{4} = ( {A}_{4 , 1} ‖ {A}_{4 , 2} ‖ {A}_{4 , 3} ‖ {A}_{4 , 4} ‖ {A}_{4 , 5} ‖ {A}_{4 , 6} ‖ {A}_{4 , 7} ‖ {A}_{4 , 8} ‖ - {A}_{4 , 1} ‖ {A}_{4 , 2} ‖ - {A}_{4 , 3} ‖ {A}_{4 , 4} ‖ - {A}_{4 , 5} ‖ {A}_{4 , 6} ‖ - {A}_{4 , 7} ‖ {A}_{4 , 8} ) ,$$
$${CE}_{5} = ( {A}_{5 , 1} ‖ {A}_{5 , 2} ‖ {A}_{5 , 3} ‖ {A}_{5 , 4} ‖ {A}_{5 , 5} ‖ {A}_{5 , 6} ‖ {A}_{5 , 7} ‖ {A}_{5 , 8} ‖ - {A}_{5 , 1} ‖ {A}_{5 , 2} ‖ - {A}_{5 , 3} ‖ {A}_{5 , 4} ‖ - {A}_{5 , 5} ‖ {A}_{5 , 6} ‖ - {A}_{5 , 7} ‖ {A}_{5 , 8} ) ,$$
$${CE}_{6} = ( {A}_{6 , 1} ‖ {A}_{6 , 2} ‖ {A}_{6 , 3} ‖ {A}_{6 , 4} ‖ {A}_{6 , 5} ‖ {A}_{6 , 6} ‖ {A}_{6 , 7} ‖ {A}_{6 , 8} ‖ - {A}_{6 , 1} ‖ {A}_{6 , 2} ‖ - {A}_{6 , 3} ‖ {A}_{6 , 4} ‖ - {A}_{6 , 5} ‖ {A}_{6 , 6} ‖ - {A}_{6 , 7} ‖ {A}_{6 , 8} ) ,$$
$${CE}_{7} = ( {A}_{7 , 1} ‖ {A}_{7 , 2} ‖ {A}_{7 , 3} ‖ {A}_{7 , 4} ‖ {A}_{7 , 5} ‖ {A}_{7 , 6} ‖ {A}_{7 , 7} ‖ {A}_{7 , 8} ‖ - {A}_{7 , 1} ‖ {A}_{7 , 2} ‖ - {A}_{7 , 3} ‖ {A}_{7 , 4} ‖ - {A}_{7 , 5} ‖ {A}_{7 , 6} ‖ - {A}_{7 , 7} ‖ {A}_{7 , 8} ) , and$$
$${CE}_{8} = ( {A}_{8 , 1} ‖ {A}_{8 , 2} ‖ {A}_{8 , 3} ‖ {A}_{8 , 4} ‖ {A}_{8 , 5} ‖ {A}_{8 , 6} ‖ {A}_{8 , 7} ‖ {A}_{8 , 8} ‖ - {A}_{8 , 1} ‖ {A}_{8 , 2} ‖ - {A}_{8 , 3} ‖ {A}_{8 , 4} ‖ - {A}_{8 , 5} ‖ {A}_{8 , 6} ‖ - {A}_{8 , 7} ‖ {A}_{8 , 8} ) .$$
$${CE}_{1} = ( {A}_{1 , 1} {PA}_{1 , 2} {PA}_{1 , 3} {PA}_{1 , 4} {PA}_{1 , 5} {PA}_{1 , 6} {PA}_{1 , 7} {PA}_{1 , 8} P - {A}_{1 , 1} {PA}_{1 , 2} P - {A}_{1 , 3} {PA}_{1 , 4} P - {A}_{1 , 5} {PA}_{1 , 6} P - {A}_{1 , 7} {PA}_{1 , 8} ) ,$$
$${CE}_{2} = ( {A}_{2 , 1} {PA}_{2 , 2} {PA}_{2 , 3} {PA}_{2 , 4} {PA}_{2 , 5} {PA}_{2 , 6} {PA}_{2 , 7} {PA}_{2 , 8} P - {A}_{2 , 1} {PA}_{2 , 2} P - {A}_{2 , 3} {PA}_{2 , 4} P - {A}_{2 , 5} {PA}_{2 , 6} P - {A}_{2 , 7} {PA}_{2 , 8} ) ,$$
$${CE}_{3} = ( {A}_{3 , 1} {PA}_{3 , 2} {PA}_{3 , 3} {PA}_{3 , 4} {PA}_{3 , 5} {PA}_{3 , 6} {PA}_{3 , 7} {PA}_{3 , 8} P - {A}_{3 , 1} {PA}_{3 , 2} P - {A}_{3 , 3} {PA}_{3 , 4} P - {A}_{3 , 5} {PA}_{3 , 6} P - {A}_{3 , 7} {PA}_{3 , 8} ) ,$$
$${CE}_{4} = ( {A}_{4 , 1} {PA}_{4 , 2} {PA}_{4 , 3} {PA}_{4 , 4} {PA}_{4 , 5} {PA}_{4 , 6} {PA}_{4 , 7} {PA}_{4 , 8} P - {A}_{4 , 1} {PA}_{4 , 2} P - {A}_{4 , 3} {PA}_{4 , 4} P - {A}_{4 , 5} {PA}_{4 , 6} P - {A}_{4 , 7} {PA}_{4 , 8} ) ,$$
$${CE}_{5} = ( {A}_{5 , 1} {PA}_{5 , 2} {PA}_{5 , 3} {PA}_{5 , 4} {PA}_{5 , 5} {PA}_{5 , 6} {PA}_{5 , 7} {PA}_{5 , 8} P - {A}_{5 , 1} {PA}_{5 , 2} P - {A}_{5 , 3} {PA}_{5 , 4} P - {A}_{5 , 5} {PA}_{5 , 6} P - {A}_{5 , 7} {PA}_{5 , 8} ) ,$$
$${CE}_{6} = ( {A}_{6 , 1} {PA}_{6 , 2} {PA}_{6 , 3} {PA}_{6 , 4} {PA}_{6 , 5} {PA}_{6 , 6} {PA}_{6 , 7} {PA}_{6 , 8} P - {A}_{6 , 1} {PA}_{6 , 2} P - {A}_{6 , 3} {PA}_{6 , 4} P - {A}_{6 , 5} {PA}_{6 , 6} P - {A}_{6 , 7} {PA}_{6 , 8} ) ,$$
$${CE}_{7} = ( {A}_{7 , 1} {PA}_{7 , 2} {PA}_{7 , 3} {PA}_{7 , 4} {PA}_{7 , 5} {PA}_{7 , 6} {PA}_{7 , 7} {PA}_{7 , 8} P - {A}_{7 , 1} {PA}_{7 , 2} P - {A}_{7 , 3} {PA}_{7 , 4} P - {A}_{7 , 5} {PA}_{7 , 6} P - {A}_{7 , 7} {PA}_{7 , 8} ) , and$$
$${CE}_{8} = ( {A}_{8 , 1} {PA}_{8 , 2} {PA}_{8 , 3} {PA}_{8 , 4} {PA}_{8 , 5} {PA}_{8 , 6} {PA}_{8 , 7} {PA}_{8 , 8} P - {A}_{8 , 1} {PA}_{8 , 2} P - {A}_{8 , 3} {PA}_{8 , 4} P - {A}_{8 , 5} {PA}_{8 , 6} P - {A}_{8 , 7} {PA}_{8 , 8} ) .$$
